(19) United States
(12) Patent Application Publication
(10) Pub. No.: US 2025/0220035 A1
(43) Pub. Date: Jul. 3, 2025

(54) ATTACK ANALYSIS DEVICE, ATTACK ANALYSIS METHOD, AND STORAGE MEDIUM THEREOF

(71) Applicant: DENSO CORPORATION, Kariya-City (JP)

(72) Inventors: Keigo NAGARA, Kariya-City (JP); Taiji ABE, Kariya-City (JP); Tomonori IKUSE, Kariya-City (JP); Hiroyuki UTSUNOMIYA, Kariya-City (JP); Masumi EGAWA, Kariya-City (JP); Hajime MASHITA, Kariya-City (JP); Keita HAYAKAWA, Kariya-City (JP)

(21) Appl. No.: 19/082,063

(22) Filed: Mar. 17, 2025

Related U.S. Application Data
(63) Continuation of application No. PCT/JP2023/034149, filed on Sep. 20, 2023.

(30) Foreign Application Priority Data
Sep. 30, 2022 (JP) 2022-157432
Sep. 30, 2022 (JP) 2022-158597
Jul. 31, 2023 (JP) 2023-124179

(51) Int. Cl. H04L 9/40; B60R 16/023; B60W 50/04

(52) U.S. Cl. CPC H04L 63/1425; B60R 16/0232; B60W 50/04; H04L 63/1433

(57) ABSTRACT

An attack analysis device includes a storage device storing attack anomaly relation information indicating a relation among (i) predicted attack information indicating an attack predicted to be received by an electronic control system, (ii) predicted anomaly information indicating an anomaly predicted to occur when the electronic control system receives the predicted attack, and (iii) predicted anomaly location information indicating a location within the electronic control system where the predicted anomaly occurs. The attack analysis device is configured to: acquire a security log indicating (i) an anomaly detected in the electronic control system and (ii) a location where the anomaly is detected; acquire an indicator indicating an internal state and/or external state of the mobile object when the anomaly occurs; estimate the received attack based on (i) the security log, (ii) the attack anomaly relation information, and (iii) the indicator; and output the attack information indicating the estimated attack.

### CROSS REFERENCE TO RELATED APPLICATIONS

The present application is a continuation application of International Patent Application No. PCT/JP2023/034149 filed on Sep. 20, 2023, which designated the U.S. and claims the benefits of priorities from Japanese Patent Application No. 2022-157432 filed on Sep. 30, 2022, Japanese Patent Application No. 2022-158597 filed on Sep. 30, 2022, and Japanese Patent Application No. 2023-124179 filed on Jul. 31, 2023. The entire disclosures of all of the above applications are incorporated herein by reference.

### TECHNICAL FIELD

The present disclosure relates to a technique for analyzing attacks against electronic control systems mounted on devices such as mobile objects, mainly automobiles, and relates to an attack analysis device, an attack analysis method, and a storage medium storing an attack analysis program.

### BACKGROUND

In recent years, technologies for driving support and automated driving control, including V2X such as vehicle-to-vehicle communication and road-to-vehicle communication, have been attracting attention. As a result, vehicles are equipped with communication function, and connectivity of the vehicle is progressing. Since the vehicles are equipped with communication function, the vehicles may receive cyberattacks, and unauthorized access to the vehicles may increase. Therefore, it may be necessary to analyze cyberattacks on vehicles and to take countermeasures against the cyberattacks.

### SUMMARY

The present disclosure provides an attack analysis device that analyzes an attack on an electronic control system mounted on a mobile object. The attack analysis device includes an attack anomaly relation information storage unit storing attack anomaly relation information indicating a relation among (i) predicted attack information indicating an attack predicted to be received by the electronic control system, (ii) predicted anomaly information indicating an anomaly predicted to occur when the electronic control system receives the predicted attack, and (iii) predicted anomaly location information indicating a location within the electronic control system where the predicted anomaly occurs. The attack analysis, by executing a program stored in a non-transitory storage medium using at least one processor, is configured to: acquire a security log indicating (i) an anomaly detected in the electronic control system and (ii) a location within the electronic control system where the anomaly is detected; acquire an indicator indicating an internal state or an external state of the mobile object when the anomaly occurs; estimate the attack received by the electronic control system based on (i) the security log, (ii) the attack anomaly relation information, and (iii) the indicator; and output the attack information indicating the estimated attack.

### BRIEF DESCRIPTION OF DRAWINGS

Objects, features and advantages of the present disclosure will become apparent from the following detailed description made with reference to the accompanying drawings. In the drawings:

FIG. 1A to FIG. 1D each is a diagram showing a positional relation between an attack analysis device and an electronic control system according to each embodiment;

FIG. 2 is a block diagram showing an example of the configuration of an electronic control system S;

FIG. 3 is an explanatory diagram showing the contents of a security log;

FIG. 4 is a block diagram showing a configuration example of an attack analysis device according to each embodiment;

FIG. 5A and FIG. 5B each is an explanatory diagram illustrating a concept of situation information;

FIG. 6 is an explanatory diagram illustrating a concept of attack and anomaly relation information;

FIG. 7A is an explanatory diagram illustrating a specific example of an attack estimation method executed by an attack analysis device according to each embodiment;

FIG. 7B is an explanatory diagram illustrating a specific example of an attack estimation method executed by an attack analysis device according to each embodiment;

FIG. 7C is an explanatory diagram illustrating a specific example of an attack estimation method executed by an attack analysis device according to each embodiment;

FIG. 7D is an explanatory diagram illustrating a specific example of an attack estimation method executed by an attack analysis device according to each embodiment;

FIG. 8 is a flowchart illustrating an operation of an attack analysis device according to each embodiment;

FIG. 9 is a block diagram showing a system including an attack analysis device according to a first embodiment;

FIG. 10 is a block diagram illustrating a configuration example of an attack analysis device according to the first embodiment;

FIG. 11 is an explanatory diagram showing a relation between an individual position and a common position of an ECU;

FIG. 12 is an explanatory diagram showing a vehicle situation determination condition table;

FIG. 13 is an explanatory diagram showing a power supply state determination table;

FIG. 14 is an explanatory diagram showing an attack estimation matching table;

FIG. 15 is an explanatory diagram showing a method for reducing a computation load when using an attack estimation matching table;

FIG. 16 is a time chart illustrating an operation of an attack analysis device according to the first embodiment;

FIG. 17 is a block diagram showing a configuration example of an attack analysis device or an attack analysis system according to a second embodiment;

FIG. 18 is a diagram illustrating an electronic control system that is an analysis target of an attack analysis device according to the second embodiment;

FIG. 19 is a diagram illustrating an example of an ECU, an entry point, and an external connection destination according to the second embodiment;

FIG. 20 is a diagram illustrating an example of a traveling situation attack relation table according to the second embodiment;

FIG. 21 is a diagram illustrating an example of a traveling situation attack relation table according to the second embodiment;

FIG. 22 is a block diagram illustrating a configuration example of an entry point candidate generation unit according to the second embodiment;

FIG. 23 is a block diagram illustrating a configuration example of an attack estimation unit according to the second embodiment;

FIG. 24 is a diagram illustrating an example of an attack anomaly relation table according to the second embodiment;

FIG. 25 is a diagram illustrating an example of an attack anomaly relation table according to the second embodiment;

FIG. 26 is a block diagram illustrating a configuration example of an estimation result verification unit according to the second embodiment;

FIG. 27 is a flowchart showing an operation of an attack analysis system according to the second embodiment;

FIG. 28 is a block diagram illustrating a configuration example of an attack analysis system according to a first modification of the second embodiment;

FIG. 29 is an explanatory diagram illustrating an arrangement of an attack analysis device according to a modified example of the second embodiment;

FIG. 30 is a block diagram showing a configuration example of an attack analysis system according to a second modification of the second embodiment;

FIG. 31 is a block diagram illustrating a configuration example of an attack analysis system according to a third modification of the second embodiment;

FIG. 32 is a block diagram showing a configuration example of an attack analysis device according to a third embodiment;

FIG. 33 is a diagram for explaining a table stored in a storage unit according to the third embodiment;

FIG. 34 is a diagram for explaining a method that determines whether a security log is a false positive log according to the third embodiment;

FIG. 35 is a diagram for explaining an example of an attack anomaly relation table according to the third embodiment;

FIG. 36 is a flowchart illustrating an operation of an attack analysis device according to the third embodiment;

FIG. 37 is a flowchart illustrating an operation of an attack analysis device according to the third embodiment;

FIG. 38 is a diagram for explaining a table stored in a storage unit in a modified example of the third embodiment;

FIG. 39 is a diagram for explaining a method for determining whether a security log is a false positive log according to a modified example of the third embodiment;

FIG. 40 is a diagram for explaining a method for determining whether a security log is a false positive log according to a modified example of the third embodiment; and

FIG. 41 is a flowchart illustrating an operation of an attack analysis device according to a modified example of the third embodiment.

### DETAILED DESCRIPTION

There are various technologies for detecting anomalies occurring in vehicles and analyzing cyberattacks based on the detected anomalies. In a comparative example, detected anomaly data is collected, and a combination of items in which the anomalies are detected is compared with an anomaly detection pattern specified in advance for each attack. Then, the type of attack corresponding to each anomaly is specified.

In a related art, when an electronic control unit detects an anomaly, a device prevents intrusion of unauthorized information by determining a measure for blocking the unauthorized information by using a determination result indicating whether a protection function or a function other than the protection function installed in the electronic control unit is operating normally or abnormally.

After performing detailed study, inventors of the present application found the following difficulties.

An attack on the electronic control system may be estimated using (i) an anomaly detected in the electronic control system, (ii) a security log indicating a location in the electronic control system where the anomaly is detected, and (iii) attack anomaly relation information indicating combinations of anomalies estimated to be occurred when the electronic control system receives the cyberattack. In this case, a further improvement is required for improving estimation accuracy of the attack and/or reducing computation load for the estimation of attack.

According to an aspect of the present disclosure, an attack analysis device analyzes an attack on an electronic control system mounted on a mobile object, and includes a log acquisition unit, an indicator acquisition unit, an attack anomaly relation information storage unit, an attack estimation unit, and an output unit. The log acquisition unit acquires a security log indicating (i) an anomaly detected in the electronic control system and (ii) a location within the electronic control system where the anomaly is detected. The indicator acquisition unit acquires an indicator indicating an internal state or an external state of the mobile object when the anomaly occurs. The attack anomaly relation information storage unit stores attack anomaly relation information indicating a relation among (i) predicted attack information indicating an attack predicted to be received by the electronic control system, (ii) predicted anomaly information indicating an anomaly predicted to occur when the electronic control system receives the predicted attack, and (iii) predicted anomaly location information indicating a location within the electronic control system where the predicted anomaly occurs. The attack estimation unit estimates the attack received by the electronic control system based on (i) the security log, (ii) the attack anomaly relation information, and (iii) the indicator. The output unit outputting attack information indicating the estimated attack.

In the above configuration, when the anomaly occurs, the attack analysis device estimates the attack using the indicator indicating the internal state and/or external state of the mobile object, in addition to security log and the attack anomaly relation information, thereby improving the estimation accuracy of attack and reducing computation load required for the estimation of attack.

The following will describe exemplary embodiments of the present disclosure with reference to the drawings.

Effects described in the following embodiments are effects obtained by a configuration of the corresponding embodiment as an example of the present disclosure, and are not necessarily effects of the present disclosure.

When there are multiple embodiments (including modifications), the configurations disclosed in the embodiments are not limited to the embodiments, and can be combined across the embodiments. For example, the configuration disclosed in one embodiment may be combined with another embodiment. The configurations disclosed respectively in multiple embodiments may be collected and combined.

The difficulty described in the present disclosure is not a publicly known issue, but persons including the inventor have independently found out, and is a fact that affirms the non-obviousness of the present disclosure together with the configuration and method of the present disclosure.

### 1. Configuration Common to all Embodiments

### (1) Positional Relation Between Attack Analysis Device and Electronic Control System

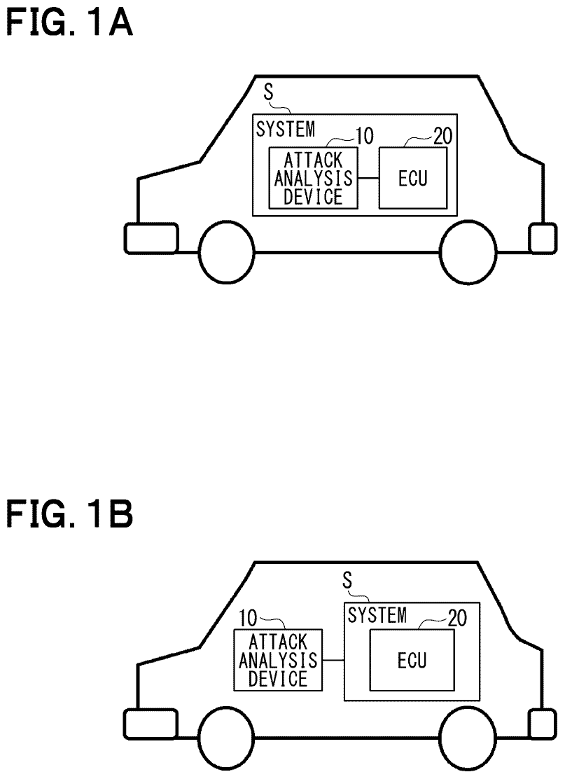

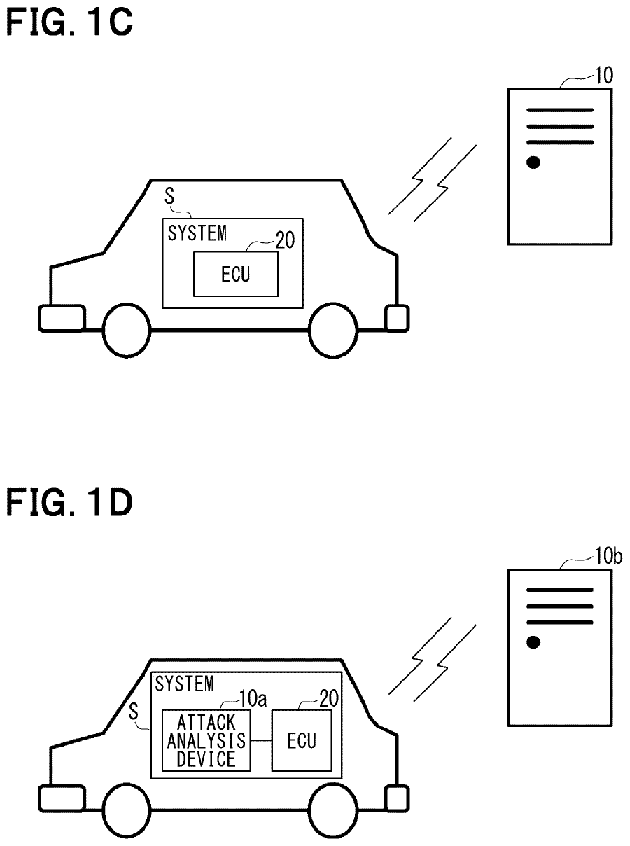

The positional relation between an attack analysis device 10 and an electronic control system S in each embodiment will be described with reference to FIG. 1A to FIG. 1D.

The attack analysis device 10 analyzes an attack received by the electronic control system S. More specifically, the attack analysis device receives a security log generated by a security sensor of an electronic control device 20, which is included in the electronic control system S, and analyzes an attack on the electronic control system S based on the security log. The attack analysis devices 11 to 13 in each embodiment will be collectively referred to as the attack analysis device 10.

As shown in FIG. 1A and FIG. 1B, the attack analysis device 10, together with an electronic control device 20, may be mounted on a vehicle. The vehicle corresponds to a mobile object. The attack analysis device and the electronic control device 20 constitute the electronic control system S. As shown in FIG. 1C, the attack analysis device 10 may be implemented as a server device or a security operation center (SOC) located outside the vehicle. That is, the attack analysis device 10 is separated from the vehicle. Furthermore, a part of the attack analysis device 10, which is indicated as an attack analysis device 10a, is mounted on a vehicle, and remaining part of the attack analysis device 10, which is indicated as an attack analysis device 10b, is provided outside the vehicle. Hereinafter, the electronic control device 20 may be referred to as electronic control unit (ECU) 20.

Herein, the term “mobile object” refers to a movable object, and a moving speed may be arbitrary.

The mobile object also includes a case where the mobile object is in stop state with a speed of zero. For example, the mobile object may include, but is not limited to, vehicles, motorcycles, bicycles, pedestrians, ships, aircrafts, and objects mounted on these.

The term “mounted” includes not only a case where an object is directly fixed to the mobile object but also a case where an object moves together with the mobile object although the object is not fixed to the mobile object. Examples of the object include an object carried by a user who is in the mobile object and an object attached to a load carried by the mobile object.

FIG. 1A shows an example in which the attack analysis device 10 is independently provided inside the electronic control system S, or an example in which the functions of the attack analysis device 10 are built in at least one of the ECUs 20 that constitute the electronic control system S. FIG. 1B shows an example in which the attack analysis device 10 is provided outside the electronic control system S. From the viewpoint of the connection form, it is substantially the same as FIG. 1A.

In the configurations of FIG. 1A and FIG. 1B, the attack analysis device 10 and the ECU 20 are connected via an in-vehicle communication network, such as a Controller Area Network (CAN) or a Local Interconnect Network (LIN). Alternatively, the attack analysis device 10 and the ECU 20 may be connected via any wired or wireless communication method, such as Ethernet™, Wi-Fi™, or Bluetooth™. The term “connection” refers to a state in which data can be exchanged. The connection state includes a case in which different hardware devices are connected through a wired or wireless communication network, as well as a case in which virtual machines running on the same hardware are virtually connected with one another.

FIG. 1C and FIG. 1D each shows an example in which entire or a part of the attack analysis device 10 is provided outside the electronic control system S. Further, the attack analysis device 10 is located outside the vehicle. Thus, the connection form is different from the connection form of FIG. 1A and FIG. 1B. The attach analysis device 10 and the electronic control system S may be connected via a communication network adopting a wireless communication method of IEEE 802.11 (Wi-Fi, registered trademark), IEEE 802.16 (WiMAX, registered trademark), wideband code division multiple access (W-CDMA), high speed packet access (HSPA), long term evolution (LTE), long term evolution advanced (LTE-A), 4G, or 5G. Alternatively, dedicated short range communication (DSRC) may be used in the communication between the attack analysis device and the electronic control system. When the vehicle is parked in a parking lot or housed in a repair shop, a wired communication may be used instead of the wireless communication. For example, a local area network (LAN), the Internet, or a fixed telephone line may be used.

In the configurations of FIG. 1A and FIG. 1B, a cyberattack can be analyzed without communicating with an external device. Thus, the configurations of FIG. 1A and FIG. 1B enables the cyberattack analysis to be performed in the attacked vehicle without delay, thereby enabling rapid response to the cyberattack.

In the configuration of FIG. 1C and FIG. 1D, it is possible to analyze the cyberattack by utilizing a sufficient resource of a server device. Further, the cyberattack analysis can be performed centrally on the server device without installing new devices or programs in the existing vehicles.

Hereinafter, the embodiments will be described with the configuration shown in FIG. 1C as a premise.

In each embodiment, a vehicle system equipped to a vehicle will be described as an example of the electronic control system S. However, the electronic control system S is not limited to a vehicle system, and may be applied to any kind of electronic control system including multiple ECUs. For example, the electronic control system S may be equipped to a stationary object or a fixed object instead of a mobile object.

A part of the attack analysis device 10 may be provided in the server device, and the remaining part may be provided in the mobile object or other devices.

In FIG. 1D, the attack analysis device 10a may be, for example, a device including a situation estimation unit 104 described below, and the attack analysis device 10b may be a device including an attack estimation unit 106 described below.

The attack analysis device 10 determines whether the anomaly indicated in the received security log is an anomaly caused by a cyberattack or an anomaly caused by a reason other than a cyberattack. In response to determining that the anomaly is caused by a cyberattack, the attack analysis device analyzes the cyberattack based on the security log. In response to determining that the anomaly is caused by a reason other than a cyberattack, the attack analysis device 10 determines that the security log is a false positive log and does not perform an analysis of cyberattack. A device having such a function can be defined as a log determination device. The log determination device may be implemented as a device that includes the situation estimation unit 104.

The process executed by the log determination device may be provided at a stage before the process executed by the attack analysis device 10. The log determination device may be included in the attack analysis device 10. In the configurations of FIG. 1A and FIG. 1B, the log determination device is also mounted on the vehicle although not shown. In the configuration of FIG. 1C, the log determination device may be provided in the server device, which corresponds the attack analysis device 10. Alternatively, the log determination device may be mounted on the vehicle. In this case, the former arrangement corresponds to FIG. 1C, and the latter arrangement corresponds to FIG. 1D.

### (2) Configuration of Electronic Control System

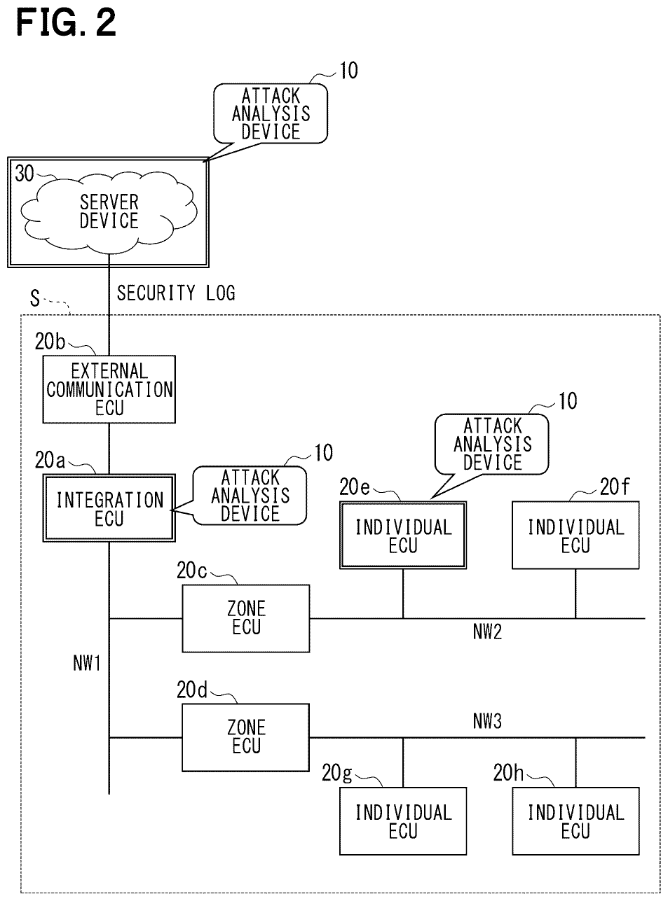

FIG. 2 is a diagram showing a configuration example of the electronic control system S. The electronic control system S includes multiple ECUs 20 and in-vehicle networks NW1, NW2, NW3 for connecting the multiple ECUs 20. Although FIG. 2 illustrates eight ECUs (ECUs 20a to 20h), the electronic control system S may include any number of ECUs. In the following description, the ECU 20 or each ECU 20 will be used when describing a single or multiple electronic control units as a whole, and the ECU 20a, ECU 20b, ECU 20c, etc. will be used when individually describing specific electronic control unit.

In the configuration of FIG. 2, the ECUs 20 are connected with one another via the in-vehicle communication network described in the explanation of FIG. 1A and FIG. 1B.

The electronic control system S illustrated in FIG. 2 includes an integration ECU 20a, an external communication ECU 20b, zone ECUs 20c, 20d, and individual ECUs 20e, 20f, 20g, 20h.

The integration ECU 20a is an ECU having a function of controlling the entire electronic control system S and a gateway function for relaying communication among the multiple ECUs 20. The integration ECU 20a may be referred to as a gateway ECU (that is, G-ECU) or a mobility computer (that is, MC). The integration ECU 20a may be a relay device or a gateway device.

The external communication ECU 20b includes a communication unit that communicates with an external device located outside the vehicle, for example, a server device 30 to be described in each embodiment. A communication method adopted by the external communication ECU 20b is the wireless communication method or the wired communication method described in the explanation of FIG. 1C.

In order to implement multiple communication methods, the electronic control system S may include multiple external communication ECUs 20b. Instead of providing the external communication ECU 20b, the integration ECU 20a may have a function of the external communication ECU 20b.

Each zone ECU 20c, 20d has a gateway function provided according to a function or a location where each individual ECU is arranged. The individual ECUs will be described later. For example, the zone ECU 20c has a gateway function of relaying communication between the individual ECU 20e, 20f disposed in a front zone of the vehicle and another ECU 20. The zone ECU 20d has a gateway function of relaying communication between the individual ECU 20g, 20h disposed in a rear zone of the vehicle and another ECU 20. The zone ECUs (i.e., ECUs 20c, 20d) are sometimes referred to as domain computers (i.e., DCs). The individual ECU 20e and the individual ECU 20f are connected to the zone ECU 20c via the network 2 (NW2 shown in FIG. 2). The individual ECU 20g and the individual ECU 20h are connected to the zone ECU 20d via the network 3 (NW3 shown in FIG. 2).

The individual ECUs (i.e., the ECUs 20e to 20h) may be configured as ECUs having any appropriate functions. The electronic control unit (ECU) may be a drive system electronic control device that controls an engine, a steering wheel, a brake, etc. The ECU may be a vehicle body electronic control device that controls a meter, a power window, etc. The ECU may be an information system electronic control device, such as a navigation device. The ECU may be a safety control electronic control device that controls the vehicle to prevent a collision with an obstacle or a pedestrian. The ECUs may be classified into a master and a slave instead of parallel arrangement.

In addition, necessary sensors may be connected to each of the individual ECUs 20e, 20f, 20g, 20h depending on the functions provided by each individual ECU. Examples of the sensor include, but are not limited to, a speed sensor, an acceleration sensor, an angular velocity sensor, a temperature sensor, a seat sensor, and a voltmeter. These sensors may be connected to the integration ECU 20a or the zone ECUs 20c, 20d instead of to the individual ECUs 20e, 20f, 20g, 20h.

Each ECU 20 may be a physically independent electronic control unit, or may be a virtual electronic control unit implemented by using a virtualization technology. When the ECUs 20 are implemented by different hardware units, the ECUs 20 may be connected via a wired or wireless communication method with one another. When the multiple ECUs 20 are implemented in virtual manner using the virtualization technology on a single hardware unit, the virtual ECUs may be connected with one another in virtual manner.

In the configuration of FIG. 1A, the attack analysis device 10 is provided inside the electronic control system S. For example, as shown in FIG. 2, the attack analysis device 10 may be implemented by the integration ECU 20a or by the individual ECU 20e. When the attack analysis device 10 is implemented by the individual ECU 20e, the individual ECU 20e may be an ECU having dedicated purpose as the attack analysis device 10.

In the configuration of FIG. 1C, the attack analysis device 10 is provided outside the electronic control system S, and the attack analysis device may be implemented by the server device 30 as shown in FIG. 2. In this case, the server device 30 receives the security log transmitted from the external communication ECU 20b.

Each ECU 20 has a security sensor. When the security sensor detects an anomaly occurrence in the ECU 20 or in the network connected to the ECU 20, the security sensor generates a security log. Details of security logs will be explained later. It is not necessary for each ECU 20 to be equipped with a security sensor.

### (3) Details of Security Log

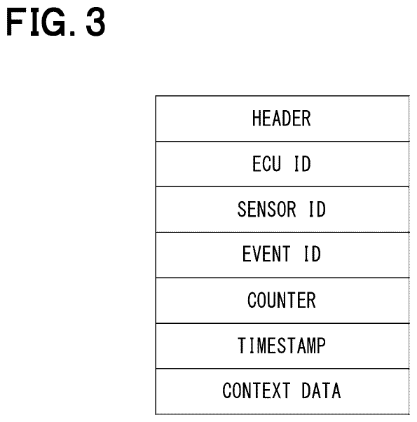

FIG. 3 is a diagram showing contents of a security log generated by the security sensor of the ECU 20.

The security log has the following data fields: an ECU ID indicating identification information of the ECU in which the security sensor is installed; a sensor ID indicating identification information of security sensor; an event ID indicating identification information of an event related to an anomaly detected by the security sensor; a counter indicating the number of times the event has occurred; a timestamp indicating occurrence time of the event; and context data indicating details of the security sensor output. The security log may further include a header storing information indicating a protocol version and a state of each data field.

According to a specification defined by AUTOSAR (AUTomotive Open System ARchitecture), IdsM Instance ID corresponds to the ECU ID, Sensor Instance ID corresponds to the sensor ID, Event Definition ID corresponds to the event ID, Count corresponds to the counter, Timestamp corresponds to the timestamp, Context Data corresponds to the context data, Protocol Version or Protocol Header correspond to the header, respectively.

FIG. 3 is an example of the log generated in response to occurrence of anomaly. A normal log generated when no anomaly occurs (for example, a case where an event is successful) may have the same configuration as in FIG. 3. In such a case, different event IDs may be used for an event in which an anomaly is occurred and an event in which no anomaly is occurred in order to distinguish the abnormal log from the normal log. Alternatively, by setting, in the header, a flag indicating the presence or absence of context data, the abnormal log may be distinguished from the normal log by checking the flag.

FIG. 3 shows a security log generated by a physically independent ECU 20. The security log may be generated by a virtual ECU.

The security event log generated by the security sensor is referred to as SEv. A refined and accurate security event log is referred to as QSEv. For example, the security sensor of the individual ECU 20e, 20f, 20g, 20h shown in FIG. 2 generates security log SEv and reports it to an intrusion detection system manager (IdsM), which is not shown. When the security log SEv passes a certification filter and meets specified criteria in the IdsM, the security log SEv is transmitted as QSEv from an intrusion detection reporter to the outside of the vehicle. The security log in the present embodiment is a concept including both of the SEv and the QSEv.

The security log in each embodiment may be a log generated by a function known as in-vehicle Security Information and Event Management (SIEM). SIEM collects and manages information related to events occurred in the electronic control system.

In the following embodiments, particularly in the first embodiment, the security log may be referred to as an anomaly log, since the security log notifies an anomaly. Also, since the security log is generated in the vehicle, the security log may also be referred to as a vehicle log.

In each of the following embodiments, particularly in the third embodiment, false positive log will be mainly described. A false positive log refers to a security log in which a detected event indicated by the security log is an event caused by an anomaly other than a cyberattack on the electronic control system S. The false positive logs include a security log indicating an abnormal event (also referred to as an abnormal log or an abnormal security log) and a security log indicating a non-anomaly or successful event (also referred to as a normal log or a successful security log). Examples of detected event is an entry of a correct or incorrect password, an event not caused by a cyberattack, a user operation, or the like.

In the third embodiment, attention is focused on the false positive log of the abnormal log, but the false positive log of the normal log may be used.

### (4) Configuration of Attack Analysis Device

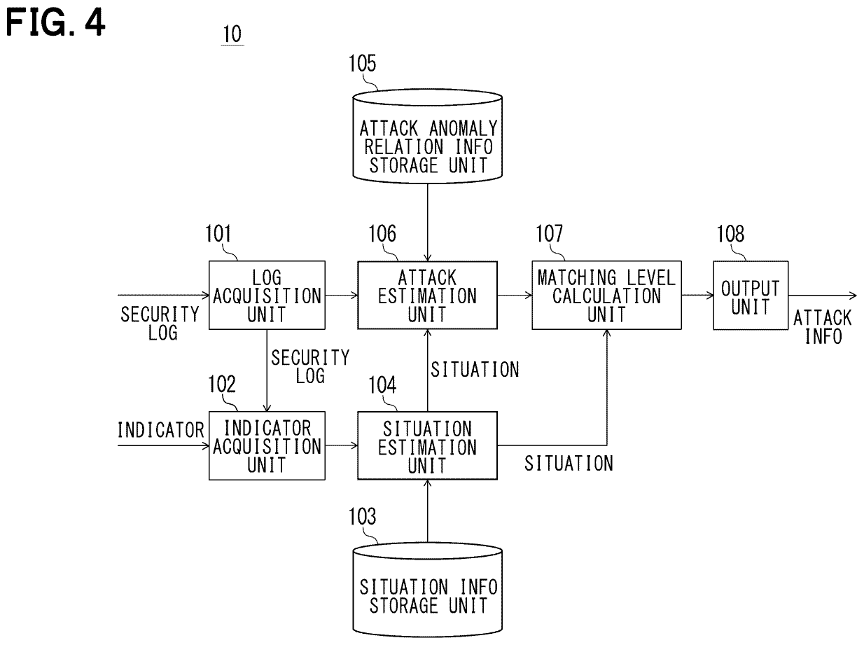

A configuration of the attack analysis device 10 will be described with reference to FIG. 4. The attack analysis device 10 includes a log acquisition unit 101, an indicator acquisition unit 102, a situation information storage unit 103, a situation estimation unit 104, an attack anomaly relation information storage unit 105, an attack estimation unit 106, a matching level calculation unit 107, and an output unit 108.

The log acquisition unit 101 acquires a security log that indicates an anomaly detected in the electronic control system S and the location within the electronic control system S where the anomaly is detected. For example, when the security log of FIG. 3 is received, the type of anomaly is indicated in the event ID and context data, and the location where the anomaly was detected is indicated in the ECU ID or the sensor ID.

In the present disclosure, the term “acquire” includes not only acquiring by receiving information or data transmitted from another device or block, but also acquiring by generating information by the ego device.

The indicator acquisition unit 102 acquires an indicator indicating an internal state and/or external state of the vehicle when an anomaly occurs.

The indicator may be any information indicating the internal state or external state of the vehicle, such as the outputs of various sensors connected to individual ECUs (i.e., ECUs 20e to 20h), a CAN frame, various information received from external devices, location information and time information received from a GPS receiver, etc. Specific examples of indicators are as follows:

### (a) Indicator of Internal State

The indicator of internal state includes outputs from on-board sensors, vehicle power supply status, communication network status, vehicle diagnostic information, ECU status, location information, and information for identifying the vehicle.

### (b) Indicator of External State Information

The indicator of external state information includes outside temperature, outside humidity, weather, known false positive log occurrence patterns, conditions for disabling security event logs, and an operating status of external devices outside the vehicle.

Specific examples of the indicators and examples of using the indicators will be described in detail in each embodiment.

Herein, the term “when an anomaly occurs” is not limited to a time point or time period, but may refer to an occurrence of anomaly as long as it is a condition, a trigger, or a subject of evaluation.

In the case of time point or time period, in addition to the time period (or time point) when the anomaly occurs, a time period (or time point) when the security log indicating an anomaly is generated, a time period (or time point) when the security log is received, or a time period (or time point) close to when the anomaly occurred, such as a time period (or time point) immediately before the anomaly occurred may be interpreted as when an anomaly occurs.

The term “internal state” refers to various states that depend on a mobile object, such as an operating state of a vehicle, a state of the vehicle itself or a component that constitutes the vehicle, or a state of function equipped to the vehicle. The position of vehicle is also included in the internal state since it indicates a state where the vehicle itself is physically placed in a specific position.

The term “external state” refers to various states that can be conceived without the presence of a mobile object, and includes the outside temperature, the time period (or time point), or an operating state of a device outside the mobile object.

The log acquisition unit 101 and the indicator acquisition unit 102 may be configured as a single acquisition unit.

The indicator may include the security log acquired by the log acquisition unit 101. When the internal and external states of the vehicle can be estimated using the security log, the security log can also be evaluated as an indicator of the internal and external states of the vehicle. In this case, for example, as shown in FIG. 4, a security log may be output as an indicator from the log acquisition unit 101 to the indicator acquisition unit 102.

The situation information storage unit 103 stores situation information indicating a relation between the indicator and the corresponding situation.

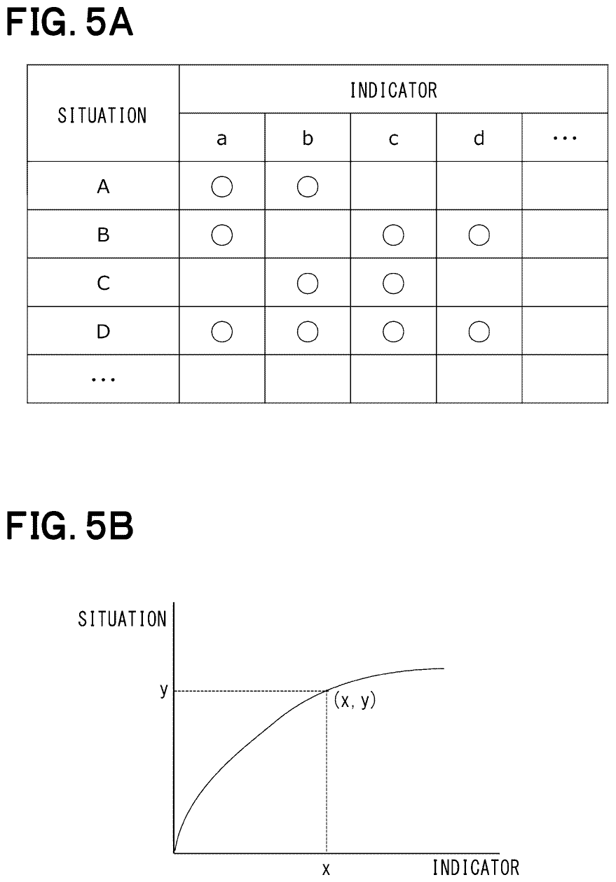

FIG. 5A and FIG. 5B each is a diagram for explaining a concept of situation information.

For example, as shown in FIG. 5A, each situation A to D is determined in accordance with corresponding combination of indicators a to d. Alternatively, as shown in FIG. 5B, there may be a relation in which the situation (y) is determined corresponding to the indicator (x). In this way, when an intermediate fact, that is, a situation can be estimated from the facts indicated by one or more indicators, the relation between the indicators and the situation can be represented by a table as shown in FIG. 5A, or a graph or a mathematical formula as shown in FIG. 5B. The information indicating the relation is referred to as situation information.

Specific examples of situation information will be described in each embodiment.

The situation estimation unit 104 estimates a situation of the vehicle corresponding to the indicator using the indicator acquired by the indicator acquisition unit 102 and the situation information stored in the situation information storage unit 103. For example, in FIG. 5A, when the indicators acquired by the indicator acquisition unit 102 are indicator a, indicator c, and indicator d, then the situation B is estimated as the situation of vehicle.

A specific example of estimating the situation will be described in each embodiment.

Here, the term “situation” of the mobile object may be any fact that is estimated from an indicator and is related to the mobile object.

The estimation in the situation estimation unit 104 is not limited to one stage, but may be multiple stages. For example, a first situation (i.e., a first intermediate fact) may be estimated from an indicator, and a second situation (i.e., a second intermediate fact) may be estimated from the first situation. In a first embodiment to be described below, two-stage estimation is performed, while in a second embodiment, one-stage estimation is performed.

The attack anomaly relation information storage unit 105 stores an attack anomaly relation table indicating a relation between cyberattacks and anomalies occurred in the electronic control system S. The attack anomaly relation table shows the relation between predicted attack information indicating an attack that the electronic control system S may receive, predicted anomaly information indicating an anomaly predicted to occur in response to the received attack, and predicted anomaly location information indicating the location within the electronic control system where the predicted anomaly may occur.

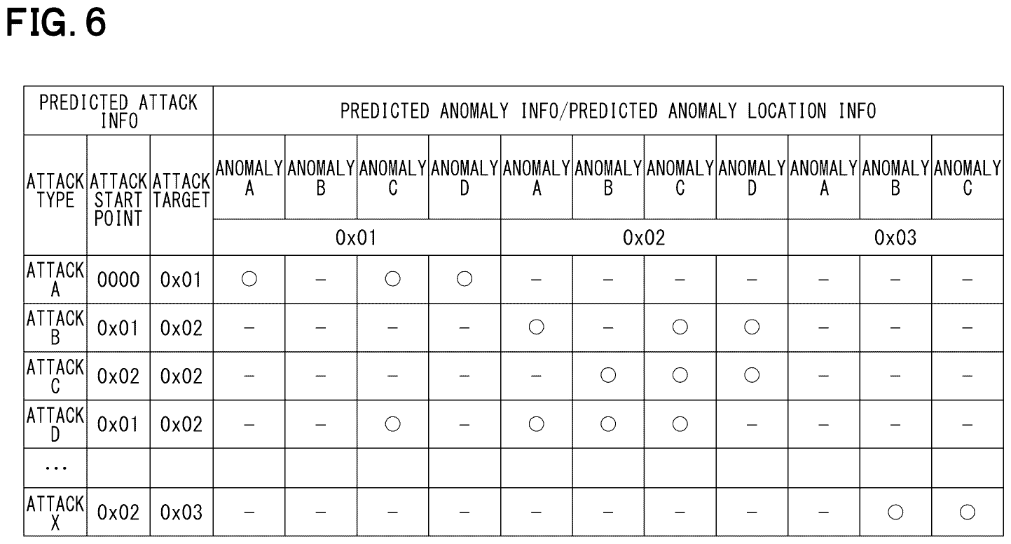

FIG. 6 is a diagram for explaining a concept of an attack anomaly relation table (corresponding to “attack anomaly relation information”) used in each embodiment.

The attack anomaly relation table shown in FIG. 6 shows, for each type of cyberattacks (e.g., attacks A to X), the anomalies (corresponding to predicted anomaly information) that will occur in the electronic control system S in response to respective cyberattacks and the locations at which the anomaly will occur (corresponding to predicted anomaly location information). When a cyberattack is received, multiple types of anomalies may occur at one or more locations. Therefore, the attack anomaly relation table indicates combinations of multiple anomalies occurred in response to the reception of cyberattack and the locations where the respective anomalies occur.

In the example illustrated in FIG. 6, the predicted attack information includes the type of cyberattack (attacks A to X), a predicted start point location of the attack and a predicted target location of the attack when the cyberattack is received. For example, the predicted attack information include (i) only the type of cyberattack, (ii) only the start point location of attack, (iii) only the target location of attack, (iv) only the start point location and the target location of attack, (v) only the start point location, the target location, and intermediate location of attack, (vi) or other information related to the cyberattack.

In FIG. 6, the predicted anomaly location, the attack start point location, and the attack target location are represented by identifiers expressed in hexadecimal numbers, and each identifier represents a location. The location corresponding to the identifier may be a concrete location or an abstract location. Specific examples of the location include the type of each ECU 20 and the type of security sensor. As an example of the former, it can be determined that 0000 corresponds to external, 0x01 corresponds to the external communication ECU 20b, 0x02 corresponds to the integration ECU 20a, and 0x03 corresponds to the zone ECU 20c. Examples of the abstract location include a hierarchy in which each ECU 20 is located, a network to which each ECU 20 is connected, and functions and characteristics of the ECUs 20.

In FIG. 6, for example, when a cyberattack of type A is received, the electronic control system S estimates that anomaly A, anomaly C, and anomaly D will occur in the external communication ECU 20b. The attack start point location of the attack A is outside the electronic control system S, and the attack target location is an external communication ECU 20b. The attack start point location may be a location inside the electronic control system S or may be outside the electronic control system S. When the attack start point location is outside the electronic control system S, the received cyberattack has started from the outside of the vehicle.

The attack anomaly relation table shown in FIG. 6 is shown in a table format. The data about attack anomaly relation may be provided in a different format of database. The name of attack anomaly relation table may be appropriately set to a different name. For example, the attack anomaly relation table may be referred to as a pattern matching table (PMT) or an anomaly detection pattern.

The attack anomaly relation table can create or generate patterns of anomaly occurrence by simulating which security sensor in which ECUs 20 will detect an anomaly in what order in the event of an attack, based on the arrangement of ECUs 20 that configure the electronic control system S, the connection relation of the ECUs 20 (also referred to as network topology), and the arrangement of security sensors installed in the ECUs 20. The attack anomaly relation table may be based on information related to the targets monitored by security sensors and rules related thereto.

The creation or generation of the attack anomaly relation table is not limited to the described method. For example, Al or machine learning may be used to generate the attack anomaly relation table. Alternatively, the patterns of anomaly occurrence may be created or generated using history data related to pattern of anomaly occurrence caused by attacks received in past.

The attack anomaly relation table shown in FIG. 6 has predicted attack information and predicted anomaly information. In addition to these types of information, the attack anomaly relation table may also have predicted non-anomaly information indicating non-anomaly event that is predicted to occur in the event of an attack, and predicted non-anomaly location information indicating a location in the electronic control system where the predicted non-anomaly event will occur. In other words, the attack anomaly relation table may be configured to indicate the relation among predicted attack information, predicted anomaly information, predicted anomaly location information, predicted non-anomaly information, and predicted non-anomaly location information. In this case, the predicted anomaly location information and the predicted non-anomaly location information may be integrated into one predicted location information.

In this case, normal logs may be used in addition to abnormal logs as security logs that are pattern matched with the attack anomaly relation table.

In addition, a security log that is determined to be a false positive abnormal log or a false positive normal log may not be used to estimating of an attack. Alternatively, weighting may be applied to the predicted anomaly information and predicted non-anomaly information included in the attack anomaly relation table, which correspond to the anomaly indicated by a security log that has been determined as a false positive anomaly log, or the non-anomaly indicated by a security log that has been determined as a false positive normal log.

The attack estimation unit 106 estimates the attack that the electronic control system S has received based on the security log acquired by the log acquisition unit 101, the attack anomaly relation table stored in the attack anomaly relation information storage unit 105, and the indicators acquired by the indicator acquisition unit 102. The attack estimation unit 106 estimates the attack on the electronic control system S based on the situation estimated by the situation estimation unit 104 using the indicator. When the situation estimation unit 104 is a separate device, the attack estimation unit 106 also serves as a situation acquisition unit that receives a situation from the situation estimation unit 104.

The term “based on” includes a case where the indicator is used directly as well as a case where the indicator is used indirectly. The term “based on” includes a case where an intermediate fact is estimated (or predicted) from the indicator and an attack is estimated using the estimated (or predicted) intermediate fact.

For example, the attack estimation unit 106 estimates, as the attack to be estimated, an attack type and/or an attack path.

In order to estimate the attack path, the predicted attack information in the attack anomaly relation table may be used. For example, when the predicted attack information indicates the attack start point location and the attack target location, the attack start point location and the attack target location are regarded as the attack path. When the predicted attack information indicates the attack start point location, intermediate location, and attack target location, the attack path may include (i) the attack start point location, intermediate location, and attack target location, or may include (ii) the attack start point location and attack target location.

In estimation of the attack path, an attack anomaly relation table in which the predicted attack information does not indicate either the attack start point location or the attack target location may be used. In this case, the predicted anomaly location in the attack anomaly relation table is used as the attack path. For example, for an attack type in which the ECU 20a, NW1, ECU 20c, NW2, and ECU 20f shown in FIG. 2 are set as the predicted abnormal locations, these predicted abnormal locations are set as the attack path. When this attack type is estimated by comparing the security log with the attack anomaly relation table, the attack path can be estimated as ECU 20a, NW1, ECU 20c, NW2, and ECU 20f. The attack direction in the estimated attack path may be estimated using data indicating a communication direction included in the context data of the security log. For example, when the communication direction indicated by the data included in the context data of the security log is from ECU 20a to ECU 20f, the attack direction may be estimated as from ECU 20a to ECU 20f. When the context data of security log includes data indicating communication in the direction from ECU 20a to ECU 20f and data indicating communication in the direction from ECU 20f to ECU 20a, the attack direction may be estimated in both directions, that is, from ECU 20a to ECU 20f and from ECU 20f to ECU 20a. In the attack anomaly relation table in which the predicted attack information does not indicate either the attack start point location or the attack target location, the attack type included in the predicted attack information may be referred to as a predicted anomaly occurrence pattern of the attack path.

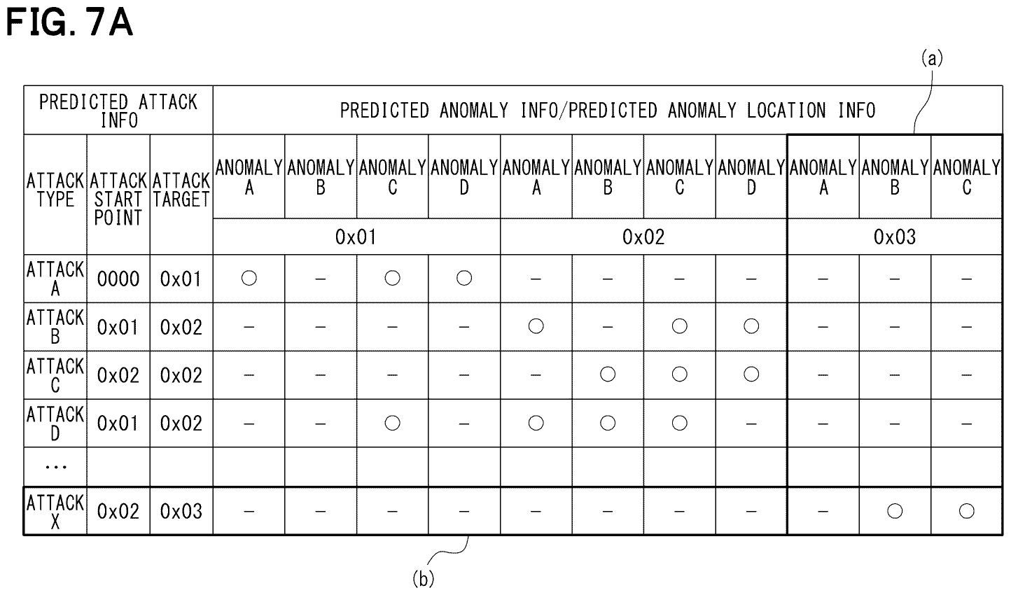

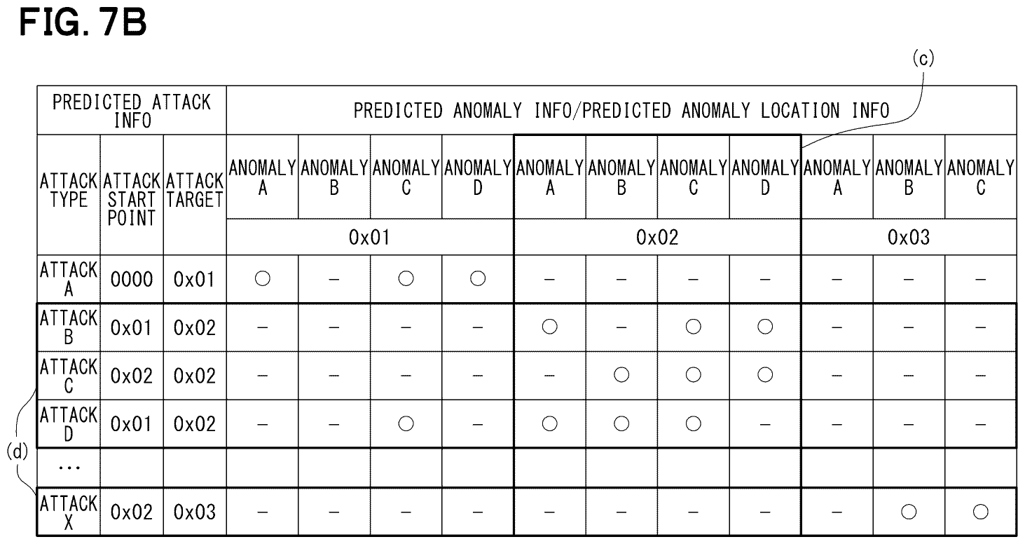

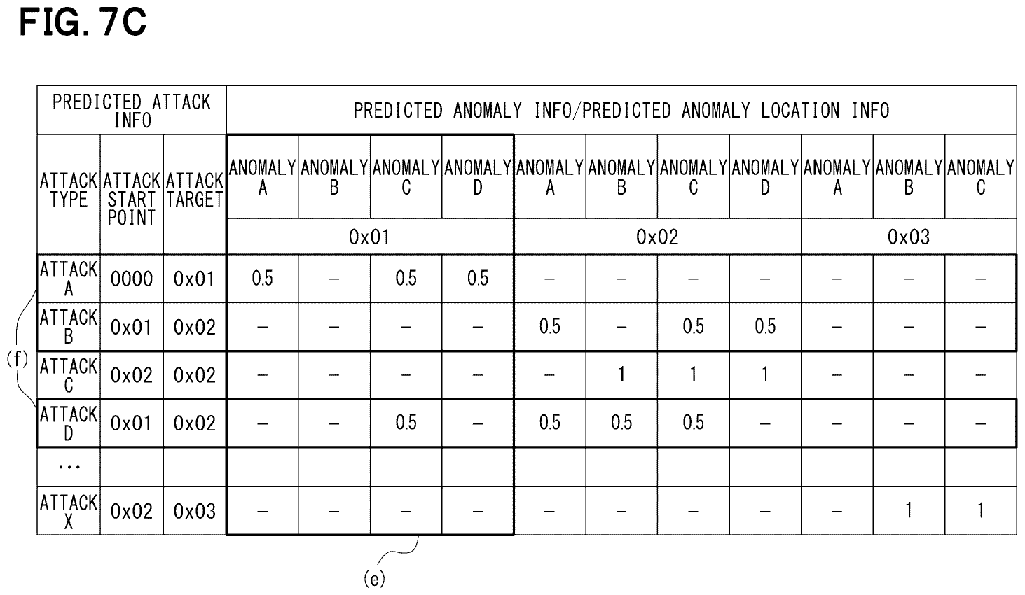

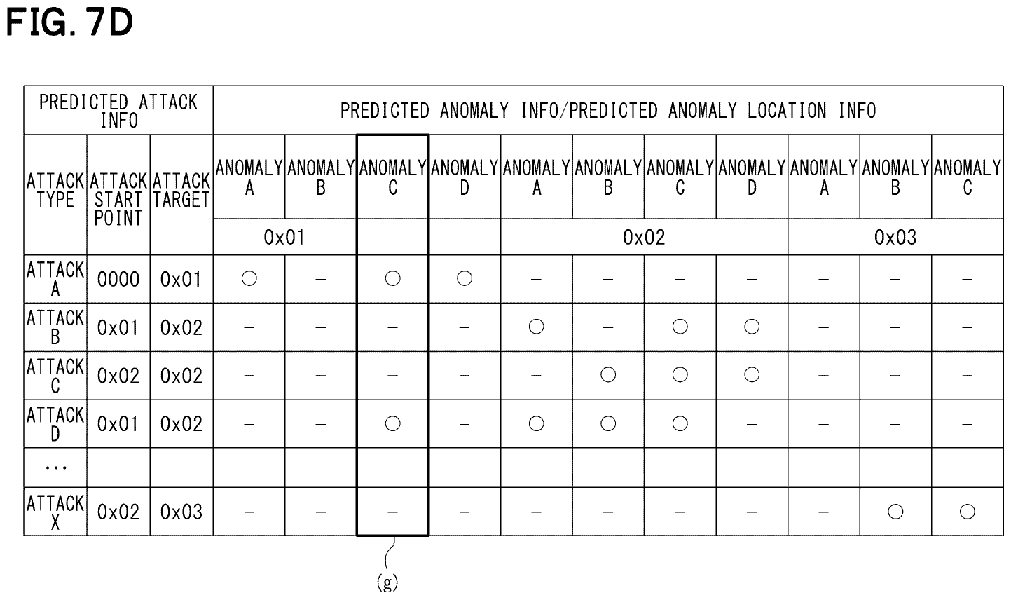

An example of attack estimation method performed by the attack estimation unit 106 will be described below with reference to FIG. 6 and FIG. 7A to FIG. 7D.

A specific example of normal attack estimation method not based on indicators will be described with reference to FIG. 6.

Suppose that the security log acquired by the log acquisition unit 101 indicates that anomalies B, C, and D are detected at the location 0x02. In the attack anomaly relation table shown in FIG. 6, the attack C corresponds to the predicted anomaly location information of 0x02 and the predicted anomaly information of anomalies B, C, and D. Therefore, the attack estimation unit 106 estimates that attack C is occurred.

Specific examples of the attack estimation method according to each example based on the indicator will be described with reference to FIG. 7A, FIG. 7B, FIG. 7C, and FIG. 7D. In each example, an attack is estimated by modifying the attack anomaly relation table.

### First Example

As described above with reference to FIG. 5A and FIG. 5B, suppose that the situation estimation unit 104 estimates a situation B using the indicators acquired by the indicator acquisition unit 102. In situation B, for example, suppose that location 0x03 is not related to a cyberattack. In this case, among the attack anomaly relation table of FIG. 7A, the attack estimation unit 106 does not use, in estimation of attack, the part shown by (a) that includes the location of 0x03 in the predicted anomaly location information, or the part shown by (b) that includes the location of 0x03 in the predicted attack information.

Since the attack estimation unit 106 performs the attack estimation without using a part of attack anomaly relation, which is estimated not to be related to cyberattack, it is possible to reduce the calculation load required for attack estimation. In particular, when the attack analysis device 10 is mounted on a vehicle and a computing resource allocated to the attack analysis device 10 is small, attack estimation can be properly performed.

The term “part” includes not only a part of one piece of attack anomaly relation information, but also at least one piece of multiple pieces of attack anomaly relation information.

The term “does not use in estimation of attack” includes not only a case where it is not actively used in the attack estimation, but also a case where a part that includes a location estimated to be related to an attack by referring to an indicator is used as predicted anomaly location information or predicted attack information for attack estimation, and the remaining part is not used passively for attack estimation.

Note that FIG. 7A describes an operation of the attack estimation unit 106 when a specific location in a certain situation is estimated to be unrelated to a cyberattack, but it can also be applied to a case where a specific anomaly in a certain situation is estimated to be unrelated to a cyberattack. For example, in situation B, it is estimated that anomaly A is not related to a cyberattack. In this case, the attack estimation unit 106 may select not to use, for attack estimation, the part of attack anomaly relation table shown in FIG. 7A that include anomaly A in the predicted anomaly information, i.e., the part of anomaly A at the locations of 0x01, 0x02, and 0x03.

It may also be applicable when a specific location and specific anomaly is estimated not to be related to a cyberattack. For example, in situation B, anomaly C at location 0x03 is estimated to be unrelated to a cyberattack. In this case, the attack estimation unit 106 may not use, in estimation of attack, the part of anomaly C at the location 0x03 in the attack anomaly relation table shown in FIG. 7A.

The above-described example is an example in which a part of one attack anomaly relation table is not used. An attack anomaly relation table may be prepared for each situation, and a corresponding attack anomaly relation table may be selected depending on the situation. In other words, for each situation, an attack anomaly relation table may be prepared that excludes predicted attack information, predicted anomaly location information, and predicted anomaly information corresponding to locations and/or anomalies that are estimated to be unrelated to a cyberattack.

### Second Example

The first example is a case where a location not related to a cyberattack is estimated from a situation, but it can also be applied to a case where a location related to a cyberattack is estimated from a situation. For example, in situation B, suppose that location 0x02 is related to a cyberattack. In this case, the attack estimation unit 106 uses, in the attack estimation, the part (c) in the attack anomaly relation table shown in FIG. 7B, which includes the location 0x02 in the predicted anomaly location information, and the part (d) in the attack anomaly relation table shown in FIG. 7B, which includes the location 0x02 in the predicted attack information.

Since the attack estimation unit 106 performs the attack estimation using the part of attack anomaly relation table, which is estimated to be related to a cyberattack, it is possible to reduce the calculation load required for the attack estimation. In particular, when the attack analysis device 10 is mounted on a vehicle and a computing resource allocated to the attack analysis device 10 is small, attack estimation can be properly performed.

The term “uses, in the attack estimation,” includes not only a case where the information is actively used in the attack estimation, but also a case where a part that includes a location estimated to be not related to an attack by referring to an indicator is not used as predicted anomaly location information or predicted attack information for attack estimation, and the remaining part is used passively for attack estimation.

FIG. 7B describes the operation of attack estimation unit 106 when a specific location in a certain situation is estimated to be related to a cyberattack, but it can also be applied to a case where a specific anomaly in a certain situation is estimated to be related to a cyberattack. For example, in situation B, anomalies A and B are estimated to be related to a cyberattack. In this case, the attack estimation unit 106 may “use, in the attack estimation,” the “part” of the attack anomaly relation table in FIG. 7B, which includes anomaly A and anomaly B in the predicted anomaly information, i.e., the parts of anomaly A and anomaly B at the locations 0x01, 0x02, and 0x03, respectively.

It may also be applicable when a specific location and a specific anomaly is estimated to be related to a cyberattack. For example, in situation B, suppose that anomalies A and B at locations 0x01 and 0x02 are related to a cyberattack. In this case, the attack estimation unit 106 may “use, in the attack estimation,” the part of anomaly A and anomaly B at locations 0x01 and 0x02 in the attack anomaly relation table shown in FIG. 7B.

The above-described example is an example in which a part of one attack anomaly relation table is used. An attack anomaly relation table may be prepared for each situation, and a corresponding attack anomaly relation table may be selected depending on the situation. In other words, for each situation, an attack anomaly relation table may be prepared that includes only predicted attack information, predicted anomaly location information, and predicted anomaly information corresponding to location and/or anomaly estimated to be related to a cyberattack.

### Third Example

In the first example, an attack was estimated without using the part of attack anomaly relation table, which is estimated not to be related to a cyberattack. In this example, an attack is estimated by weighting the part of attack anomaly relation table, which is estimated not to be related to a cyberattack.

As in the first example, in situation B, for example, suppose that location 0x01 is not related to a cyberattack. Therefore, in the attack anomaly relation table shown in FIG. 7C, the attack estimation unit 106 assigns a weight (w) to a pattern (e) that includes the location of 0x01 as predicted anomaly location information and/or to a pattern (f) that includes the location of 0x01 as predicted attack information. For example, in FIG. 7C, patterns (e) and (f) are multiplied by a coefficient of 0≤w<1, for example, w is set to 0.5 The value of coefficient can be determined appropriately with consideration of a level to which the information is not related to the cyberattack.

When such weights are assigned in the attack anomaly relation table, it is possible to estimate an attack and obtain a matching level indicating a certainty level indicating the attack is occurred in the object. The matching level can be calculated, for example, by dividing an inner product of the vector value of the attack anomaly relation table for the estimated attack and the vector value of the security log indicating the detected attack by the sum of the vector values of the attack anomaly relation table before weights are assigned to the estimated attack, but is not limited to this configuration. The matching level is calculated by the matching level calculation unit 107, which will be described later.

Matching level=(vector value of attack anomaly relation table)*(vector value of security log)/(vector value of attack anomaly relation table before weighting)

Herein, the symbol * indicates an inner product.

The matching level when no weighting is applied can be calculated as follows:

Matching level=(vector value of attack anomaly relation table)*(vector value of security log)/(vector value of attack anomaly relation table)

For example, suppose that the security log acquired by the log acquisition unit 101 indicates that anomalies A, C, and D are detected at the location 0x01. In this case, in the attack anomaly relation table of FIG. 7C, the predicted attack information in which the predicted anomaly location information is 0x01 and the predicted anomaly information corresponds to anomalies A, C, and D is attack A. Therefore, the attack estimation unit 106 estimates that attack A has occurred. The matching level can be calculated as follows.

Matching level=0.5×1 (anomaly A)+0.5×1 (anomaly C)+0.5×1 (anomaly D)/(1 (anomaly A)+1 (anomaly B)+1 (anomaly C))=1.5/3=0.5

In contrast, the matching level without weighting is calculated as follows.

Matching level=1×1 (anomaly A)+1×1 (anomaly C)+1×1 (anomaly D)/(1 (anomaly A)+1 (anomaly B)+1 (anomaly C))=3/3=1.0

The weighting in the attack anomaly relation table in FIG. 7C indicates the proportion of anomalies at each location that are related to cyberattacks, so the matching level calculated taking the weighting into account can represent the certainty that an estimated cyberattack has occurred. In this example, the matching level is calculated as 1 when weighting is not applied, i.e., the occurrence possibility of attack A is evaluated as 100%. When the weighting is applied, the matching level is 0.5, that is, the occurrence possibility of attack A is evaluated as 50%.

As another example, suppose that the security log acquired by the log acquisition unit 101 indicates that anomalies A and C are detected at the location 0x01. In this case, in the attack anomaly relation table of FIG. 7C, there is no predicted attack information whose predicted anomaly location information is 0x01 and whose predicted anomaly information completely matches anomalies A and C. The closest predicted attack information is attack A. Therefore, the attack estimation unit 106 estimates that attack A has occurred. The matching level can be calculated as follows.

Matching level=0.5×1(anomaly A)+0.5×1(anomaly C)+0.5×0(anomaly D)/(1(anomaly A)+1(anomaly B)+1(anomaly C))=1.0/3=0.33

In contrast, the matching level without weighting is calculated as follows.

Matching level=1×1(anomaly A)+1×1(anomaly C)+1×0(anomaly D)/(1(anomaly A)+1(anomaly B)+1(anomaly C))=⅔=0.66

In this example, the matching level without weighting is 0.66, indicating that the occurrence possibility of attack A is evaluated as 66%, and the matching level with weighting is 0.33, indicating that the occurrence possibility of attack A is evaluated as 33%.

In this way, the weighting can reduce the contribution degree of predicted anomaly information or predicted anomaly location information of a location estimated not to be related to an attack in a specific situation to the matching level.

Then, the attack estimation unit 106 uses the weighted attack anomaly relation table to estimate an attack, thereby enabling estimation of an attack with consideration of an association level at which the a cyberattack is related.

The above-described example is an example in which weights are assigned to the attack anomaly relation table. An attack anomaly relation table may be prepared for each situation, and a corresponding attack anomaly relation table may be selected depending on the situation. In other words, for each situation, an attack anomaly relation table may be prepared such that predicted attack information estimated to be not related to a cyberattack and/or predicted attack information corresponding to anomaly, predicted anomaly location information, and predicted anomaly information are assigned with respective weights.

### Fourth Example

In the first to third examples, the focus is on the location where anomalies occurred in relation to a cyberattack, and the attack anomaly relation table is modified before estimating an attack. In this example, the focus is on the anomaly that has occurred, and an attack is estimated for the occurred anomaly.

Based on the indicator acquired by the indicator acquisition unit 102, the situation estimation unit 104 estimates the cause of anomaly as a situation. When the estimated situation is caused by a cause other than a cyberattack, the attack estimation unit 106 determines that the anomaly indicated by the security log is not an anomaly caused by a cyberattack and determines the security log as a false positive log. The false positive log is generated when an anomaly, which is different from an anomaly caused by a cyberattack in the electronic control system S, is occurred. The estimation unit does not use the false positive log in the estimation of attack.

In this way, by not using the false positive log to estimate attacks, it is possible to reduce the calculation load required for attack estimation. In particular, when the attack analysis device 10 is mounted on a vehicle and a computing resource allocated to the attack analysis device 10 is small, attack estimation can be properly performed.

In the fourth example, attack estimation using false positive log is not performed. Alternatively, as described in the third example, an attack estimation may be made using the false positive log, but the attack anomaly relation table may be modified such that a level at which the false positive log is related to the cyberattack may be taken into consideration and reflected to the estimation.

For example, when the anomaly indicated by the false positive log is anomaly C occurring at location 0x01, a weight (w) is assigned to the part (g) in the attack anomaly relation table shown in FIG. 7D, i.e., the pattern of anomaly C at location 0x01. The weighting method may be the same as described in the third example.

In the fourth example, the unit which determines whether a security log is a false positive log corresponds to a log determination device.

Returning to FIG. 4, when a combination of an anomaly and anomaly location in a security log is not exactly the same as a combination of predicted anomaly information and predicted anomaly location information, the matching level calculation unit 107 calculates the matching level for each combination. The matching level refers to an identical level between an anomaly indicated by a security log and an anomaly indicated by the predicted anomaly information.

The output unit 108 outputs attack information indicating the attack estimated by the attack estimation unit 106. For example, the attack information may be attack type and/or an attack path. The attack information may further include the matching level calculated by the matching level calculation unit 107.

The attack information may be any information related to an attack, such as the type or type of attack, the attack path such as the start point of the attack or the target of the attack, or the damage caused by the attack.

### (5) Operation of Attack Analysis Device

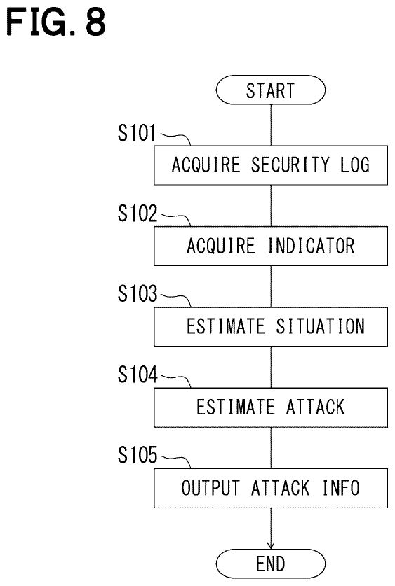

The operation of the attack analysis device 10 will be described with reference to FIG. 8. FIG. 8 not only shows an attack analysis method executed by the attack analysis device 10, but also shows a processing procedure of an attack analysis program executable by the attack analysis device 10. The process is not limited to the execution order illustrated in FIG. 8. For example, the execution order may be interchanged unless there are restrictions, such as a relation in which one step uses a result of previous step. The same applies to the flowcharts and timing charts in FIG. 8 and thereafter.

The attack analysis device 10 includes an attack anomaly relation information storage unit 105 that stores an attack anomaly relation table. The attack anomaly relation table shows the relation between predicted attack information, which indicates possible attacks on the electronic control system, predicted anomaly information, which indicates anomalies predicted to occur in response to receiving the attack, and predicted anomaly location information, which indicates the occurrence location of the predicted anomaly within the electronic control system.

In S101, the log acquisition unit 101 of the attack analysis device 10 acquires a security log indicating an anomaly detected in the electronic control system S and the location within the electronic control system S where the anomaly is detected.

In S102, the indicator acquisition unit 102 acquires an indicator indicating the internal state and/or the external state of the vehicle when an anomaly occurs (S102).

In S103, the situation estimation unit 104 estimates the vehicle situation corresponding to the indicator acquired in S102.

In S104, based on the security log acquired in S101, the attack anomaly relation table stored in the attack anomaly relation information storage unit 105, and the indicator acquired in S102, the attack estimation unit estimates an attack that has been received by the electronic control system S. In S104, in the case of using indicators, for example, the attack on the electronic control system S is estimated based on the vehicle situation estimated in S103.

In S105, the output unit 108 outputs the attack information indicating the attack estimated in S104.

### (6) Overview

As described above, according to the attack analysis device 10 of each embodiment, attack is estimated based on indicators in addition to security logs and attack anomaly relation tables, thereby improving the efficiency of calculations to estimate cyberattacks received by the electronic control system.

The situation of corresponding vehicle is estimated based on the indicator, and the attack estimation is performed based on the situation in addition to the security log and the attack anomaly relation table, so that the calculation required for attack estimation can be selected and executed corresponding to the situation. With the configuration, an efficiency of calculation to estimate cyberattack on the electronic control system can be improved.

### 2. First Embodiment

The present embodiment refers to the description of Japanese Patent Application No. 2022-158597, which is incorporated herein by reference.

The attack analysis device of the present embodiment is referred to as an attack analysis device 11.

### (1) Overview of Overall Configuration

The following will describe a configuration of an entire system including the attack analysis device 11 of the present embodiment.

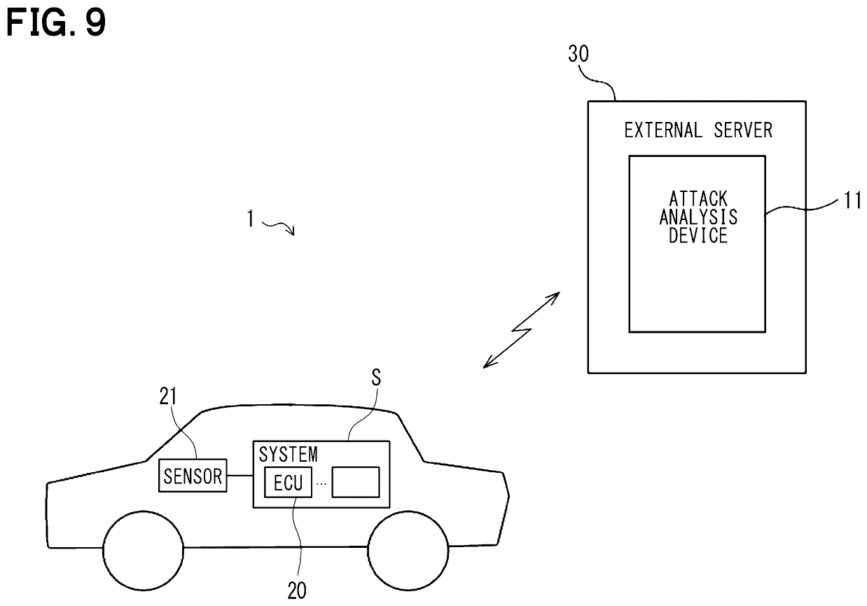

As shown in FIG. 9, in the present embodiment, the system 1 includes a vehicle (e.g., an automobile) and an external server 30. The vehicle and the external server 30 are configured to communicate with one another via a wireless communication network (e.g., the Internet, etc.), for example.

The vehicle is equipped with a vehicle control system S (i.e., an electronic control system that controls an operation of vehicle). The vehicle control system is subject to a cyberattack, and the external server 30 is equipped with the attack analysis device 11 that analyzes cyberattack received by the vehicle control system S. The attack analysis device 11 may be mounted on a vehicle.

The vehicle control system S includes multiple electronic control units (hereinafter, referred to as ECUs) 20. ECU is an abbreviation of Electronic Control Unit. In addition, various sensors and switches, (i.e., sensors 21) may be connected to the vehicle control system S in order to detect the state of each component of the vehicle control system S. Specifically, the sensors, switches, and the like that constitute the sensors 21 are connected to the ECUs 20.

The vehicle control system S receives signals (i.e., vehicle situation determination purpose signals described later, which correspond to “indicators”) detected by the sensors 21. The signals detected by the sensors correspond to indicators indicating the states of respective components of the vehicle. The vehicle situation determination purpose signal is transmitted to the attack analysis device 11 included in the external server 30. In the present embodiment, the indicator is a signal based on which a vehicle situation indicating a state of the vehicle can be estimated.

When the estimation of the vehicle situation using the indicator is performed in the vehicle, the vehicle situation obtained as a result of the estimation may be transmitted to the attack analysis device 11 included in the external server 30.

As described below, in the event of a cyberattack in the vehicle control system S, a security sensor (not shown) installed in each ECU 20 detects the occurrence of an anomaly caused by the cyberattack and generates a vehicle log (i.e., an anomaly log, which is a signal indicating the anomaly, hereafter referred to as a “security log”). The generated vehicle log is then transmitted to the attack analysis device 11 included in the external server 30.

### (Vehicle Control System)

The vehicle control system S controls an operation of the vehicle, and each ECU 20 is connected via a bus (not shown) or the like within the vehicle control system. The ECUs 20 are connected to one another via an in-vehicle network.

A power supply state of each ECU 20 can be individually controlled. As described later, the power supply state can be changed to a stopped or sleep state depending on the vehicle situation indicating the overall state of the vehicle (i.e., the state of the vehicle defined in accordance with each vehicle situation determination purpose signal).

In the above description, “stop” indicates a state in which power is not supplied to the ECU 20, and “sleep” indicates a state in which the ECU 20 stops normal operation and waits to resume normal operation until, for example, a wake-up signal or the like is input. In the sleep state, lower power is supplied than the normal power supplied during normal operation, thereby contributing to power saving.

The ECU 20 arranged in the vehicle control system S is equipped with the security sensor that monitors the inside of the ECU 20 and the network to which the ECU 20 is connected. When the security sensor detects an anomaly occurred within the ECU 20 or in the network, the security sensor generates the vehicle log as a security log.

The vehicle log includes anomaly information (corresponding to “anomaly”) indicating the anomaly detected by the security sensor, and anomaly location information (corresponding to “location”) indicating the location where the anomaly detected by the security sensor occurred. The vehicle log may further include identification information for identifying the electronic control system S, identification information of the security sensor that has detected the anomaly, identification information of the ECU 20 to which the security sensor is equipped, anomaly detection time, the number of times by which the anomaly is detected, a detection order of the anomalies, and information about content and IP address of received data (for example, transmission source and transmission target) before detection of the anomaly.

### (Attack Analysis Device)

The attack analysis device 11 is a device that analyzes a cyberattack based on vehicle logs generated in the vehicle when the vehicle (more specifically, the vehicle control system S) is subjected to a cyberattack.

The attack analysis device 11 is a well-known electronic processing device including a CPU, and memories such as ROM and RAM. The attack analysis device 11 may be equipped with a well-known microcomputer (not shown). In addition, the memory is not limited to a memory included in the microcomputer, and may be various storage mediums (for example, a hard disk or the like) disposed outside the microcomputer.

Various functions executed by the electronic control unit (ECU 20) and the electronic processing device are implemented by the CPU executing programs stored in a non-transitory tangible storage medium. In the present disclosure, the memory corresponds to a non-transitory tangible storage medium for storing a program. By executing the program stored in the non-transitory tangible storage medium, a method corresponding to the program is executed.

The memory stores not only various programs (e.g., a program for analyzing cyberattacks) but also various data (e.g., various tables) used in execution of the various programs.

A method for implementing the various functions of the electronic control unit (ECU 20) and electronic processing device is not limited to in software manner, and partial or entire elements may be implemented by one or more hardware circuits. For example, when the above functions are implemented by an electronic circuit, which is hardware circuit, the electronic circuit may be provided by a digital circuit including large number of logic circuits, an analog circuit, or a combination of digital circuit and analog circuit.

### (2) Configuration and Function of Attack Analysis Device

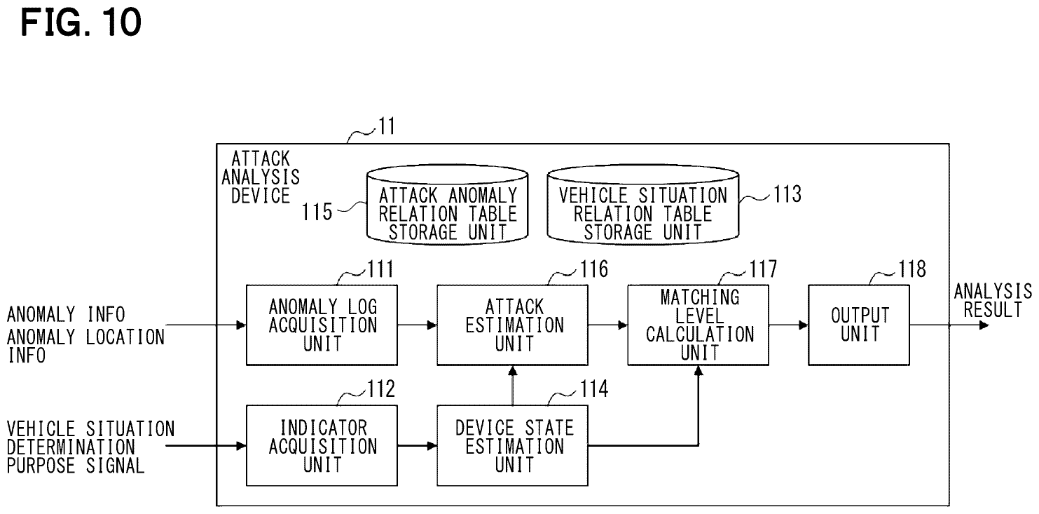

The following will describe a functional configuration of the attack analysis device 11 with reference to FIG. 10.

In the present embodiment, as shown in FIG. 10, the attack analysis device 11 functionally includes an anomaly log acquisition unit 111, an indicator acquisition unit 112, a vehicle situation relation table storage unit 113, a device state estimation unit 114, an attack anomaly relation table storage unit 115, an attack estimation unit 116, a matching level calculation unit 117, and an output unit 118.

The following will describe each unit of the attack analysis device 11.

a) The anomaly log acquisition unit 111 (corresponding to a log acquisition unit) is configured to receive a vehicle log transmitted from the vehicle. As described above, the vehicle log includes anomaly information indicating the content of anomaly caused by a cyberattack. The cyberattack is detected by the security sensor. The vehicle log also includes anomaly location information indicating a location where the anomaly is occurred.

The anomaly information indicates a type of anomaly. The anomaly location information also includes information indicating the location of ECU 20 in which anomaly is occurred and information indicating the location of bus connected to the ECU 20 in which anomaly is occurred.

Examples of the anomaly occurred in the ECU 20 include an anomaly in information (i.e., a frame) transmitted and received between the ECUs 20 (hereinafter referred to as a frame anomaly), an anomaly in the bus (hereinafter referred to as a bus anomaly), and a host type anomaly. The anomaly may be a variety of anomalies caused by cyberattacks on the vehicle control system S, such as the frame anomaly, the bus anomaly, or the host type anomaly.

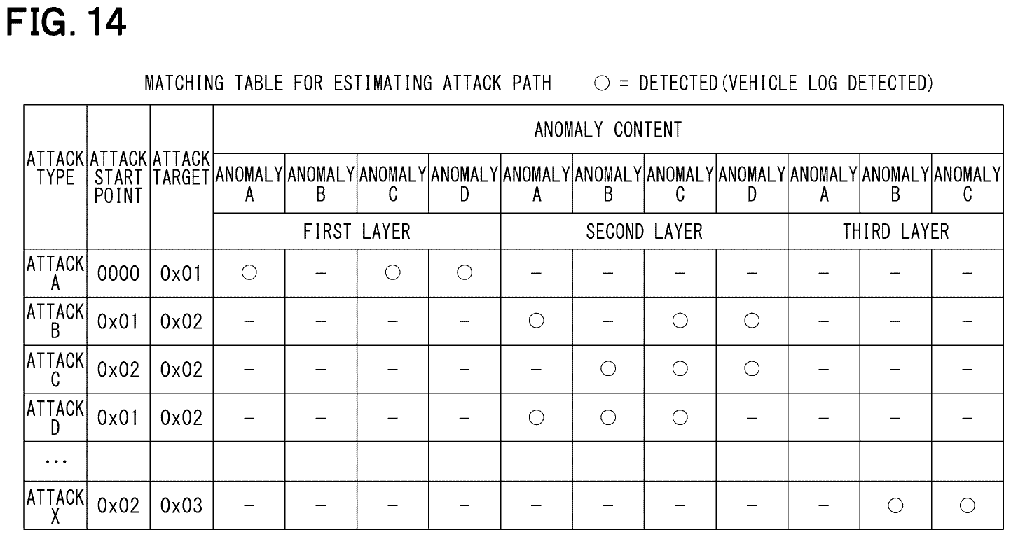

In the present embodiment, as will be described later with reference to FIG. 14, the anomaly information includes a type of anomaly, such as anomaly A, B, C, D. Examples of the location of anomaly include a first layer to a third layer. The number of types of anomalies and the number of layers are not limited to the above-described example.

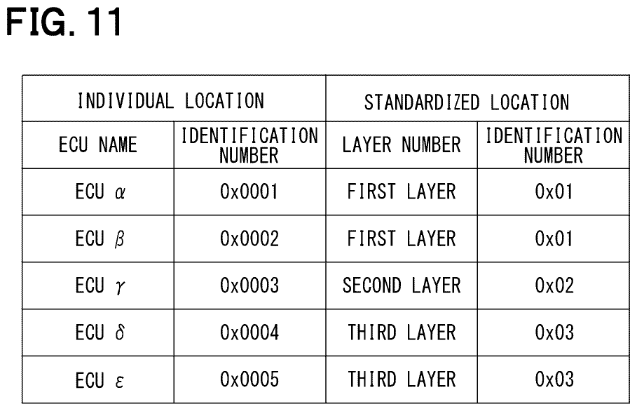

The following will describe the first to the third layers with reference to FIG. 11.

The first to the third layers are obtained by dividing multiple ECUs 20 into three types, for example, dividing ECUs 20 performing the same operation in a vehicle situation. That is, the ECUs 20 are divided into two groups in each of which power operation (ON/OFF state) is the same within the divided group. It should be noted that the off state includes the sleep state.

For example, as shown in FIG. 11, a case will be described in which multiple ECUs α to ECU ϵ correspond to examples of the ECU 20, and each ECUs α to ϵ is assigned with an identification number (i.e., an identification number for an individual location).

Since ECU a and ECU B have the same power on/off operation in the same vehicle situation, same identification number (i.e., identification number indicating a standardization location), for example 0x01, is assigned to the ECU α and ECU β as the first layer ECU 20.

In the example shown in FIG. 11, there is no ECU 20 that has the same power on/off operation as the ECU γ, an identification number indicating a standardization location, for example, 0x02, is assigned to the ECU γ as the second layer ECU 20.

Since ECU δ and ECU ϵ have the same power on/off operation in the same vehicle situation, same identification number indicating a standardization location, for example, 0x03 is assigned to the ECU δ and ECU ϵ as the third layer ECU 20.

Although the first to third layers in which each ECU 20 is standardized is described as an example, the anomaly location may be simply indicated by the location of each ECU 20 (for example, an identification number indicating an individual location) without performing the standardization.

b) The indicator acquisition unit 112 is configured to receive a vehicle situation determination purpose signal transmitted from the vehicle as shown in FIG. 10.

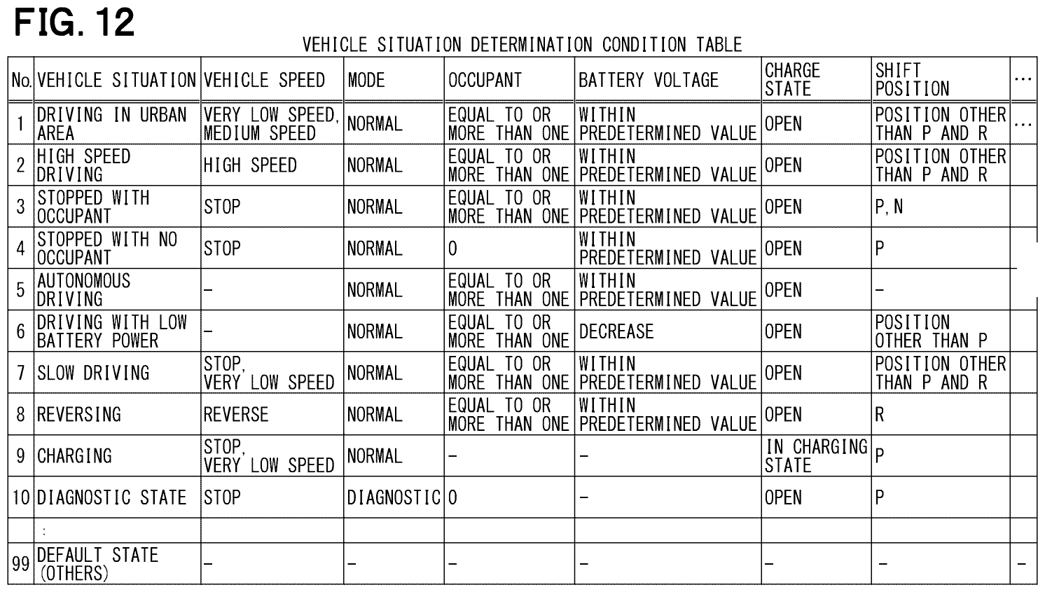

As described above, the vehicle situation determination purpose signal serves as an indicator indicating a state of each component of the vehicle detected by the sensor 21, and is used for the purpose of estimating the vehicle situation based on the vehicle situation determination condition table (see FIG. 12) described later.

c) The device state estimation unit 114 corresponds to a situation estimation unit, and is configured to estimate the vehicle situation.

The device state estimation unit 114 estimates, using the vehicle situation determination purpose signal received by the indicator acquisition unit 112, a vehicle situation indicating an overall state of the vehicle based on a vehicle situation determination condition table (see FIG. 12) to be described later.

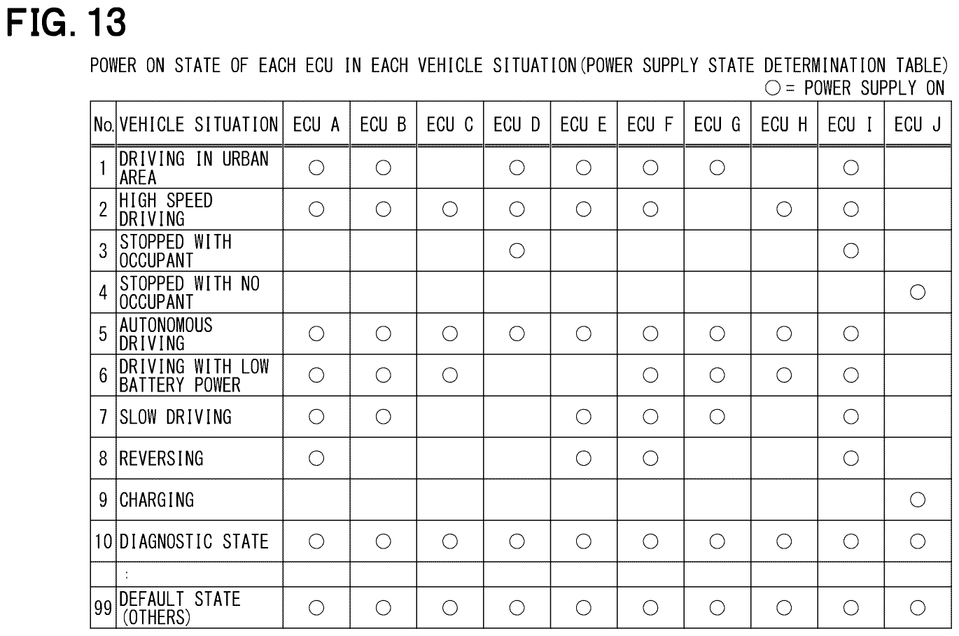

The device state estimation unit 114 further estimates a power supply state (corresponding to a situation) of each ECU 20, specifically, whether each ECU is in on state or off state, based on the vehicle situation and a power supply state determination table (see FIG. 13) to be described later. The on/off state of each ECU 20 may be estimated by the attack estimation unit 116.

d) The attack estimation unit 116 corresponds to an attack estimation unit, and is configured to estimate an attack path and a type of cyberattack.

The attack estimation unit 116 is configured to estimate the attack path and the attack type based on information indicating whether the power of each ECU 20 is in on state or off state (corresponding to the situation), which is obtained based on the vehicle situation estimated by the device state estimation unit 114 and information of the vehicle log obtained from the anomaly log acquisition unit 111 (i.e., anomaly information of anomaly A to anomaly D and standardized anomaly location information of each layer). The estimation procedure will be described in detail later.

e) The matching level calculation unit 117 calculates a matching level between (i) a combination of anomaly information and anomaly location information and (ii) a combination of predicted anomaly information and predicted anomaly location information shown in FIG. 14. The details will be described later.

The matching level can be expressed, for example, as a percentage (e.g., %) of the matching level of the anomalies by comparing (i) the combination of anomalies indicated by the actually acquired vehicle logs with (ii) the combination of anomalies from the predicted anomaly patterns included in the matching table for estimating attack path, which will be described later.

For example, when four anomalies in the vehicle log perfectly match four anomalies in the predicted anomaly pattern, the matching level is 100%. When three out of four anomalies match, the matching level is ¾ of 100%, that is, 75%.

The matching level may be expressed, for example, by a numerical value obtained by dividing a difference between (i) the number of anomalies indicated by the vehicle log and (ii) the number of anomalies indicated by the predicted anomaly pattern by the number of anomalies indicated by the vehicle log or the number of anomalies indicated by the predicted anomaly pattern.

f) The output unit 118 is configured to output an estimation result estimated by the attack estimation unit 116 and the calculation result calculated by the matching level calculation unit 117.

g) The vehicle situation relation table storage unit 113 is set in a memory, and stores a vehicle situation determination condition table as shown in FIG. 12 and a power supply state determination table indicating the power supply state of each ECU 20 for each vehicle situation as shown in FIG. 13.

### (Vehicle Situation Determination Condition Table)

The following will describe the vehicle situation determination condition table with reference to FIG. 12.

As shown in FIG. 12, the vehicle situation determination condition table includes indicators arranged in horizontal direction (column arrangement direction, also referred to as column direction). Each indicator indicates a state of each component of the vehicle. The vehicle situation determination condition table includes overall states of the vehicle (e.g., driving state, etc.) arranged in vertical direction (row arrangement direction, also referred to as row direction).

Each indicator indicates a state of component of the vehicle, and is related to the situation determination purpose signal, which indicates the state of each component obtained from the sensor 21. Examples of such indicators include vehicle speed, mode (e.g., driving mode or diagnostic mode), occupant (e.g., number of occupants), battery voltage, charge state, shift position, and the like.

The vehicle situation indicates an overall state of the vehicle specified by the indicator. Examples of vehicle situation include at least one of the followings: driving in urban area; high speed driving, stopped with an occupant, stopped with no occupant, autonomous driving, driving with low battery power, slow driving, reversing, in charging state, in diagnostic state, or a default state other than the above-mentioned exemplary states.

The default state may be, for example, an undeterminable state, an unclear situation state, or other initial setting state that is set in advance.

Driving in urban area can be determined, for example, by determining whether the vehicle is driving in a specific city based on map data or whether the vehicle is driving at a speed lower than a predetermined speed set in advance. High speed driving may be determined by determining whether the vehicle is driving on a highway or determining whether the vehicle is driving at a speed equal to or higher than the predetermined speed set in advance. Autonomous driving of the vehicle may be determined by determining whether the autonomous driving mode of the vehicle is activated. Driving with low battery power may be determined in response to the remaining battery power decreasing to equal to or lower than a predetermined level while the vehicle is in traveling state. Slow driving of the vehicle may be determined in response the vehicle speed being lower than a predetermined low speed.

By using the vehicle situation determination condition table, each vehicle situation can be estimated from the state of each component specified by the vehicle situation determination purpose signal (for example, the state indicated by each indicator such as vehicle speed and shift position).

### (Power Supply State Determination Table)

The following will describe the power supply state determination table with reference to FIG. 13.

As shown in FIG. 13, in the power supply state determination table, power supply on state (ON) and off state (OFF) of each ECU 20 (e.g., ECUs A to J) are arranged in horizontal direction of the drawing, and each vehicle situation is arranged in vertical direction of the drawing.

By using the power supply state determination table, it is possible to specify the power supply on/off state of each ECU A to J in each vehicle situation.

Among the ECUs A to J, ECUs that have the same power on/off state in each vehicle situation are included in the same layer. For example, ECU A and ECU F are regarded as ECUs 20 in the same layer, and ECU C and ECU H are regarded as ECUs 20 in the same layer.

### (Attack Path Estimation Matching Table)

h) The attack anomaly relation table storage unit 115 corresponds to an attack anomaly relation information storage unit, and is set in a memory. The attack anomaly relation table storage unit 115 stores a matching table for estimating an attack path (corresponding to attack anomaly relation information) as shown in FIG. 14.

In the matching table for estimating the attack path, along the horizontal direction of drawing, predicted anomaly information corresponding to each type of anomaly detected by the security sensor and predicted anomaly location information indicating location of each anomaly occurred in each layer including the ECUs 20 are arranged. In the matching table for estimating the attack path, along the vertical direction of drawings, cyberattack types and cyberattack paths are arranged. The predicted anomaly information is arranged corresponding to the predicted anomaly location in relation to each layer.

The predicted anomaly information indicates the type of anomaly that is predicted to occur when the vehicle actually receives a cyberattack. The predicted anomaly location information indicates a location of anomaly that is predicted to occur when the vehicle actually receives a cyberattack.

The type of anomaly is, for example, anomalies A to D, and the location of the anomaly is each layer including each ECU 20 (for example, the first layer to the third layer). The type of cyberattack (i.e., attack type) includes, for example, attack A to attack X. The attack path is, for example, an estimated path defined by the location of attack start point and the location of target of attack. Attacks A to X include various known cyberattacks.

As described above with reference to FIGS. 11, 0x01 to 0x03 for the attack start point and the attack target indicate standardized first to third layer identification numbers, and 0000 indicates the outside of vehicle.

With this configuration, the matching table for estimating an attack path is a table that shows the relation among the type of anomaly, the location of anomaly, the attack type, and the attack path when the attack type and attack path can be determined in response to occurrence of an anomaly, which is indicated by the type of anomaly, such as, anomalies A to D and the location of anomaly, such as corresponding layer.

Therefore, by using the matching table for estimating attack path, it is possible to determine or estimate the attack type and attack path from the type of anomaly and the location of anomaly.

### (3) Attack Type and Attack Path Estimation Method

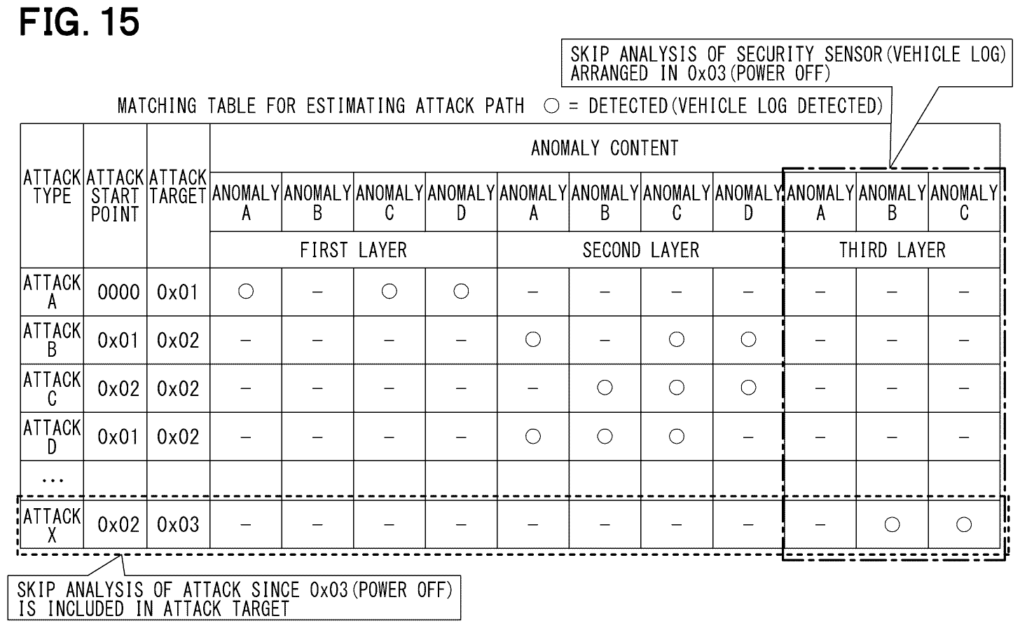

The following will describe a method for estimating an attack type and an attack path using the matching table for estimating attack path with reference to FIG. 15.

In the present embodiment, the attack type and the attack path are estimated by comparing (i) a combination of anomaly information indicating the type of actually occurred anomaly included in the vehicle log and anomaly location information indicating the location where the anomaly actually occurred with (ii) a combination of predicted anomaly information and predicted anomaly location information included in the matching table for estimating attack path.

### (Basic Estimation Method)

First, a basic estimation method for estimating attack type and attack path will be described.

In this estimation method, vehicle logs from all ECUs 20 (layers) are analyzed. For example, the anomaly location and anomaly type are determined from a group of vehicle logs received within a certain time period (i.e., a group of vehicle logs to be analyzed for attack analysis). Then, the method determines the actually occurred anomaly corresponds to which anomaly in the attack estimation matching table (i.e., which location of column and which location of row in the table).

With this configuration, it is possible to determine the anomaly pattern (the actual anomaly pattern that indicates the arrangement of whether there is actual anomaly) of actual vehicle log, which corresponds to the predicted anomaly pattern (the arrangement pattern of circle in each row) included in the matching table for estimating attack.

Therefore, by comparing the actual anomaly pattern with the predicted anomaly pattern included in the matching table for estimating attack, using the matching table for estimating attack, the attack type and attack path can be estimated.

For example, when an actual anomaly pattern and a predicted anomaly pattern completely match with one another, the attack type and attack path can be identified from the matching table for estimating attack. When the actual anomaly pattern does not completely match the predicted anomaly pattern, the attack type and attack path can be estimated according to the matching level.

The following will describe an example of the above-described process. It should be noted that the present disclosure is not limited to this example. Estimation of attack path by the attack analysis device will be described as an example.

(Step 1) The attack analysis device acquires a group of vehicle logs (i.e., one or more vehicle logs) that serve as input for attack path estimation.

(Step 2) The attack analysis device estimates an attack path by following the steps (2-1) to (2-5) described below.

(2-1) The attack analysis device analyzes one of the vehicle logs to determine which ECU 20 (which layer), that is, which security sensor has the anomaly indicated by the vehicle log (that is, determines the anomaly location and anomaly type).

(2-2) The attack analysis device determines, by referring to the matching table for estimating attack, which ECU 20 (that is, which layer) in the column direction (horizontal direction) of the matching table for estimating attack has the anomaly (i.e., which column the anomaly relates to).

(2-3) The attack analysis device checks, for the identified column, the presence or absence of anomaly along the row direction (vertical direction) of the matching table for estimating attack. When a row with circle is checked, the corresponding attack path is stored as a candidate attack path.

(2-4) The attack analysis device repeats the process (2-3) until the end of identified column along the row direction (checks by the number of attack paths).

(2-5) The attack analysis device returns to (Step 1) and performs the estimation of attack path for the next vehicle log.

(Step 3) After all vehicle logs have been checked, the stored candidate attack paths are stored as estimation result of attack path. The attack path candidate indicates the attack path candidate before the output is finalized. When the same attack path candidate is estimated for multiple times, the attack path candidate estimated later is not stored repeatedly.

(Step 4) The attack analysis device outputs the stored attack paths as estimation result.

### (Estimation Method According to Power Supply State)

The main steps in this estimation method are similar to the above-described basic estimation method. The following will mainly explain, in detail, the method of estimating the attack type and attack path, which is performed in response to the power being turned on and off in the ECU 20.

In the estimation method according to power supply state, for example, as shown in an area surrounded by a dashed line in FIG. 15, when an ECU 20 (a layer) in power off state is included in the attack target (or the start point of attack), the attack analysis devices skips the attack analysis. In other words, considering that ECU 20 in power off state cannot be the start point or target of a cyberattack. The ECU 20 in power off state is presumed not to be related to a cyberattack, therefore attack analysis can be skipped.

For example, as shown in an area surrounded by dash-dot line in FIG. 15, the analysis of the vehicle log corresponding to anomalies A to D related to the ECU 20 whose power is in off state (the third layer) is skipped. In other words, since vehicle logs cannot be generated by the ECU 20 in power off state, the ECU 20 is presumed not to be related to a cyberattack, therefore analysis of this ECU can be skipped.

The following will describe a specific example in process order, but the process is not limited to the configuration described below. The following will describe an example of estimating an attack path by the attack analysis device.

(Step 1) The attack analysis device acquires a group of vehicle logs (i.e., one or more vehicle logs) that serve as input for attack path estimation.

(Step 2) The attack analysis device estimates an attack path by following the steps (2-1) to (2-7) described below.

(2-1) The attack analysis device analyzes one of the vehicle logs to determine which ECU 20 (which layer), that is, which security sensor has the anomaly indicated by the vehicle log (that is, determines the anomaly location and anomaly type).

(2-2) As a result of the above-described process (2-1), when the vehicle log to be analyzed is a vehicle log corresponding to one of anomalies A to D of ECU 20 that is estimated to be turned off because the power is in off state, the subsequent process, that is the process in (2-3) to (2-6) is skipped, and the process returns to (Step 1) to analyze the next vehicle log. For example, analysis of vehicle log within the area surrounded by the dash-dot line in FIG. 15 is not performed.

(2-3) The attack analysis device identifies, with reference to the matching table for estimating attack, the security sensor of which ECU 20 (which layer) in the column direction (horizontal direction) of the matching table for estimating attack has an anomaly, that is, the anomaly relates to which column.

(2-4) The attack analysis device checks, for the identified column, the presence or absence of anomaly along the row direction (vertical direction) of the matching table for estimating attack. When a row with circle is checked, the corresponding attack path is stored as a candidate attack path.

(2-5) During the execution of process in (2-4), if either the ECU 20 (the layer) from which the attack starts or the ECU 20 (the layer) corresponding to the target of attack is in power off state, the attack analysis device skips checking for the presence or absence of anomaly. For example, analysis of attack within the area surrounded by the dashed line in FIG. 15 will be skipped.

(2-6) The attack analysis device repeats the process in (2-4) and (2-5) until the end of identified column along the row direction (checks by the number of attack paths).

(2-7) The attack analysis device returns to (Step 1) and performs the estimation of attack path for the next vehicle log.

(Step 3) After all vehicle logs have been checked, the stored attack path candidates are stored as estimation result of attack path. The attack path candidate indicates the attack path candidate before the output is finalized. When the same attack path candidate is estimated for multiple times, the attack path candidate estimated later is not stored repeatedly.

(Step 4) The attack analysis device outputs the estimation result of attack path.

When the matching result of all vehicle logs shows that the actual vehicle logs match anomalies A, C, and D in the first layer, for example, as in attack A in FIG. 15 (that is, 100% matching level), the attack analysis device estimates that the cyberattack has an attack path with the attack start point at 0000 and the attack target at 0x01. The attack analysis device can estimate the cyberattack is attack A.

When the pattern of combination (actual anomaly pattern) in which anomaly information of actual vehicle log is combined with anomaly location information of actual vehicle log matches the pattern in one row of the matching table for estimating attack (corresponding to predicted anomaly pattern), the attack path and attack type corresponding to the predicted anomaly pattern can be suitably estimated as attack path and attack type of actual attack.

For example, when the vehicle log only partially matches one row of the anomaly pattern in the matching table for estimating attack, the attack analysis device can determine that the matching level is low. For example, when only two out of three match, the attack analysis device can determine matching level as ⅔.

For example, when the anomaly based on the acquired vehicle log (the anomaly in the actual anomaly pattern) is located in the second layer in the matching table for estimating attack and the anomaly types are three, corresponding to anomaly A, anomaly B, and anomaly C, then by referring to the predicted anomaly pattern in the matching table for estimating attack, the attack analysis device estimates the attack type (or attack path) as attack B, attack C, and attack D.

In this case, the attack analysis device estimates the matching level as ⅔ for attack B, ⅔ for attack C, and 3/3 (that is, 100%) for attack D.

### (4) Details of Process

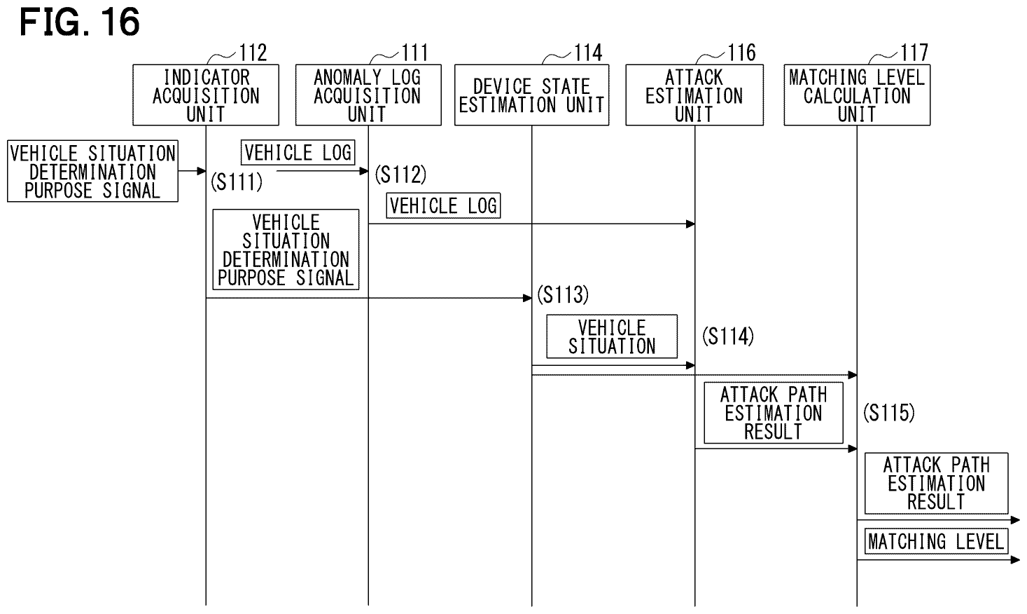

The following will describe a process executed by the attack analysis device 11 with reference to a timing chart of FIG. 16.

The indicator acquisition unit 112 receives a vehicle situation determination purpose signal from the vehicle control system S of the vehicle in S111.

The anomaly log acquisition unit 111 receives a vehicle log including anomaly information and anomaly location information from the vehicle control system S of the vehicle in S112.

The device state estimation unit 114 estimates the vehicle situation based on the vehicle situation determination purpose signal by using the vehicle situation determination condition table in S113.

The attack estimation unit 116, using the matching table for estimating attack, compares (i) the combination of anomaly type and anomaly location included in the vehicle log obtained from the anomaly log acquisition unit 111 with (ii) multiple predicted anomaly patterns that are predicted to occur in the event of cyberattack (that is, by matching the combination of the anomaly type and anomaly location included in the vehicle log with the predicted anomaly patterns in the matching table for estimating attack), thereby estimating the attack path and type of the cyberattack in S114.

In the present embodiment, as described above, when the attack estimation unit 116 estimates an attack path, the calculation range for the estimation is set by identifying a powered-off ECU 20 based on the power state determination table and the vehicle situation estimated by the device state estimation unit 114. Then, for the identified powered-off ECU 20, process unnecessary for estimating the attack path is not performed.

As shown in FIG. 15, for the area surrounded by the dashed line, when the ECU 20 (the layer) whose power is in off state is included in the attack target (or the start point of attack), the analysis of this attack is not performed by skipping the analysis. For example, as shown in the are surrounded by the dash-dot line in FIG. 15, analysis of the vehicle log generated by the security sensor included in the powered off ECU 20 (for example, the third layer) is not performed by skipping the analysis.

As shown in the power supply state determination table, the power on/off state of each ECU 20 is determined in accordance with the vehicle situation. As shown in the table of FIG. 11, the ECU 20 corresponding to each layer is determined in advance.

The estimation result, such as the attack path estimated by the attack estimation unit 116 and the vehicle situation estimated by the device state estimation unit 114 are output to the matching level calculation unit 117.

The matching level calculation unit 117 calculates the matching level by the various methods described above in S115.

The ECU 20 that is in power off state at the generation time of vehicle log is identified based on the vehicle situation. When there is an ECU 20 whose power is in off state at the generation time of vehicle log, the identified ECU is not included in the calculation of matching level.

The estimated result of attack path and the matching level are output to the output unit 118, and the analysis result (the estimated result of attack path and the matching level) are output from the output unit 118 to a specified device disposed outside the attack analysis device 11 (e.g., a storage device of the external server 30)

### (5) Effects

(a) According to the present embodiment, the attack path and/or attack type of cyberattack can be estimated by comparing the anomaly information and anomaly location information included in the vehicle log with multiple predicted anomaly patterns that are predicted to occur in the event of cyberattack.

When estimating an attack path, an estimation range is determined based on the vehicle situation, such that the necessary calculation can be selected and performed according to the vehicle situation. With this configuration, it is possible to improve the calculation efficiency of attack estimation, that is, estimation of attack type and attack path. Thus, calculation load for estimating attack can be reduced.

In the present embodiment, the estimation range for estimating an attack path can be determined set based on the power on/off state of ECU 20 obtained from the vehicle situation. For example, for the vehicle log of the ECU 20 in power off state, calculation for estimating the attack path can be omitted. With this configuration, it is possible to improve the efficiency of calculation of attack estimation, such as estimation of attack path, thereby reducing the calculation load.

(b) In the present embodiment, the predicted anomaly pattern is linked to the ECU 20 corresponding to start point of attack and the ECU 20 corresponding to target of attack. When the ECU 20 corresponding to the start point of attack or the ECU 20 corresponding to the target of attack is included in the powered-off ECUs 20 in the vehicle situation when an anomaly is detected, the process of estimating the attack path can be skipped for the predicted anomaly pattern linked to the powered-off ECU 20.

(c) In the present embodiment, for predicted anomaly patterns that correspond to the powered-off ECU 20 in the vehicle situation when an anomaly is detected, the process of estimating attack path can be skipped.

(d) In the present embodiment, a table showing the relation between the attack path and/or attack type, predicted anomaly information indicating the type of anomaly predicted to occur in the event of cyberattack, and predicted anomaly location information indicating the location of anomaly predicted to occur in the event of cyberattack is used as the matching table for estimating attack, and is used in the estimation of attack path.

Therefore, the attack path and attack type of a cyberattack can be estimated from a combination (corresponding to predicted anomaly pattern) of predicted anomaly information and predicted anomaly location information included in the matching table (corresponding to attack estimation matching table in which combinations of anomaly types and anomaly locations are defined) corresponding to a combination (corresponding to an actual anomaly pattern) of anomaly type and anomaly location actually obtained.

(e) In the present embodiment, the matching level can indicate a level of similarity between the information included in the vehicle log and the predicted anomaly pattern.

(f) In the present embodiment, the vehicle situation can be at least one of the following: driving in urban area, driving at high speed equal to or higher than a predetermined speed, stopped with occupant, stopped with no occupant, autonomous driving, driving with low battery charge below a predetermined level, slow driving at a speed lower than a predetermined speed, reversing, battery charging, diagnosis state, and a default state other than the various states described above. Note that the vehicle situation is not limited to these examples, and may include various vehicle situations indicating the state of vehicle (for example, the moving state or use state of the vehicle).

### (6) Modification of the Present Embodiment

Although the embodiments of the present disclosure have been described above, the present disclosure is not limited to the above embodiments and can be modified as necessary. The following modifications can be properly applied to the present embodiment as well as other embodiments.

(2a) In the present embodiment, a vehicle is used as an example of a device equipped with the electronic control system S that is subject to cyberattacks. The present disclosure is not limited to the above-described electronic control system S, and can be applied to any electronic control system equipped with multiple ECUs. For example, the electronic control system S may be an electronic control system mounted on any mobile body, or may be mounted on a stationary body rather than a mobile body.

(2b) In the present embodiment, an example has been given in which the attack analysis device 11 is mounted on an external server. Alternatively, partial or entire part of attack analysis device 11 may be mounted on a vehicle.

(2c) In the present embodiment, the ECUs are standardized, but the standardization may not be performed in the ECUs. In this case, for example, an attack estimation matching table in which each ECU location is defined instead of each layer in FIG. 14 can be used.

(2d) The contents estimated by the present disclosure may include only the attack path of cyberattack, only the attack type of cyberattack, or both of attack type and attack type of cyberattack.

(2e) The attack analysis device 11 described in the present disclosure may be implemented by a dedicated computer provided by configuring a processor and a memory programmed to execute one or more functions implemented by a computer program.

Alternatively, the attack analysis device 11 described in the present disclosure may be implemented by a dedicated computer configured as a processor with one or more dedicated hardware logic circuits.

Alternatively, the attack analysis device 11 described in the present disclosure may be implemented by one or more dedicated computers configured by a combination of a processor and a memory programmed to execute one or more functions, and a processor configured by one or more hardware logic circuits.

The computer program may be stored in a computer-readable non-transitory tangible storage medium as instructions to be executed by the computer. The technique for implementing the functions of the respective units included in the attack analysis device 11 does not necessarily need to include software, and all of the functions may be implemented with the use of one or multiple hardware circuits.

(2f) In addition to the above-described attack analysis device 11, the present disclosure can also be implemented in various forms, such as an apparatus including the attack analysis device 11 as an element, a program for causing the computer of the attack analysis device 11 to perform the above-described method, a non-transitory tangible storage medium such as a semiconductor memory on which the corresponding program is stored, and a processing method of the attack analysis device 11 (e.g., an attack analysis method).

(2g) Multiple functions of one component in the above embodiment may be implemented by multiple components, and a function of one component may be implemented by multiple components. Multiple functions of multiple elements may be implemented by one element, one function provided by multiple elements may be implemented by one element. A part of the configuration of each of the embodiments described above may be omitted. At least the part of the configuration of each of the embodiments described above may be added to or substituted for a configuration of another embodiment.

### (7) Overview of Present Embodiment

The present embodiment includes the following technical ideas.

### (Technical Idea 1)

An attack analysis device (11), which analyzes a cyberattack based on an anomaly occurred in an electronic control system(S) when the electronic control system receives the cyberattack, wherein the electronic control system includes an electronic control device (20) whose power state can be individually controlled and can be changed to a stop state or a sleep state according to a situation, which indicates a state of a device to which the electronic control system is equipped, the attack analysis device including:
an anomaly log acquisition unit (111) acquiring an anomaly log including information indicating a type of the anomaly and a location of the anomaly, the anomaly log being generated when the anomaly occurs in the electronic control system; and
an attack estimation unit (116) estimating an attack path and/or an attack type of the cyberattack by comparing information included in the anomaly log acquired by the anomaly log acquisition unit with one or more predicted anomaly patterns indicating a combination of the anomalies predicted to occur in the event of cyberattack,
wherein, when the attack estimation unit estimates the attack path and/or the attack type, a calculation range for performing the estimation is determined based on the situation of the device.

### (Technical Idea 2)

The attack analysis device according to technical idea 1, further including:
an indicator acquisition unit (112) acquiring, from the device, an indicator based on which the situation of the device can be estimated; and
a device state estimation unit (114) estimating the situation of the device based on the acquired indicator,
wherein, when the attack estimation unit estimates the attack path and/or the attack type, a calculation range for performing the estimation is determined based on the situation of the device estimated by the device state estimation unit.

### (Technical Idea 3)

The attack analysis device according to technical idea 1, wherein
the calculation range for performing the estimation is set based on the stop state or the sleep state of the power state of the electronic control device acquired from the situation of the device.

### (Technical Idea 4)

The attack analysis device according to technical idea 3, wherein,
with respect to the anomaly log of the electronic control device acquired in the stop state or the sleep state of the electronic control device, a process for estimating the attack path and/or the attack type by comparing the anomaly log with the predicted anomaly patterns is omitted.

### (Technical Idea 5)

The attack analysis device according to technical idea 1, wherein
the predicted anomaly pattern is linked to the electronic control device at a predicted attack location indicating a start point of the cyberattack, and
when the electronic control device at the predicted attack location is included in the electronic control device that is in the stop state or the sleep state in the situation of the device when the anomaly is detected, the process of estimating the cyberattack by comparing the predicted anomaly pattern associated with the electronic control device that is in the stop state or the sleep state with the anomaly log is omitted.

### (Technical Idea 6)

The attack analysis device according to technical idea 1, wherein
the predicted anomaly pattern is linked to the electronic control device corresponding to a predicted attack target that indicates a target of the cyberattack, and
when the electronic control device corresponding to the predicted attack target of is included in the electronic control device that is in the stop state or the sleep state in the situation of the device when the anomaly is detected, the process of estimating the cyberattack by comparing the predicted anomaly pattern associated with the electronic control device that is in the stop state or the sleep state with the anomaly log is omitted.

### (Technical Idea 7)

The attack analysis device according to technical idea 1, wherein,
among the predicted anomaly patterns, for the predicted anomaly pattern corresponding to the electronic control device that is in the stop state or the sleep state in the situation of the device when the anomaly is detected, the process of estimating the cyberattack by comparing with the anomaly log is omitted.

### (Technical Idea 8)

The attack analysis device according to technical idea 1, wherein
the predicted anomaly pattern is provided by a table that includes (i) predicted anomaly information indicating the anomaly predicted to occur when the cyberattack is received and (ii) a predicted anomaly location indicating a location of
the anomaly predicted to occur when the cyberattack is received, and the attack path and/or the attack type of the cyberattack is estimated by comparing the anomaly log with the predicted anomaly pattern included in the table.

### (Technical Idea 9)

The attack analysis device according to technical idea 1, wherein
the attack analysis device is configured to calculate a matching level indicating a level of similarity between information included in the anomaly log and the predicted anomaly pattern.

### (Technical Idea 10)

The attack analysis device according to technical idea 9, wherein
the information included in the anomaly log acquired by the anomaly log acquisition unit is compared with the predicted anomaly pattern that is predicted to occur in the event of cyberattack, and the matching level is calculated based on an identification level between the information included in the anomaly log and the predicted anomaly pattern.

### (Technical Idea 11)

The attack analysis device according to technical idea 1, wherein
the device is a vehicle, and
the situation of the vehicle includes at least one of the following:
driving in urban area;
driving at high speed equal to or higher than a predetermined speed;
stopped with occupant;
stopped with no occupant;
autonomous driving;
driving with low battery charge below a predetermined level;
slow driving at a speed lower than a predetermined speed;
reversing;
battery charging state;
diagnosis state; or
a default state other than the described situation.

### (Technical Idea 12)

The attack analysis device according to technical idea 2, wherein the situation of the device is determined based on the indicator of the device and a table in which the indicator of the device is correlated to the situation of the device.

### (Technical Idea 13)

The attack analysis device according to technical idea 1, wherein
estimating of the attack path and/or the attack type of the cyberattack based on the information included in the anomaly log and a table in which information of the anomaly log acquired by the anomaly log acquisition unit is correlated with the predicted anomaly pattern that is predicted to occur in the event of cyberattack.

### (Technical Idea 14)

The attack analysis device according to technical idea 13, wherein
a table in which the attack path and/or the attack type, predicted anomaly information indicating the anomaly predicted to occur in the event of cyberattack, and a predicted anomaly location indicating a location of the anomaly predicted to occur in the event of cyberattack are correlated is used as the table in which information of the anomaly log acquired by the anomaly log acquisition unit is correlated with the predicted anomaly pattern that is predicted to occur in the event of cyberattack, and
the attack path and/or the attack type of the cyberattack is estimated from a combination of the predicted anomaly information and the predicted anomaly location corresponding to a combination of the type of anomaly and the location of anomaly.

### (Technical Idea 15)

An attack analysis method, which analyzes a cyberattack based on an anomaly occurred in an electronic control system(S) when the electronic control system receives the cyberattack, wherein the electronic control system includes an electronic control device (20) whose power state can be individually controlled and can be changed to a stop state or a sleep state according to a situation that indicates a state of a device to which the electronic control system is equipped, the attack analysis method including:
acquiring an anomaly log including information indicating a type of the anomaly and a location of the anomaly, the anomaly log being generated when the anomaly occurs in the electronic control system;
estimating an attack path and/or an attack type of the cyberattack by comparing information included in the anomaly log acquired by the anomaly log acquisition unit with one or more predicted anomaly patterns indicating a combination of the anomalies predicted to occur in the event of cyberattack; and
determining a calculation range for performing the estimation is based on the situation of the device when estimating the attack path and/or the attack type of the cyberattack.

### (Technical Idea 16)

An attack analysis program to be executed by an attack analysis device (11) that analyzes a cyberattack based on an anomaly occurred in an electronic control system(S) when the electronic control system(S) receives the cyberattack, wherein the electronic control system includes an electronic control device (20) whose power state can be individually controlled and can be changed to a stop state or a sleep state according to a situation that indicates a state of a device to which the electronic control system is equipped, the attack analysis program including instructions to be executed by at least one processor of the attack analysis device, the instructions, when executed by the at least one processor, causing the attack analysis device to:
acquire an anomaly log including information indicating a type of the anomaly and a location of the anomaly, the anomaly log being generated when the anomaly occurs in the electronic control system;
estimate an attack path and/or an attack type of the cyberattack by comparing information included in the anomaly log acquired by the anomaly log acquisition unit with one or more predicted anomaly patterns indicating a combination of the anomalies predicted to occur in the event of cyberattack; and
determine a calculation range for performing the estimation is based on the situation of the device when estimating the attack path and/or the attack type of the cyberattack.

### 3. Second Embodiment

The present embodiment refers to the description of Japanese Patent Application No. 2022-157432, which is incorporated herein by reference. The attack analysis device of the present embodiment is referred to as an attack analysis device 12.

### (1) Overall Configuration of Attack Analysis Device

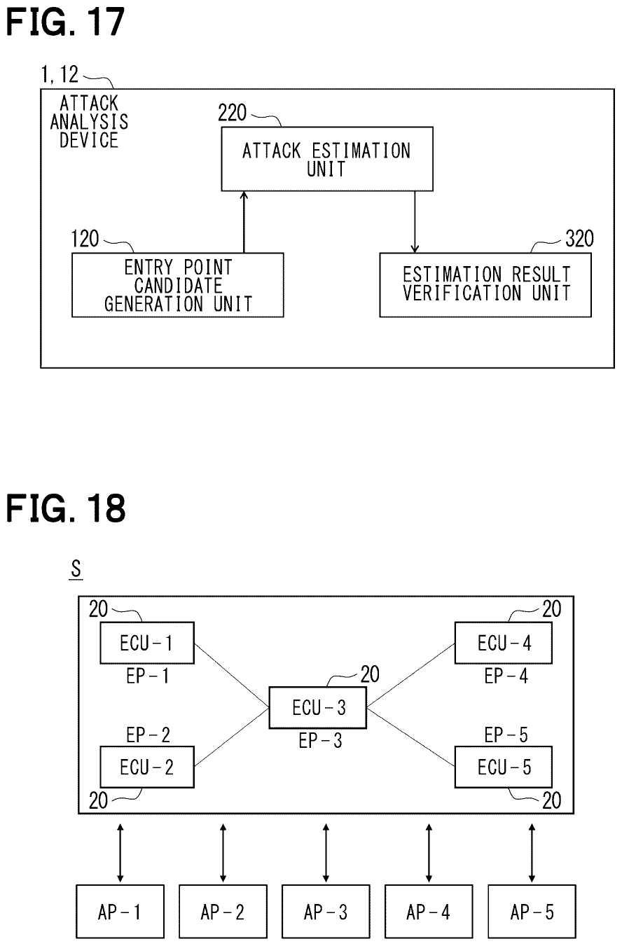

The following will describe an attack analysis device 12 according to the present embodiment with reference to FIG. 17. The attack analysis device 12 analyzes attacks against an electronic control system S installed in a mobile object, which will be described later. The attack analysis device 12 includes an entry point candidate generation unit 120, an attack estimation unit 220, and an estimation result verification unit 320. In the following embodiment, a device having the attack estimation unit 220 is referred to as an attack analysis device. The entry point candidate generation unit 120, the attack estimation unit 220, and the estimation result verification unit 320 are collectively referred to as an attack analysis system. Therefore, FIG. 17 is also a diagram illustrating the attack analysis system 1 according to the present embodiment.

In the embodiment, the electronic control system S that receives attacks is a vehicle system mounted in or on the vehicle as an example. The attack analysis device 12 of the present embodiment may be provided outside the vehicle as shown in FIG. 1C.

### (2) Electronic Control System and Various Tables

The following will describe the electronic control system S with reference to FIG. 18. The electronic control system S includes multiple electronic control units (ECUs) 20. In the example shown in FIG. 18, the electronic control system S includes ECU-1 to ECU-5, and each ECU is connected with one another via an in-vehicle network.

Each ECU configuring the electronic control system S includes one or more security sensors that monitor the inside of the ECU and the network to which the ECU is connected. In response to detection of an anomaly occurring within the ECU or on the network, the security sensor generates a security log and outputs the generated security log to the entry point candidate generation unit 120, which will be described later. Hereinafter, the log generated and output by the security sensor will be referred to as a security log. The individual security log includes anomaly information indicating an anomaly detected by the security sensor and anomaly location information indicating occurrence location of the anomaly detected by the security sensor. The security log may further include identification information for specifying the electronic control system S, identification information of the security sensor that has detected the anomaly, identification information of the ECU to which the security sensor is mounted, anomaly detection time, the number of times by which the anomaly is detected, a detection order of the anomalies, and information about content and IP address of received data (transmission source and transmission target) before detection of the anomaly.

The electronic control system S is connected external connection destinations, which is indicated by AP in FIG. 18, using a wireless communication method or a wired communication method. In the example shown in FIG. 18, the external connection destinations of the electronic control system S includes AP-1 to AP-5.

Examples of external connection destinations include a Home Energy Management System (HEMS), a lamp, a roadside device, a non-contact power charging device, other vehicles, a diagnostic device, and an OEM center.

When the electronic control system S is subjected to a cyberattack from a connection destination, the entry point from which the attack entered can be identified. This configuration enables accurate estimation of the attack path and the attacked target. As shown in FIG. 18, when the electronic control system S is subjected to a cyberattack, each ECU-1, 2, 3, 4, 5 becomes an entry point EP-1, 2, 3, 4, 5, respectively. Alternatively, the entry point may be specified by an interface. Each ECU may be a physical ECU or a virtual ECU.

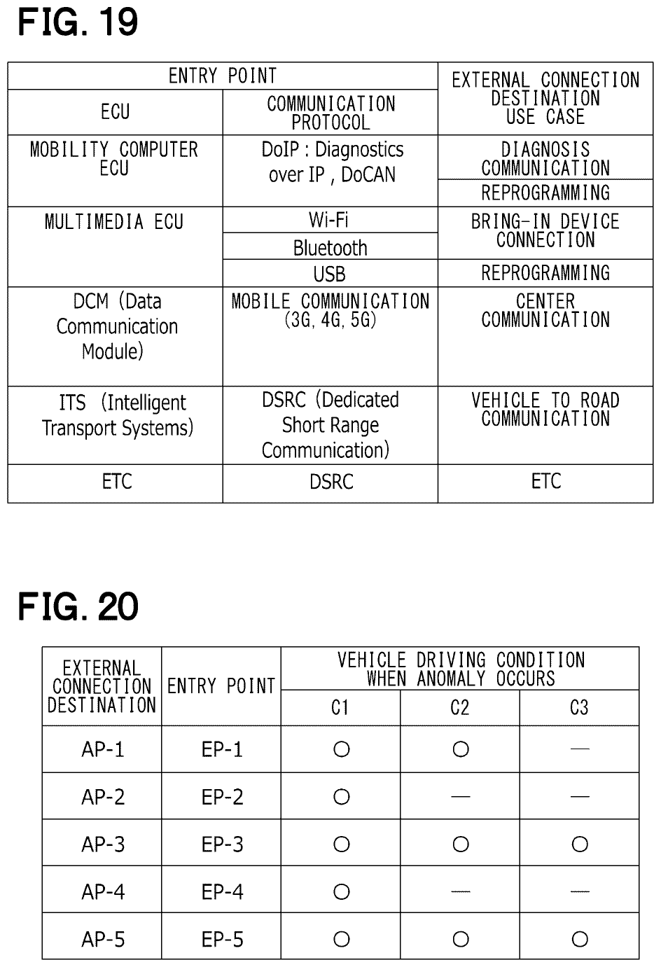

A specific example of entry point will be described with reference to FIG. 19.

In the case of an attack from an external connection destination shown in the right column of FIG. 19, the interface shown in the center column is the entry point, and the ECU having the entry point is shown in the left column. In the example shown in FIG. 19, a multimedia ECU has Wi-Fi, Bluetooth™, and USB as interfaces, and each interface serves as an entry point.

The ECU shown in the left column may be defined as the entry point. Alternatively, as shown in FIG. 19, a combination of an interface shown in the center column and the corresponding ECU shown in the left column may be defined as an entry point.

FIG. 20 is a diagram showing an example of a driving condition and attack relation table, which corresponds to driving condition and anomaly relation information. The driving condition and attack relation table shown in FIG. 20 stores, in association with each other, external connection destination (corresponding to connection destination information) and predicted attack entry point (corresponding to predicted entry point) from which connection destination the attacked is entered, the driving condition of the vehicle when an anomaly occurs, i.e., the driving condition corresponding to the entry point (corresponding to predicted driving conditions), within the electronic control system S shown in FIG. 18. That is, for each external connection destination, the driving condition of vehicle when connection to that external connection destination is possible is associated with the external connection destination. In the example shown in FIG. 20, the external connection destinations AP-1 to AP-5 can be connected to in the driving condition C1. The external connection destinations AP-1, AP-3, and AP-5 can be connected in the driving condition C2. The external connection destinations AP-3 and AP-5 can be connected in the driving condition C3.

The driving condition includes not only the internal condition while the vehicle is driving, such as the behavior, operation, and mode of the vehicle itself, but also the external condition while the vehicle is driving, such as the ambient temperature, position, and time and date of the vehicle.

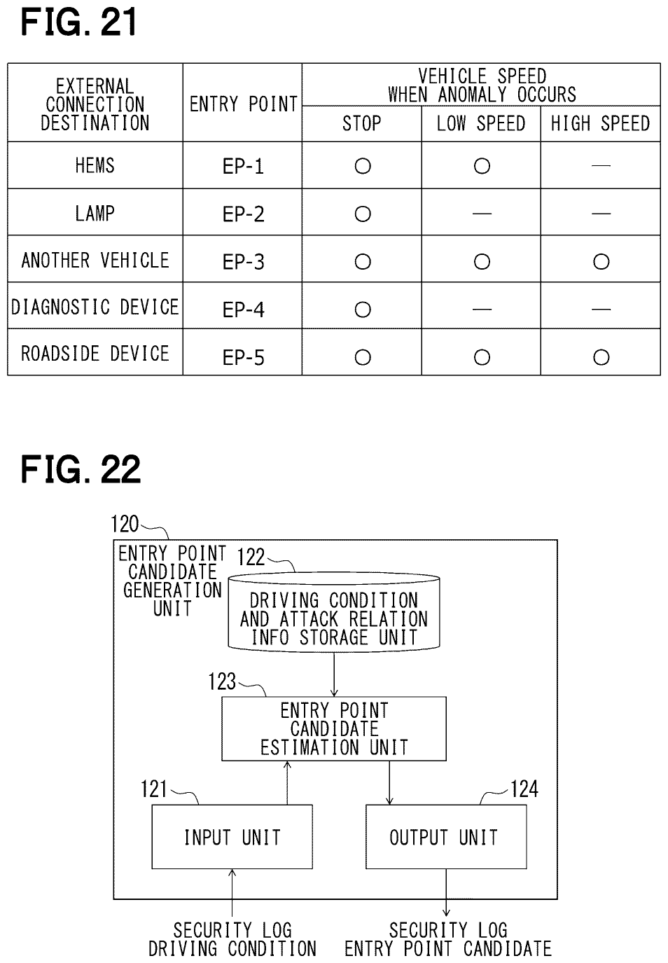

FIG. 21 is a diagram showing the possibility of various external connection destinations depending on the vehicle speed. The example of various connection destinations include a HEMS, a desk lamp, another vehicle, a diagnostic device for maintenance work at a vehicle dealership, and a roadside device. In this example, the driving condition corresponds to the speed of vehicle. The speed shown in FIG. 21 is classified according to a connection possibility to the external connection destination. For example, vehicle speed of 0 km/h corresponds to stop, vehicle speed within 0 km/h to 20 km/h corresponds to low speed, and vehicle speed of equal to or higher than 20 km/h corresponds to high speed. An upper limit may be set for the driving condition of high speed depending on the performance of the connected device. For example, the high speed may be set in multiple stages.

Here, speed refers to a speed in narrow sense, which is indicated by the distance traveled per unit time, as well as any information that can indirectly indicate speed in the narrow sense, such as the time required per unit distance, or the positional information of two points and time required for traveling between the two points. Alternatively, the speed may also be defined by a range of speed value.

By using the driving condition and attack relation table, it is possible to identify or narrow down external connection destination and entry point using the vehicle's driving condition at the occurrence time of anomaly. For example, since a vehicle cannot be connected to a lamp while it is moving, if an anomaly occurs in the moving state of vehicle, the possibility of an attack from a lamp can be eliminated or evaluated as low possibility. The vehicle speed can be obtained not only as speed information, but also as a transition in position information or the state of a transmission gear that reflects the driving state of vehicle.

When the vehicle's driving condition is distinguished by temperature, for example the air temperature around the vehicle or the temperature of component included in the vehicle, then a connection destination that does not work at the temperature when an anomaly occurs can be excluded from the source of cyberattack.

When the vehicle's driving condition is distinguished by time or date, a connection destination that is not operating at the occurrence time of anomaly can be excluded from the source of attack.

When the vehicle's driving condition is distinguished according to its geographic location, it is possible to exclude, from the source of attack connection destination, a connection destination that does not exist economically or legally depending on the country or state in which the vehicle is driving at the occurrence time of anomaly.

As shown in FIG. 20 and FIG. 21, there is usually one-to-one correspondence between external connection destinations corresponding to the sources of cyberattacks and entry points. Alternatively, an entry point may correspond to multiple external connection destinations.

The driving condition and attack relation tables shown in FIG. 20 and FIG. 21 correspond to the situation information described and shown in FIG. 5A and FIG. 5B. In addition, in the driving condition and attack relation table, the vehicle's driving condition at the occurrence time of anomaly corresponds to an indicator, and the entry point and external connection destination correspond to a situation. In other words, the driving condition and attack relation table is used to estimate an entry point corresponding to a driving situation based on the actually input driving situation.

### (3) Configuration of Entry Point Candidate Generation Unit

The entry point candidate generation unit 120 will be described with reference to FIG. 22. The entry point candidate generation unit 120 includes an input unit 121, a driving condition and attack relation information storage unit 122, an entry point candidate estimation unit 123, and an output unit 124.

The input unit 121 (corresponding to the log acquisition unit and indicator acquisition unit) acquires a security log indicating an anomaly detected in the electronic control system S, and also acquires the vehicle's driving condition (corresponding to indicator) at the occurrence time of anomaly. For example, the driving condition corresponding to the time indicated by a timestamp, which identifies an occurrence time of anomaly and is included in the security log, may be acquired. The driving condition is acquired from various sensors and ECUs in the vehicle.

The driving condition and attack relation information storage unit 122 stores a driving condition and attack relation table (corresponding to driving condition and attack relation information) that shows the relation between predicted entry points, which are the entry points of predicted attacks, and the predicted driving conditions corresponding to the predicted entry points.

The entry point candidate estimation unit 123 (corresponding to situation estimation unit) estimates external connection destination and entry point candidate (corresponding to situation) that may have a connection possibility in the driving condition acquired by the input unit 121 based on the driving condition and attack relation table stored in the driving condition and attack relation information storage unit 122.

For example, in the driving condition and attack relation table shown in FIG. 20, when the driving condition at the occurrence time of anomaly in the security log is C2, the entry point candidate estimation unit 123 identifies AP-1, AP3, and AP-5 as possible connection destinations to which the electronic control system S can be connected in that driving condition, and identifies EP-1, EP-3, and EP-5 as possible entry point candidates.

The output unit 124 outputs the security log acquired by the input unit 121 and the entry point candidates estimated by the entry point candidate estimation unit 123 to the attack estimation unit 220 described later.

The security log may be directly input to the attack estimation unit 220 described below without being acquired from the input unit 121. In this case, the output unit 124 outputs the entry point candidate to the attack estimation unit 220.

### (4) Configuration of Attack Estimation Unit

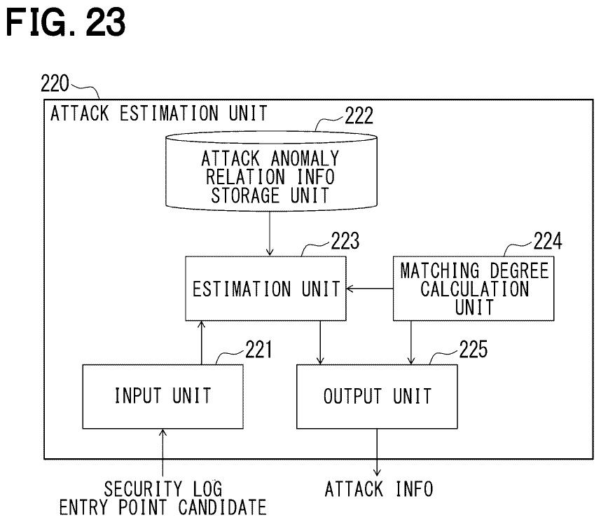

The attack estimation unit 220 will be described with reference to FIG. 23. The attack estimation unit 220 includes an input unit 221, an attack anomaly relation information storage unit 222, an estimation unit 223, a matching level calculation unit 224, and an output unit 225.

The input unit 221 acquires the security log and the entry point candidates from the entry point candidate generation unit 120.

The attack anomaly relation information storage unit 222 stores an attack anomaly relation table (corresponding to attack anomaly relation information). The attack anomaly relation table shows a relation between predicted attack information indicating attacks that the electronic control system S may be subjected to, predicted anomaly information indicating anomalies that are predicted to occur in the electronic control system in the event of a cyberattack, and predicted anomaly location information indicating the predicted location within the electronic control system S where the anomaly may occur.

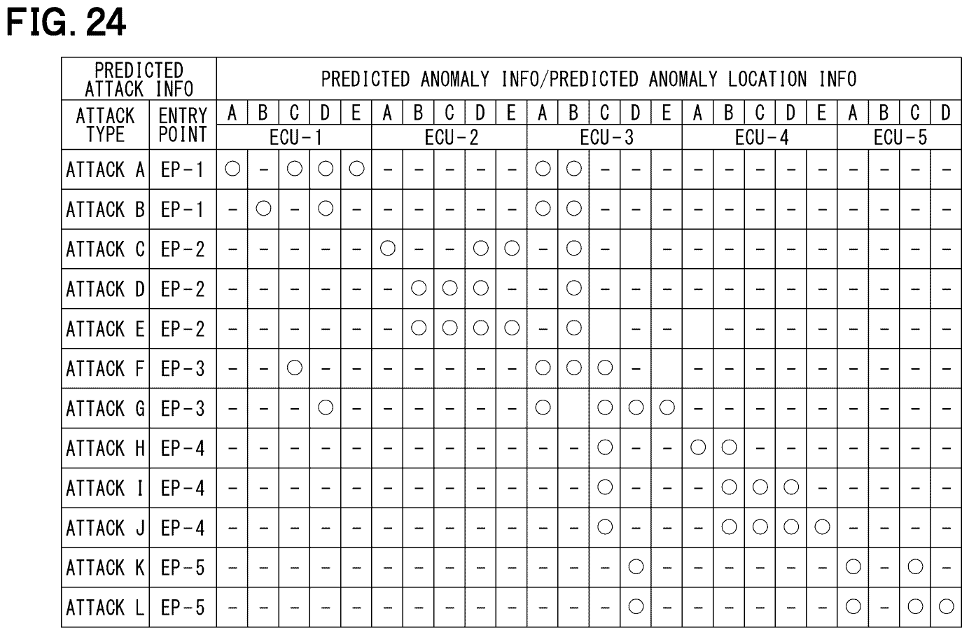

FIG. 24 is a diagram illustrating an example of the attack anomaly relation table. The attack anomaly relation table shown in FIG. 24 shows, for each type of attack (e.g., attack A to attack L), the anomalies (corresponding to predicted anomaly information) that will occur in the electronic control system S in response to respective cyberattacks and the locations at which the anomaly will occur (corresponding to predicted anomaly location information). The location at which the anomaly will occur is indicated by ECU-1 to ECU-5. As shown in FIG. 24, when an attack occurs, it is predicted that multiple anomalies may occur at multiple locations. Thus, the attack anomaly relation table may indicate a combination of multiple anomalies that occur in response to reception of attack and locations of the multiple anomalies.

FIG. 24 further shows a relation between the attack type and the entry point predicted in the event of attack.

In the present embodiment, the predicted attack information includes an attack type and an entry point. The predicted attack information may also include other information. For example, the predicted attack information may include an attack path including an attack start point location and an attack target location. When an attack path is included in the predicted attack information, the entry point column may be omitted and the attack start point location may be used instead of the entry point. When the attack start point location corresponds to an interface or the ECU that constitutes the entry point, this attack start point location is used as the entry point.

For example, when an attack of type A occurs in the electronic control system S, it is predicted that anomalies A, C, D, and E may occur in ECU-1, and anomalies A and B may occur in ECU-3. It is also predicted that the entry point from which attack A started is EP-1.

The estimation unit 223 estimates the attack received by electronic control system S based on the security log and the attack anomaly relation table input from the input unit 221. At this time, the attack is estimated using a part of the attack anomaly relation table, which includes the entry point candidates input from the input unit 221. Specifically, an attack anomaly relation table narrowed down by entry point candidates is used to identify an attack that has a combination of predicted anomaly information and predicted anomaly location information, which corresponds to a combination of anomaly information and anomaly location information included in one or more security logs. One combination corresponds to another combination includes a case where the two combinations are the same or similar to one another.

By using the attack anomaly relation table narrowed down by entry point candidates, the number of columns of predicted attack information to be compared with security logs can be reduced, thereby improving the estimation efficiency of attack.

For example, in the example shown in FIG. 20, when the driving condition of vehicle is C2 at the occurrence time of anomaly, the entry point is one of EP-1, EP-3, or EP-5. Thus, only the attacks A, B, F, G, K, and L whose entry points are EP-1, EP-3, and EP-5 are subject to analysis. In this configuration, by estimating entry point candidates based on the driving condition at the occurrence time of anomaly, it is possible to limit the analysis targets in the attack anomaly relation table of FIG. 24 to attacks that correspond to the specified entry point candidates.

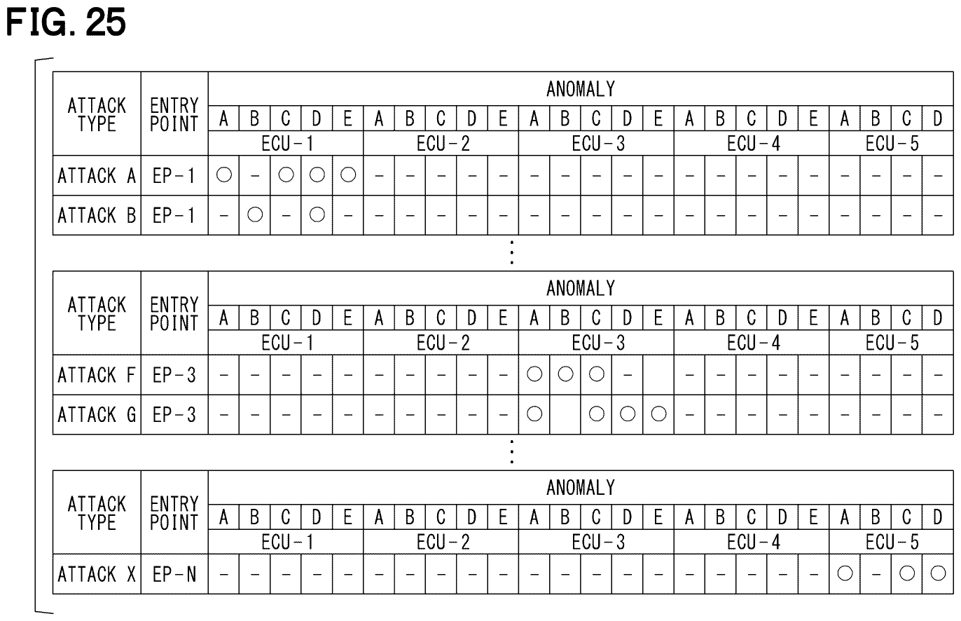

The attack anomaly relation table may be prepared for each entry point candidate. In this case, as shown in FIG. 25, the attack anomaly relation tables prepared for entry points EP-1, EP-3, and EP-5 are selected, and attacks with combinations of predicted anomaly information are identified from these tables.

It should be noted that the entry point candidates estimated based on the driving conditions may be used to verify the estimated attack, instead of being used to narrow down the targets to be matched in the attack anomaly relation table. The verification is performed by the estimation result verification unit 320.

When a combination of predicted anomaly information and predicted anomaly location that is exactly the same as the combination of anomaly information and anomaly location information does not exist in the attack anomaly relation table, the estimation unit 223 identifies the closest combination from the combinations of predicted anomaly information and predicted anomaly location included in the attack anomaly relation table. Then, the attack estimation unit 223 estimates the attack type indicating the closest combination to be a type of the attack received by the electronic control system.

In a case where there are multiple closest combinations (e.g., attack A, attack B), the estimation unit 223 may estimate that the type of attack received by the electronic control system is either attack A or attack B.

The estimation unit 223 may further estimate an anomaly that may occur in the electronic control system S in the future or an attack that will be received in the future based on a difference between a combination of the anomaly information and the anomaly location information and a combination of the predicted anomaly information and the predicted anomaly location information. For example, when the number of anomalies indicated by the anomaly information is smaller than the number of anomalies indicated by the predicted anomaly information, among the anomalies indicated by the predicted anomaly information, an anomaly that is not included in the anomalies indicated by the anomaly information may occur in the future. Therefore, the estimation unit 223 estimates that the difference between the anomalies indicated by the predicted anomaly information and the anomalies indicated by the anomaly information is an anomaly that will occur in the electronic control system in the future. In such a case, the output unit 225, which is to be described later, may output, as future anomaly information, a difference between the anomalies indicated by the predicted anomaly information and the anomalies indicated by the anomaly information.

When the number of anomalies indicated by the anomaly information is smaller than the number of anomalies indicated by the predicted anomaly information, the anomalies indicated by the anomaly information may be estimated as anomalies occurred at a previous stage of the attack, and there is a possibility that a further anomaly may occur due to receiving of the attack in the future. Therefore, the estimation unit 223 estimates the attack that the electronic control system S may receive in the future, assuming that electronic control system S receives an attack r in the future. In such a case, the output unit 225 described later may output future attack information indicating that the attack type included in the attack information is an attack that the electronic control system may receive in the future.

When the combination of anomaly information and the anomaly location information is not exactly the same as any one of the combinations of the predicted anomaly information and the predicted anomaly location information, the matching level calculation unit 224 calculates a matching level therebetween. For example, the matching level is represented by a numerical value obtained by dividing a difference between the number of anomalies indicated by the anomaly information and the number of anomalies indicated by the number of anomalies indicated by the anomaly information or indicated by the predicted anomaly information.

The output unit 225 outputs attack information indicating the attack estimated by the estimation unit 223 to the estimation result verification unit 320, which is to be described later. The attack information may include the matching level calculated by the matching level calculation unit 224.

As described above, when the estimation unit 223 estimates an anomaly that will occur in the electronic control system in the future or an attack that the electronic control system S may be subjected to in the future, the output unit 225 may output attack information including the future attack information or the future anomaly information.

### (5) Configuration of Estimation Result Verification Unit

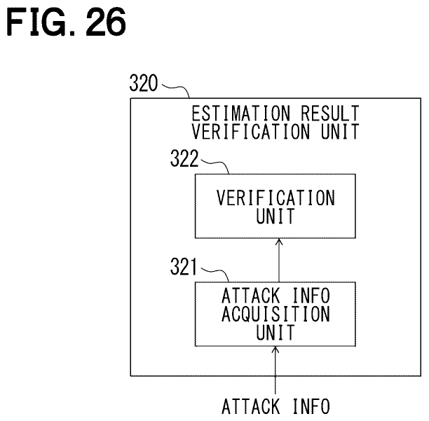

The estimation result verification unit 320 will be described with reference to FIG. 26. The estimation result verification unit 320 includes an attack information acquisition unit 321 and a verification unit 322.

The attack information acquisition unit 321 acquires the attack information output from the output unit 225.

The verification unit 322 verifies contents included in the acquired attack information. For example, the verification unit 322 verifies the accuracy of estimation result of the attack estimation unit 220 based on the matching level included in the attack information. For example, when the matching level is lower than a predetermined matching level, the verification unit 322 determines that the estimation result by the attack estimation unit 220 is not correct. Alternatively, the verification unit 322 may instruct the attack estimation unit 220 to perform analysis again with consideration of past estimation result and future estimation result of the security log.

The verification unit 322 may further verify the accuracy of attack anomaly relation table based on the matching level. For example, in a case where the estimation result having a low matching level consecutively occur, the verification unit 322 may determine that the association between the predicted anomaly information and the predicted anomaly location information included in the attack anomaly relation table is not accurate, and the table needs to be reset or updated.

### (6) Operation of Attack Analysis Device

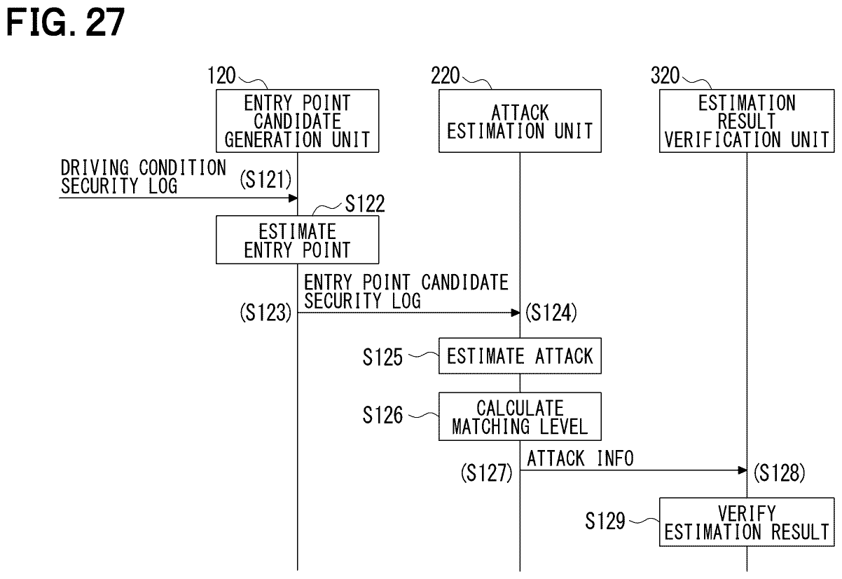

The operation of attack analysis device 12 will be described with reference to FIG. 27. The operation of attack analysis device 12 may also be regarded as the operation of attack analysis system 1.

In S121, the input unit 121 of the entry point candidate generation unit 120 acquires a security log indicating an anomaly detected in the electronic control system S and the driving condition of vehicle at the occurrence time of anomaly.

In S122, the entry point candidate estimation unit 123 estimates entry point candidates, which are candidates of the entry point of the attack during the driving condition acquired in S121, based on the driving condition attack relation table stored in the driving condition attack relation information storage unit 122.

In S123, the output unit 124 outputs the security log and the entry point candidates estimated in S122.

In S124, the input unit 221 of the attack estimation unit 220 acquires the security log and the entry point candidates output from the output unit 124 in S123.

In S125, the estimation unit 223 estimates the attack on the electronic control system based on the security log and the attack anomaly relation information including the entry point candidates as the predicted attack information. At this time, when there is a difference between (i) the combination of predicted anomaly information and predicted anomaly location information stored in the attack anomaly relation table and (ii) the combination of anomaly information and anomaly location information included in the security log, the matching level calculation unit 224 calculates the matching level between (i) the predicted anomaly information and predicted anomaly location information and (ii) the anomaly information and anomaly location information in S126.

In S127, the output unit 225 outputs attack information indicating the estimated attack, together with the matching level.

In S128, the attack information acquisition unit 321 of the estimation result verification unit 320 acquires the attack information output from the output unit 225 in S127.

When the verification unit 322 acquires the attack information, the verification unit 322 verifies the attack estimation result included in the attack information in S129.

### (7) Conclusion

As described above, according to the attack analysis device 12 of the present embodiment, when the electronic control system receives an attack, entry point candidates are estimated using the vehicle's driving condition at the occurrence time of anomaly, and the received attack is estimated by narrowing down the entry point candidates. This configuration enables attack analysis more efficient and can reduce processing load of attack estimation.

According to the attack analysis device 12 of the present embodiment, attacks are estimated using an attack anomaly relation table in which the contents of predicted anomalies are associated with entry points. When estimation of attack is performed using an attack anomaly relation table that has been narrowed down to entry point candidates in advance, predicted attack information that is not actually relevant to the received attack can be excluded from the estimation target in advance, thereby improving estimation accuracy of attack.

Furthermore, since attacks are estimated using the attack anomaly relation table in which the contents of predicted anomalies are associated with entry points, it is also possible to output entry point information as well as attack information as an estimated result.

### (8) Modification Examples

In a modification of the second embodiment, the entry point candidate generation unit 120 and at least a part of the estimation result verification unit 320 are provided in a device different from the device in which the attack estimation unit 220 is provided. In the following description, differences from the second embodiment will be mainly described. The configuration and operation of the entry point candidate generation unit 120, the attack estimation unit 220, and the estimation result verification unit 320 are the same as those in the second embodiment, and therefore will not be described in detail.

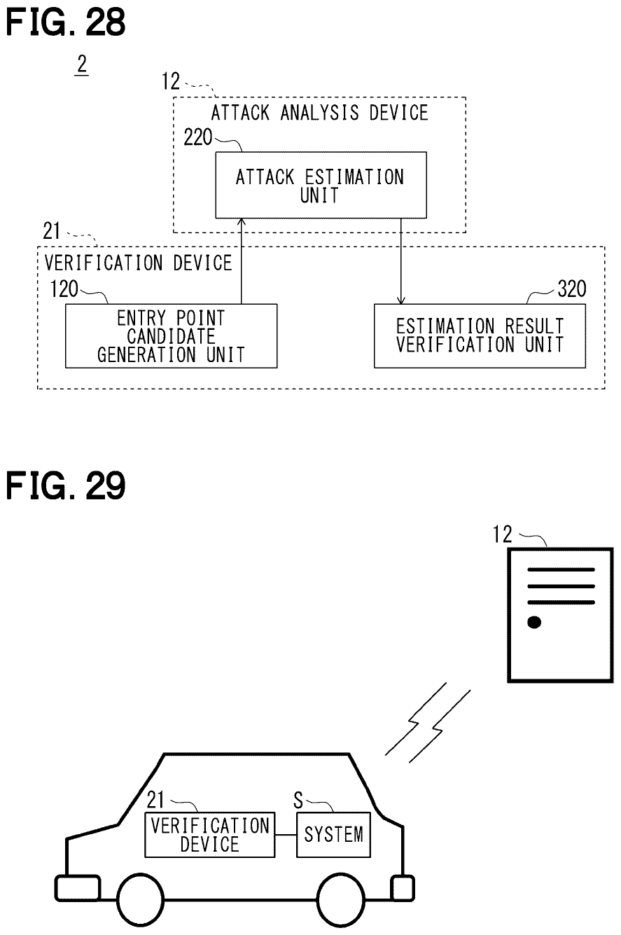

FIG. 28 is a diagram showing an example of an attack analysis system including an attack analysis device 12 according to the first modification. In the configuration example of FIG. 28, the attack analysis device 12 includes only the attack estimation unit 220, and the entry point candidate generation unit 120 and the estimation result verification unit 320 are provided in a verification device 21. The attack analysis device 12 and the verification device 21 are collectively referred to as an attack analysis system 2.

FIG. 29 is a diagram illustrating the attack analysis device 12 of the first modification. As shown in FIG. 29, in the first modification, a server device located outside the vehicle corresponds to the attack analysis device 12, and the verification device 21 is mounted on the vehicle.

In this case, the input unit 221 of the attack analysis device 12 acquires, from the verification device 21 mounted on the vehicle, a security log indicating an anomaly detected in the electronic control system S and entry point candidates of attack. The entry point candidates are candidates of entry point of the attack corresponding to the driving condition of the vehicle at the occurrence time of anomaly.

In the first modification, the entry point candidates and security logs output from the entry point candidate generation unit 120 are transmitted to the attack estimation unit 220 via a wireless communication network. Similarly, the attack information output from the attack estimation unit 220 is transmitted to the estimation result verification unit 320 via the wireless communication network. Although not shown in FIG. 29, the attack analysis device 12 and the verification device 21 each may be equipped with a wireless communication unit and an antenna. Alternatively, the output unit 124 of the entry point candidate generation unit 120 and the attack information acquisition unit 321 of the estimation result verification unit 320 may have the wireless communication function.

Among the process executed by the attack analysis system, the process of estimating the cyberattack received by the electronic control system S, that is, the process in the attack estimation unit 220 requires high processing load. Thus, by arranging the attack analysis device 12, which includes the attack estimation unit 220, in the server device, it is possible to significantly reduce the processing load in the vehicle.

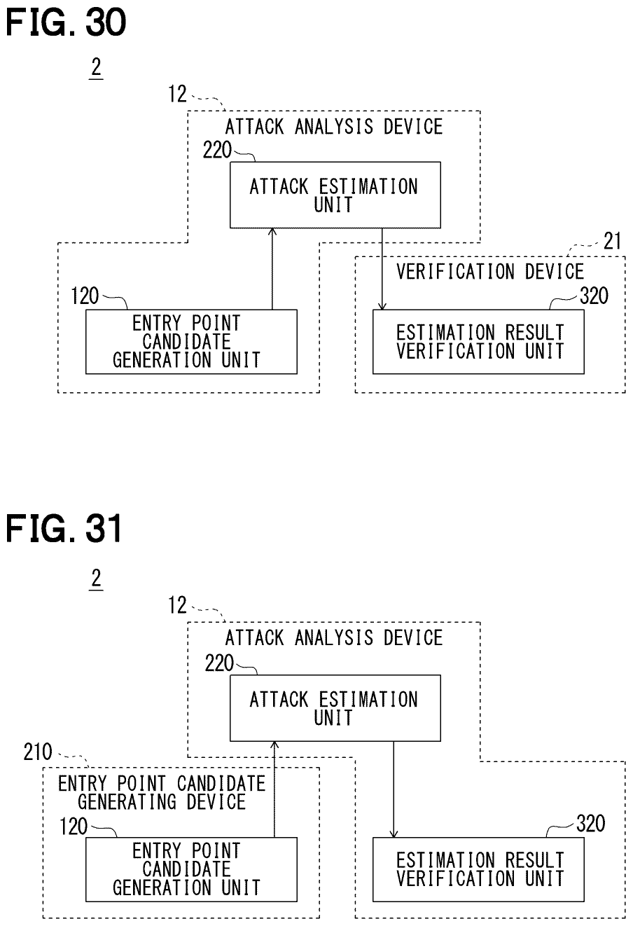

FIG. 30 illustrates a second modification, which is a modification of the second embodiment. In the second modification, the attack analysis device 12 includes an entry point candidate generation unit 120 in addition to the attack estimation unit 220. In this case, similarly to the configuration illustrated in FIG. 29, the attack analysis device 12 may be provided by a server device. Alternatively, the attack analysis device 12 may be a device mounted on a vehicle, and the verification device 21 may be implemented by a server device. In this case, verification of the attack estimation result by the attack estimation unit 220 is performed in the server device. In the server device, since the estimation result of the attack in multiple electronic control systems are verified, it is possible to determine whether it is necessary to reset or update the attack anomaly relation table by comparing the estimation results of different electronic control systems.

FIG. 31 illustrates a third modification, which is another modification of the second embodiment. In the third modification, the attack analysis device 12 includes an estimation result verification unit 320 in addition to the attack estimation unit 220. The entry point candidate generation unit 120 is provided in an entry point candidate generating device 210. In the third modification, the attack analysis device 12 having the same arrangement as in FIG. 29, that is, the attack estimation unit 220 that requires a high processing load and the estimation result verification unit 320 are provided by a server device.

The above modifications can also be applied to other embodiments and modifications. In FIG. 4, for example, the indicator acquisition unit 102, the situation information storage unit 103, and the situation estimation unit 104 may be provided in the vehicle, and the log acquisition unit 101, the attack anomaly relation information storage unit 105, and the attack estimation unit 106 may be provided in the server device.

### (9) Overview

The present embodiment includes the following technical ideas.

### (Technical Idea 1)

An attack analysis device analyzing an attack on an electronic control system mounted on a mobile object, the attack analysis device including:
an acquisition unit (121) acquiring a security log indicating an anomaly detected in the electronic control system and a driving condition of the mobile object at an occurrence time of the anomaly;
a driving condition and attack relation information storage unit (122) storing driving condition and attack relation information indicating a relation between a predicted entry point, which is an entry point of a predicted attack, and a predicted driving condition corresponding to the predicted entry point;
an entry point candidate estimation unit (123) estimating an entry point candidate, which is a candidate of an entry point of an attack under the driving condition of vehicle, based on the driving condition and attack relation information;
an attack anomaly relation information storage unit (222) storing attack anomaly relation information indicating a relation among (i) predicted attack information indicating an attack predicted to be received by the electronic control system, (ii) predicted anomaly information indicating an anomaly predicted to occur when the electronic control system receives the predicted attack, and (iii) predicted anomaly location information indicating a location within the electronic control system where the predicted anomaly occurs;
an estimation unit (223) estimating the attack that the electronic control system has received based on the security log and attack anomaly relation information including the entry point candidate in the predicted attack information; and
an output unit (225) outputting attack information indicating the estimated attack.

### (Technical Idea 2)

The attack analysis device according to technical idea 1, wherein
the driving condition is a speed of the mobile object.

### (Technical Idea 3)

The attack analysis device according to technical idea 1, wherein
the driving condition includes one or more element of a condition group that includes a position of the mobile object, an ambient temperature of the mobile object, and time related information.

### (Technical Idea 4)

The attack analysis device according to technical idea 1, wherein
the driving condition and attack relation information further includes destination information indicating a destination of the predicted entry point.

### (Technical Idea 5)

The attack analysis device according to any one of technical ideas 1 to 4, wherein
the attack analysis device is located outside the mobile object.

### (Technical Idea 6)

The attack analysis device according to any one of technical ideas 1 to 4, wherein
the attack analysis device is mounted on the mobile object.

### (Technical Idea 7)

An attack analysis device analyzing an attack on an electronic control system mounted on a mobile object, the attack analysis device including:
an acquisition unit (221) acquiring a security log indicating an anomaly detected in the electronic control system and an entry point candidate, which is a candidate of an entry point of an attack in a driving condition of the mobile object at an occurrence time of the anomaly;
an attack anomaly relation information storage unit (222) storing attack anomaly relation information indicating a correspondence relation among (i) predicted attack information indicating an attack predicted to be received by the electronic control system, (ii) predicted anomaly information indicating an anomaly predicted to occur when the electronic control system receives the predicted attack, and (iii) predicted anomaly location information indicating a location within the electronic control system where the predicted anomaly occurs;
an estimation unit (223) estimating the attack that the electronic control system has received based on the security log and attack anomaly relation information including the entry point candidate in the predicted attack information; and
an output unit (225) outputting attack information indicating the estimated attack.

### (Technical Idea 8)

An attack analysis method executed by an attack analysis device, which analyzes an attack on an electronic control system mounted on a mobile object,
wherein the attack analysis device includes:
a driving condition and attack relation information storage unit (122) storing driving condition and attack relation information indicating a relation between a predicted entry point, which is an entry point of a predicted attack, and a predicted driving condition corresponding to the predicted entry point; and
an attack anomaly relation information storage unit (222) storing attack anomaly relation information indicating a relation among (i) predicted attack information indicating an attack predicted to be received by the electronic control system, (ii) predicted anomaly information indicating an anomaly predicted to occur when the electronic control system receives the predicted attack, and (iii) predicted anomaly location information indicating a location within the electronic control system where the predicted anomaly occurs,
the attack analysis method including:
acquiring a security log indicating an anomaly detected in the electronic control system and a driving condition of the mobile object at an occurrence time of the anomaly;
estimating an entry point candidate, which is a candidate of an entry point of an attack under the driving condition of vehicle, based on the driving condition and attack relation information;
estimating the attack that the electronic control system has received based on the security log and attack anomaly relation information including the entry point candidate in the predicted attack information; and
outputting the attack information indicating the estimated attack.

### (Technical Idea 9)

An attack analysis program to be executed by at least one processor of an attack analysis device, which analyzes an attack on an electronic control system mounted on a mobile object,
wherein the attack analysis device includes:
   a driving condition and attack relation information storage unit (122) storing driving condition and attack relation information indicating a relation between a predicted entry point, which is an entry point of a predicted attack, and a predicted driving condition corresponding to the predicted entry point; and
   an attack anomaly relation information storage unit (222) storing attack anomaly relation information indicating a relation among (i) predicted attack information indicating an attack predicted to be received by the electronic control system, (ii) predicted anomaly information indicating an anomaly predicted to occur when the electronic control system receives the predicted attack, and (iii) predicted anomaly location information indicating a location within the electronic control system where the predicted anomaly occurs,
the attack analysis program including instructions, when executed by the at least one processor, causing the attack analysis device to:
acquire a security log indicating an anomaly detected in the electronic control system and a driving condition of the mobile object at an occurrence time of the anomaly;
estimate an entry point candidate, which is a candidate of an entry point of an attack under the driving condition of vehicle, based on the driving condition and attack relation information;
estimate the attack that the electronic control system has received based on the security log and attack anomaly relation information including the entry point candidate in the predicted attack information; and
output the attack information indicating the estimated attack.

### 4. Third Embodiment

An attack analysis device of the present embodiment is referred to as an attack analysis device 13.

### (1) Configuration of Attack Analysis Device

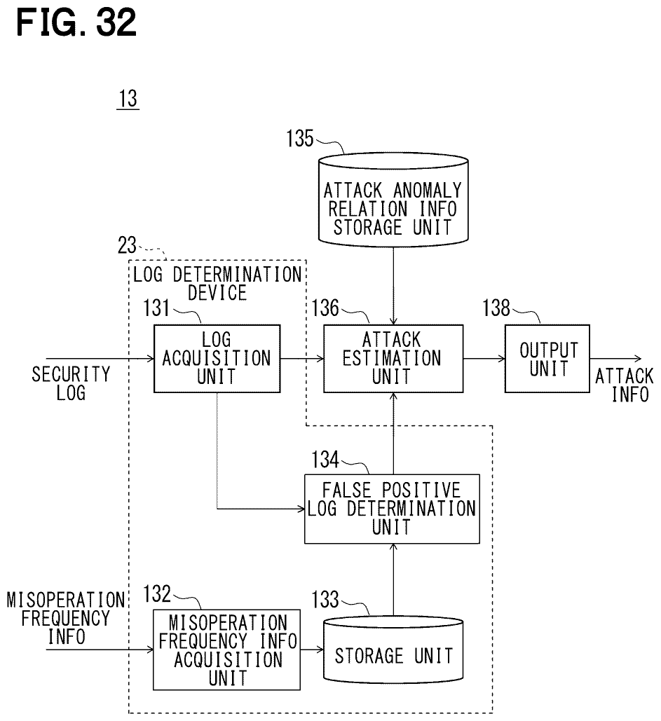

FIG. 32 is a block diagram illustrating a configuration of the attack analysis device 13 according to the present embodiment. The attack analysis device 13 includes a log acquisition unit 131, an misoperation frequency information acquisition unit 132, a storage unit 133, a false positive log determination unit 134, an attack anomaly relation information storage unit 135, an attack estimation unit 136, and an output unit 138.

The log acquisition unit 131, the misoperation frequency information acquisition unit 132, the storage unit 133, and the false positive log determination unit 134 constitute a log determination device 23. The log determination device 23 may be included in the attack analysis device 13 as a part of the attack analysis device 13. Alternatively, as shown in FIG. 29 and FIG. 31 of the second embodiment, the log determination device 23 may be mounted on a vehicle and the attack analysis device having functional blocks other than the log determination device 23 may be implemented by a server device located outside the vehicle.

The log acquisition unit 131 (also corresponding to an indicator acquisition unit) acquires a security log (also corresponding to indicator) generated by a security sensor equipped to the ECU 20. The configuration of electronic control system S is shown in FIG. 2, and contents of the security log are shown in FIG. 3.

When the log determination device 13 adopts the arrangement illustrated in FIG. 1C for the electronic control system S, the log acquisition unit 131 acquires the security log by performing a communication via a communication network using wireless communication method. The log acquisition unit 131 may acquire multiple security logs collectively as a security log set, or may acquire the security logs sequentially when each security log is generated. When the log acquisition unit 131 sequentially acquires each security log when generated, the attack analysis device 13 may further be equipped with a log storage unit (not shown) that temporarily stores a security log acquired by the log acquisition unit 131.

The false positive log determination unit 134 (corresponding to a situation estimation unit) estimates whether the cause of anomaly indicated in the security log acquired by the log acquisition unit 131 is a cyberattack (corresponding to a situation) based on the frequency at which the security log (corresponding to an indicator) is generated. When the cause of anomaly indicated by the security log is not a cyberattack, the security log is determined to be a false positive log. The false positive log is a security log generated in response to detection of an anomaly that is different from an anomaly caused by an attack on the electronic control system S.

The false positive log determination unit 134 estimates whether the cause of anomaly indicated in the security log acquired by the log acquisition unit 131 is a misoperation of a vehicle user (corresponding to a situation) based on the frequency at which the security log is generated. When the cause of anomaly indicated by the security log is a misoperation by the vehicle user, the security log is determined to be a false positive log.

As mentioned above, there is one-to-one correspondence between the estimation result indicating whether the cause of anomaly indicated by the security log is a cyberattack (specifically, the estimation result indicating whether the security is caused by misoperation) and whether the security log is a false positive log. In the following explanation, among the operation executed by the false positive log determination unit 134, estimation about whether the log is caused by a cyberattack (specifically, estimating whether the log is caused by a misoperation by the user) will be omitted. The false positive log determination unit 134, which determines whether a security log is a false positive log or not, will be described.

Here, frequency is indicated by, for example, the number of times, the time, the cycle, or the like at which the security log is generated.

As shown in FIG. 3, the security log includes the time indicating occurrence time of an event. The false positive log determination unit 134 can specify the frequency at which the security logs are generated based on the timestamp included in the security log. Alternatively, the frequency at which security logs are generated may be calculated based on the time at which each security log is received by the log acquisition unit 131.

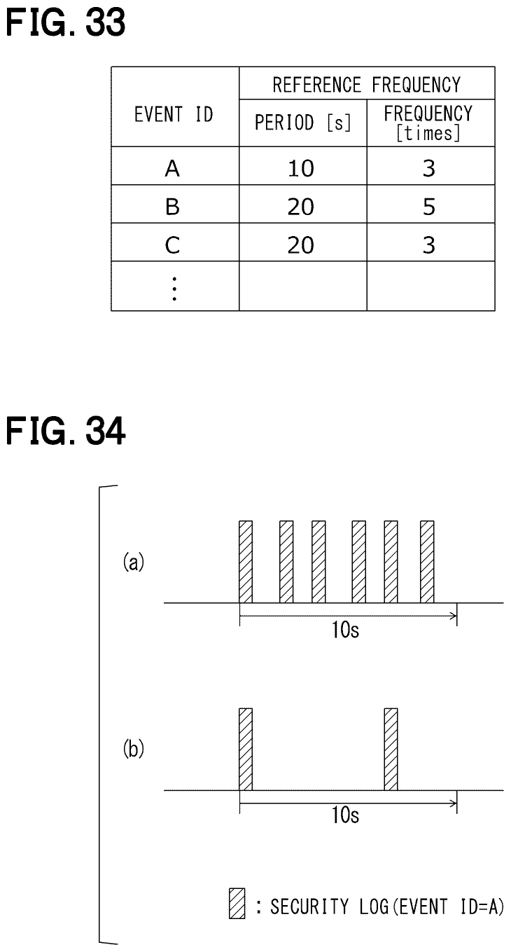

In the false positive log determination process, the false positive log determination unit 134 refers to the information stored in the storage unit 133. The storage unit 133 stores information used for determining a false positive log. FIG. 33 is a diagram showing an example of information stored in the storage unit 133. A table showing a correspondence between event IDs and reference frequencies, which will be described later, is stored in the storage unit 133.

The event ID stored in the storage unit 133 indicates identification information of an event related to an anomaly that may occur due to an misoperation by a user of the electronic control system S, among the event IDs.

Here, the term user includes not only the owner of electronic control system but also a person who temporarily uses the electronic control system.

A reference frequency stored in the storage unit 133 is a frequency referred to as a reference for determining whether the security log is a false positive log. In the example shown in FIG. 33, time and number of times are stored as the reference frequency, but the present disclosure is not limited to the example shown in FIG. 33.

For example, it is assumed that a misoperation occurs since a user of a vehicle equipped with the electronic control system S incorrectly enters a password necessary for connecting to Wi-Fi™ or that an operator at a maintenance shop or dealer performs an incorrect authentication operation. When such misoperations are performed, the security sensor detects an anomaly caused by the misoperation and generates a security log. In another example, it is assumed that updating the software installed in the ECU 20, a worker at a maintenance shop or a dealer makes a mistake such as making a mistake in selection of the program, or terminating the work before the update of all the software is completed. When such misoperations are performed, the security sensor detects anomaly caused by the misoperation and generates a security log. Events related to an anomaly that may occur due to misoperation by the user is limited. Therefore, the storage unit 133 stores an event ID. The event ID indicates an event related to an anomaly that may occur due to a misoperation made by the user. When the event ID included in the security log acquired by the log acquisition unit 131 is the same as the event ID stored in the storage unit 133, the false positive log determination unit 134 determines whether the security log is a false positive log. For a security log having an event ID related to an anomaly that is not likely to occur due to the misoperation by the user, the false positive log determination unit 134 does not perform the determination process for determining whether the log is a false positive log. This configuration can reduce a processing load related to log determination process.

When the frequency at which the security log is generated is lower than the reference frequency stored in the storage unit 133, the false positive log determination unit 134 estimates that the cause of anomaly indicated by the security log is misoperation made by the vehicle user, and determines that the security log is a false positive log.

Here, the term “than” includes both cases that include and exclude the same value as the compared object.

In the example shown in FIG. 33, the storage unit 133 stores a time period (for example, 10 seconds) and a number of times (for example, 3 times) as the reference frequency of the security log of the event ID (for example, event A). This indicates that the number of security logs generated during ten seconds is three times. The false positive log determination unit 134 determines whether the generation frequency of security logs is less than three times during ten seconds.

A process for determining whether a security log is a false positive log will be described with reference to FIG. 34. In the example shown in FIG. 34, the security log is generated six times within ten seconds. The frequency is higher than the reference frequency. Therefore, it is estimated that the cause of anomaly indicated by the security log is a cyberattack (i.e., it is estimated that the security log is not caused by a misoperation made by the user), and it is determined that none of the security logs shown in (a) of FIG. 34 is false positive log. By contrast, in the example shown in (b) of FIG. 34, the security log is generated twice within ten seconds, and the generation frequency is lower than the reference frequency. Therefore, it is estimated that the cause of anomaly indicated by the security log is not a cyberattack (i.e., it is estimated that the security log is caused by a misoperation made by the user), and all of the security logs shown in (b) of FIG. 34 are determined to be false positive logs.

In the example shown in FIG. 34, the frequency of security logs generated within ten seconds from the time when the first security log was generated is compared with the reference frequency. The frequency of the security logs is not limited to the frequency from the first security log is generated. For example, the frequency of security logs generated during ten seconds before the time when the last security log was generated may be compared with the reference frequency. Alternatively, the frequency of each security log generated within ten seconds from the time when each security log was generated may be calculated, and each frequency may be compared with the reference frequency.

Since the number of times a user repeats an misoperation is limited, the generation frequency of security logs due to user's misoperation may not be extremely high. By contrast, when the electronic control system S is subjected to, for example, a brute force attack or a DOS attack, it is assumed that security logs will be generated at extremely high frequency. Therefore, a reference frequency is set with consideration of these factors. When the frequency at which security logs are generated is lower than the reference frequency, the false positive log determination unit 134 determines that the security log is generated by a user's misoperation, that is, determined as the false positive log.

In the present embodiment, the number of times by which a security log is generated within a predetermined period is described as the frequency at which the security logs are generated. The present disclosure is not limited to this configuration. For example, a cycle by which a security log is generated may be used as the frequency. For example, since the speed at which the user performs an operation is limited, there is a possibility that the cycle of repeating an misoperation is not extremely short. By contrast, in a case where the electronic control system S is subjected to a brute force attack or a DOS attack by mechanical process, there may be a high possibility that the cycle at which the security log is generated becomes extremely short. Therefore, by using a cycle in which the security log is generated as a frequency, it is possible to determine whether the security log is a false positive log or not.

FIG. 33 illustrates a table showing the correspondence between the event ID and the reference frequency, but the event ID and the reference frequency may be stored further in association with the ECU ID. For example, the ECU 20a and the ECU 20c may generate security logs having the same event ID (event A). In such a case, security logs generated in different ECUs are generated by detecting different anomalies. Therefore, even when the security logs have the same event ID (event A), there may be a possibility that one security log is generated when the security sensor detects an anomaly caused by an attack, and the other security log is generated when the security sensor detects an anomaly caused by a misoperation. Therefore, in addition to the event ID and the reference frequency, the ECU ID may be stored in association with event ID and the reference frequency.

The security logs acquired by the log acquisition unit 131 may include security logs having various event IDs. The security logs having different event IDs are logs generated in response to detection of different anomalies. Therefore, the false positive log determination unit 134 determines whether generation frequency of security log having the same event ID is lower than the reference frequency associated with the event ID stored in the storage unit 133, and determines whether the security log is a false positive log. When an ECU ID is stored in the storage unit 133, the generation frequency of security log having same ECU ID as the event ID is determined to be lower than a reference frequency associated with the event ID and ECU ID stored in the storage unit 133, thereby determining whether the security log is a false positive log or not.

The false positive log determination unit 134 outputs the determination result to the attack estimation unit 136. For example, when the false positive log determination unit 134 determines that a security log is a false positive log, a flag indicating that the security log is a false positive log is assigned as false positive information and output together with the false positive log. For example, the false positive information may be assigned by including the false positive information in the context data of the security log illustrated in FIG. 3. By assigning a flag as false positive information to a security log, it is possible to easily distinguish between a security log generated in response to an attack and a security log generated in response to a user's misoperation.

In the embodiment to be described below, a case is described in which the false positive log determination unit 134 assigns false positive information to a security log that has been determined to be a false positive log. The false positive information may also be assigned to a security log which is determined by the false positive log determination unit 134 as a non-false positive log. The false positive information in the latter case indicates information indicating that the security log to which the information is added is not a false positive log.

The false positive log determination unit 134 may output identification information of a security log, which is determined to be a false positive log, to the attack estimation unit 136.

According to the output of the false positive log determination unit 134, the attack estimation unit 136 can identify security log that is not used for the attack estimation (i.e., false positive log), and can omit attack estimation having a low importance.

When the security sensor detects an anomaly caused by a user's misoperation and a security log is generated by the misoperation, the misoperation frequency information acquisition unit 132 acquires misoperation frequency information indicating the frequency of the user's misoperation. The reference frequency stored in the storage unit 133 is updated based on the misoperation frequency information.

The frequency of misoperations tends to vary depending on the user. For example, a user A tends to perform twice or three misoperations within one minute, while another user B may perform ten or more misoperations within one minute. Therefore, the security log may be determined to be a false positive log for the user a, but the security log may not be determined to be a false positive log for the user b. Therefore, when the user performs a misoperation, the reference frequency may be set according to a user by acquiring the misoperation frequency information and updating the reference frequency based on the frequency of the misoperation of the user.

The attack anomaly relation information storage unit 135 stores an attack anomaly relation table that shows the relation between cyberattacks and anomalies that occur in the electronic control system S. The attack anomaly relation table is explained above with reference to FIG. 6, thus FIG. 6 and detailed explanation will be omitted in the present embodiment.

The attack estimation unit 136 estimates the attack received by the electronic control system S based on the security log acquired by the log acquisition unit 131, the attack anomaly relation table stored in the attack anomaly relation information storage unit 135, and the determination result of the false positive log determination unit 134.

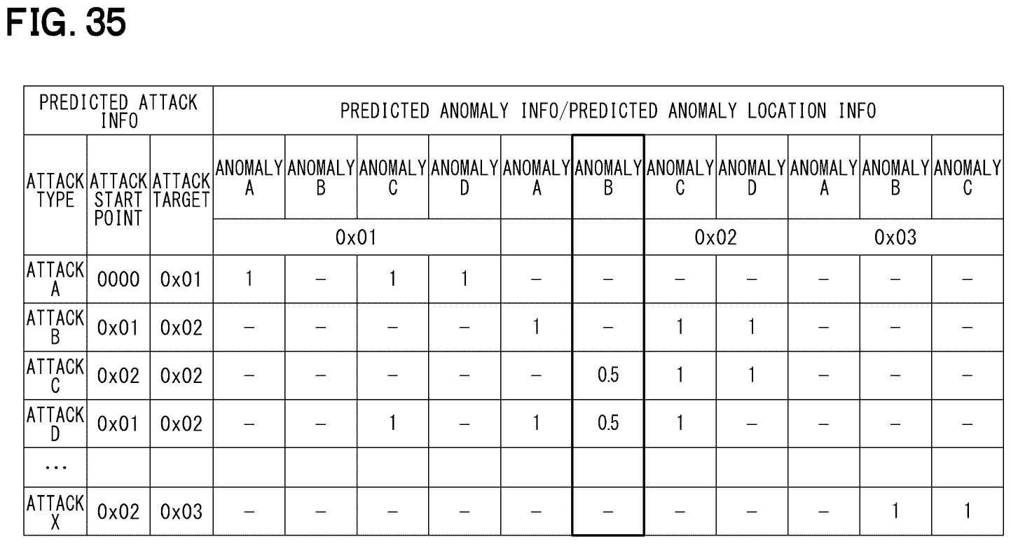

The following will describe a case where the attack estimation unit 136 uses the attack anomaly relation table shown in FIG. 35 to estimate the attack. When the false positive log determination unit 134 outputs a determination result that the security log indicating anomaly B occurred at location 0x02 is not caused by a cyberattack, the attack estimation unit 136 multiplies a weighting of, for example, 0.5 to a pattern in which the predicted anomaly location information is 0x02 and the predicted anomaly information is anomaly B. Then, by using the corrected attack anomaly relation table for attack estimation, the attack estimation score in the case where a false positive log has occurred is evaluated lower than the attack estimation score in the case where a false positive log is not occurred. This makes it possible to improve the accuracy of cyberattack estimation when false positive logs is occurred.

When the weighting coefficient is set to 0, false positive logs are not reflected in the score. Therefore, when it is certain that the security log is a false positive log, the coefficient may be set to 0.

The weighting coefficient to be multiplied may be determined by quantitatively evaluating the determination result by the false positive log determination unit 134 and then determining the value of the coefficient based on the quantitative evaluation result of the determination result by the false positive log determination unit. For example, multiple reference frequencies may be prepared, the frequency at which security logs are generated within a predetermined period may be classified in relation to multiple reference frequencies, and a coefficient determined according to the classification result may be used.

The attack estimation unit 136 may not perform attack estimation with reference to the attack anomaly relation table. For example, when the false positive log determination unit 134 outputs a determination result that the security log indicating anomaly B that occurred at 0x02 is a false positive log, which is not caused by a cyberattack, the attack estimation unit 136 may not perform attack estimation using the false positive log.

### (2) Operation of Attack Analysis Device

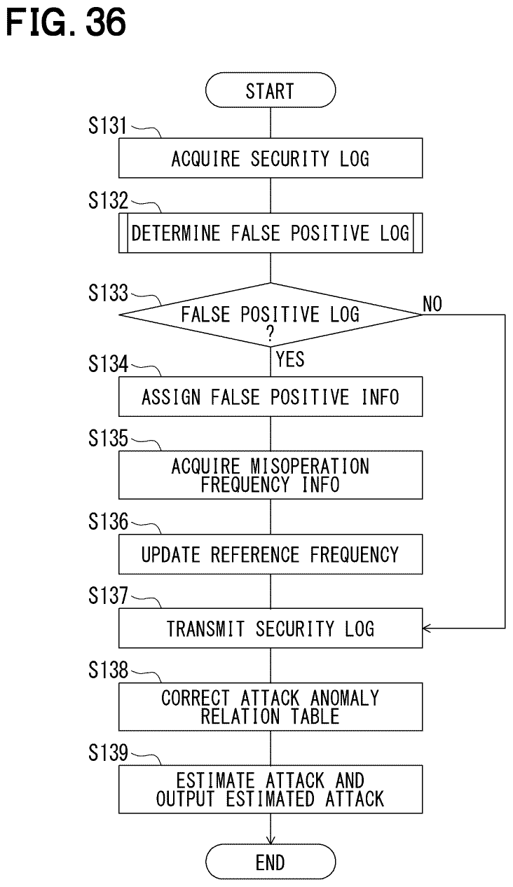

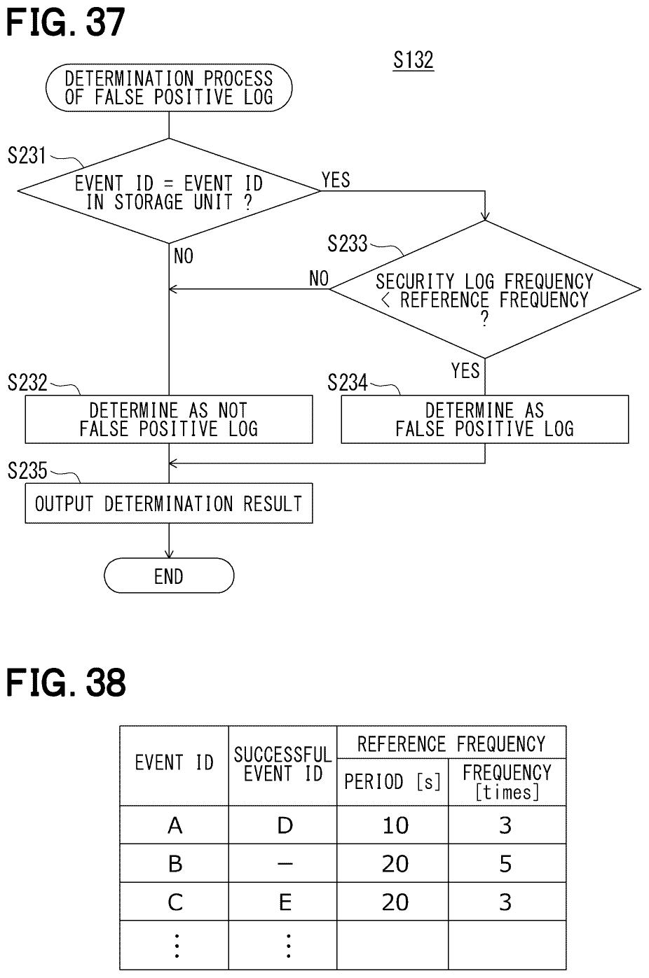

The operation of the attack estimation device 13 will be described with reference to FIG. 36 and FIG. 37.

In S131, the log acquisition unit 131 acquires a security log generated when the security sensor equipped to each of the multiple ECUs 20 configuring the electronic control system S detects an anomaly.

In S132, the false positive log determination unit 134 determines whether the security log acquired in S131 is a false positive log. Specifically, the false positive log determination unit 134 determines, based on the frequency at which the security log is generated, whether or not the security log is a false positive log. A specific flow of S132 is described below with reference to FIG. 37.

In S132, in response to determining that the security log is a false positive log (S133: Y), the false positive log determination unit 134 assigns the false positive information to the security log determined to be the false positive log in S134.

In S135, the misoperation frequency information acquisition unit 132 acquires misoperation frequency information indicating the frequency of misoperation made by the user.

In S136, the storage unit 133 updates the reference frequency based on the misoperation frequency information acquired in S135.

In S137, the false positive determination unit 134 transmits the security log, which has been determined as the false positive log and is assigned with the false positive information.

In S138, the attack estimation unit 136 modifies the attack anomaly relation table based on the false positive information. In S139, the attack estimation unit 136 performs an attack estimation using the corrected attack anomaly relation table, and the output unit 138 outputs attack information indicating the estimated attack.

The following will describe a determination process in S132 for determining whether a security log is a false positive log with reference to FIG. 37.

In S231, the false positive log determination unit 134 determines whether the event ID in the security log is the same as the event ID stored in the storage unit 133.

When the event ID included in the security log is different from the event ID stored in the storage unit 133 (S231: N), the process determines that the security log is not a false positive log in S232.

When the event ID included in the security log is the same as the event ID stored in the storage unit 133 (S231: Y), the false positive log determination unit 134 further determines whether the frequency of security log is lower than the reference frequency in S233.

When the frequency of security log is lower than the reference frequency (S233: Y), the false positive log determination unit 134 determines that the security log is a false positive log in S234.

When the frequency of security log is higher than the reference frequency (S233: N), the false positive log determination unit 134 determines that the security log is not a false positive log in S232.

Then, the false positive log determination unit 134 outputs the determination result in S235.

### (3) Overview

As described above, according to the present embodiment, it is possible to determine that a security log generated by a user's misoperation is a false positive log. As a result, the attack analysis device 13, which analyzes attacks using security logs, can eliminate false positive logs or lower the evaluation score of false positive logs, and analyze attacks using security logs other than false positive logs, thereby improving the accuracy of attack analysis.

### (4) Modifications

In a modification, a method different from the method used in the third embodiment is used to determine whether a security log is a false positive log or not. Since the configuration of attack analysis device of the present modification is the same as that of the third embodiment, the present modification will be described with reference to the configuration shown in FIG. 32.

The log acquisition unit 131 of the present modification acquires a security log indicating that a specific event in the electronic control system S has been successful, in addition to the security log generated when a security sensor detects an anomaly. Hereinafter, in order to distinguish a security log generated when an anomaly is detected from a security log indicating that a specific event has succeeded, the security log is referred to as an anomaly security log and a successful security log, respectively.

The false positive log determination unit 134 performs false positive log determination using the information stored in the storage unit 133, similar to the third embodiment. FIG. 38 illustrates an example of a table stored in the storage unit 133 according to the present modification. The storage unit 133 illustrated in FIG. 38 stores a table indicating a correspondence relation among the event ID, the reference frequency, and the event ID (referred to as a successful event ID) of the successful security log.

The successful event ID is an event ID that indicates identification information of an event that may be successful when the user of the electronic control system S performs a correct operation after performing a misoperation. For example, it is conceivable that a correct password input or authentication operation is performed after a misoperation such as a user of a vehicle in which the electronic control system S is equipped erroneously inputs a password required for Wi-Fi (registered trademark) connection or an operator in a maintenance shop or a dealer performs an erroneous authentication operation. As described above, when input of a correct password or correct authentication operation is performed, a security log indicating that the event is successful is generated. Therefore, a successful event ID indicating an event that may occur after the user's misoperation is stored in the storage unit 133. When the event ID included in the successful security log acquired by the log acquisition unit 131 is the same as the successful event ID stored in the storage unit 133, the false positive log determination unit 134 determines whether the abnormal security log is a false positive log based on the frequency at which the abnormal security log is generated before the successful security log.

In the example of FIG. 38, the successful event ID is associated with the event ID of A and C, but the successful event ID is not associated with the event ID of B. Depending on the type of the event, the security log of the successful event may not be acquired, and thus the successful event ID is not associated with all of the event IDs. Therefore, when a successful event ID is not associated as in the event ID of B, it is determined whether the security log is a false positive log using the same method as in the third embodiment.

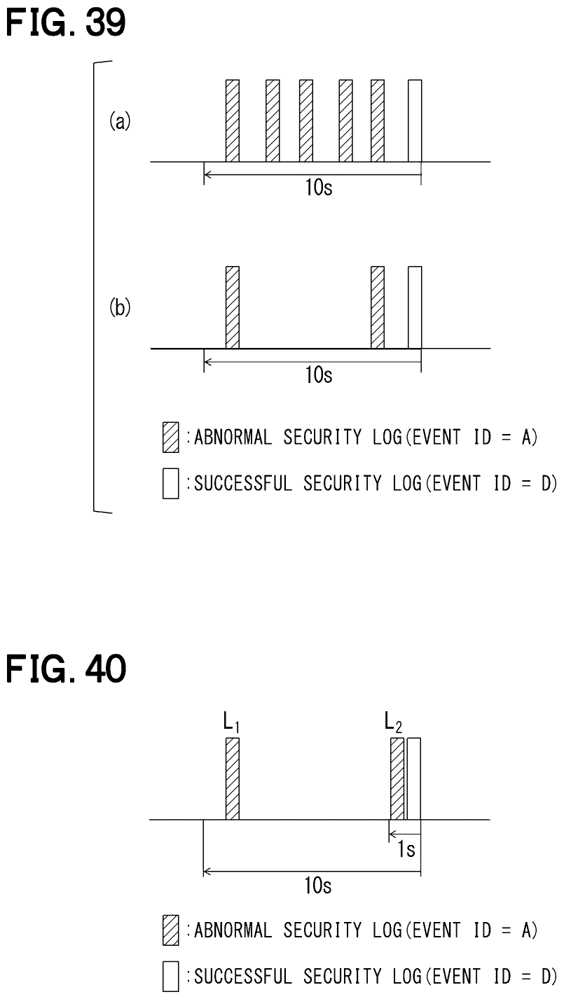

The determination process of determining whether a security log is a false positive log in the present modification will be described with reference to FIG. 39. In the example illustrated in (a) of FIG. 39, the abnormal security log having the event ID of A is generated five times during ten seconds before the time when the successful security log having the event ID of D is generated, and the frequency is higher than the reference frequency. Therefore, it is determined that none of the abnormal security logs shown in (a) of FIG. 39 is a false positive log. In the example illustrated in (b) of FIG. 39, the abnormal security log is generated twice during 10 seconds before the time when the successful security log is generated, and the generation frequency is lower than the reference frequency. In this case, all of the abnormal security logs illustrated in (b) of FIG. 39 are determined to be false positive logs.

In the example shown in (a) of FIG. 39, in addition to the abnormal security logs, the successful security log may also be determined to be not a false positive log. In the example shown in (b) of FIG. 39, in addition to the abnormal security logs, the successful security log may also be determined to be not a false positive log.

In other words, false positive determination may be performed on security logs that include both of the abnormal security logs and the successful security logs.

Even when the frequency of abnormal security log is lower than the reference frequency, the false positive log determination unit 134 of the present embodiment may not determine that the abnormal security log generated immediately before the successful security log is a false positive log. After making the misoperation, it takes a certain length of time for the user to perform the operation. Therefore, in a case where the successful security log is generated immediately after the abnormal security log is generated, that is, in a case where the time from the occurrence of anomaly to the occurrence of the successful event is shorter than the time required for the user to perform the correct operation, there is a possibility that the anomaly has occurred not by the misoperation of the user but by the attack caused by the machine processing. Therefore, the false positive log determination unit 134 may not determine that an abnormal security log generated within a predetermined period before the time when the successful security log is generated is a false positive log.

For example, in the example illustrated in FIG. 40, the abnormal security logs are generated twice during ten seconds before the time when the successful security log is generated, and the frequency thereof is lower than the reference frequency. In the example of FIG. 40, the abnormal security log is generated within a predetermined period (in FIG. 40, one second is illustrated as an example) before the time when the successful security log is generated. Therefore, the abnormal security log L1 may be determined as a false positive log, but the abnormal security log L2 is not determined as a false positive log.

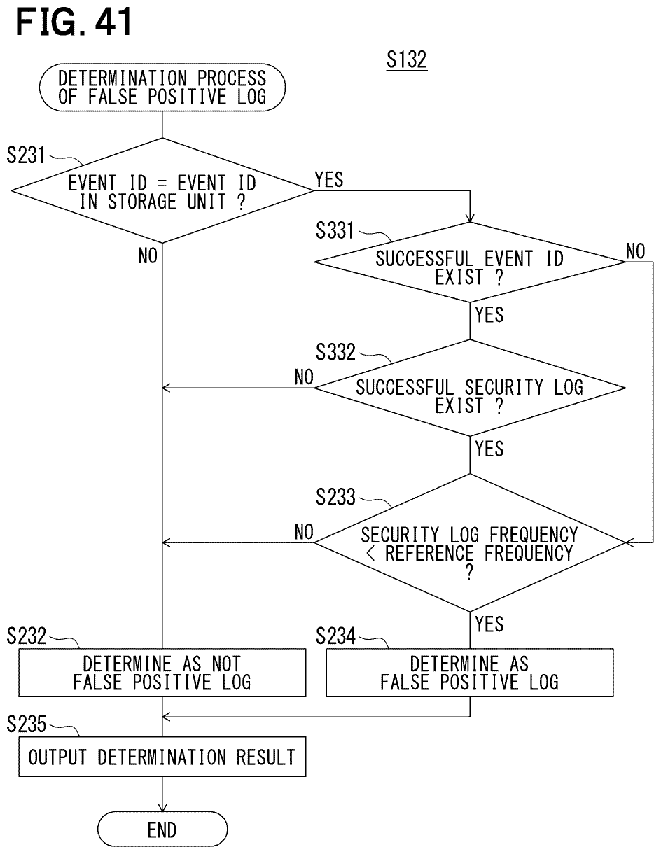

The attack analysis device 13 of the present modification executes the processes shown in FIG. 36, similar to the attack analysis device 13 of the third embodiment. However, in the attack analysis device 13 of the present modification, the process of determining whether a log is a false positive log in S132 differs from that of the third embodiment. The process of determining whether a log is a false positive log in the present modification will be described with reference to FIG. 41. In FIG. 41, process same as FIG. 37 is marked with the same reference symbol as in FIG. 37.

In S231, the false positive log determination unit 134 determines whether the event ID in the security log is the same as the event ID stored in the storage unit 133.

When the event ID included in the security log is different from the event ID stored in the storage unit 133 (S231: N), the process determines that the security log is not a false positive log in S232.

When the event ID included in the security log is the same as the event ID stored in the storage unit 133 (S231: Y), the false positive log determination unit 134 further determines whether a successful event ID associated with the event ID is stored in the storage unit 133 in S331.

When the storage unit 133 stores the successful event ID associated with the event ID (S331: Y), the process further determine whether the log acquisition unit 131 has acquired a successful security log having the successful event ID in S332.

When the log acquisition unit 131 has acquired the successful security log, the process determines whether the frequency of the abnormal security log generated before the successful security log is lower than the reference frequency in S233.

When the frequency of security log is lower than the reference frequency (S233: Y), the false positive log determination unit 134 determines that the security log is a false positive log in S234.

When the frequency of security log is higher than the reference frequency (S233: N), the false positive log determination unit 134 determines that the security log is not a false positive log in S232.

In S331, in response to determining that the successful event ID associated with the event ID is not stored in the storage unit 133 (S331: N), the process determines, in S233, whether the frequency of abnormal security log is lower than the reference frequency similar to the third embodiment.

Then, the false positive log determination unit 134 outputs the determination result in S235.

As described above, according to the present embodiment, by using a security log indicating that an event has succeeded, it is possible to determine a security log generated by a user's misoperation as a false positive log with higher accuracy.

### 5. Overview

The features of the attack analysis device are described in each embodiment of the present disclosure as above.

Since the terms used in each embodiment are examples, the terms may be replaced with equivalent terms that are synonymous or include synonymous functions.

The block diagram used for the description of each embodiment is obtained by classifying and arranging the configuration of the device by function. The blocks representing the respective functions may be implemented by any combination of hardware or software. Since the blocks represent the functions, such a block diagram may also be understood as disclosures of a method and a program for implementing the method.

The order of the functional blocks that can be understood as the processing, the flow, and the method described in each embodiment may be changed unless there are restrictions, such as a relation in which one step uses the result of another step in the preceding step.

The terms of first, second, and N-th (N is an integer) used in each embodiment and the disclosure are used to distinguish two or more configurations of the same type and two or more methods of the same type and do not limit the order and superiority and inferiority.

Each of the embodiments described vehicle attack analysis device for analyzing cyberattack on an electronic control system mounted on a vehicle. The present disclosure is not limited to vehicle use. The present disclosure may include a dedicated or general-purpose device other than a vehicle device.

Embodiments of the attack analysis device of the present disclosure may be configured as a component, a semi-finished product, a finished product or the like.

Examples of the form of the component include a semiconductor element, an electronic circuit, a module, and a microcomputer.

Examples of semi-finished product include an electronic control unit (ECU) and a system board.

Examples of finished product include a cellular phone, a smartphone, a tablet computer, a personal computer (PC), a workstation, and a server.

Other examples of the present disclosure may include a device having communication function, such as a video camera, a still camera, or a car navigation system.

Necessary functions such as an antenna or a communication interface may be properly added to the attack analysis device.

The attack analysis device according to the present disclosure may be used for the purpose of providing various services, especially when used on the server side. When providing such various services, the devices of the present disclosure may be used, the method of the present disclosure may be used, or/and the program of the present disclosure may be executed.

The present disclosure is implemented not only by dedicated hardware having a configuration and a function described in relation to each embodiment. The present disclosure can also be implemented as a combination of a program for implementing the present disclosure, recorded on such a recording medium as memory and a hard disk and general-purpose hardware including dedicated or general-purpose CPU, memory, or the like, capable of executing the program.

A program stored in a non-transitory tangible storage medium (for example, an external storage device (a hard disk, a USB memory, and a CD/BD) of dedicated or general-purpose hardware, or an internal storage device (a RAM, a ROM, and the like)) may also be provided to dedicated or general-purpose hardware via the storage medium or from a server via a communication line without using the storage medium. As a result, it is possible to always provide the latest functions through program upgrade.

The attack analysis device of the present disclosure is intended primarily for analyzing attacks on the electronic control systems installed in automobiles, but may also be intended for analyzing attacks on normal systems that are not installed in automobiles.

What is claimed is:

1. An attack analysis device analyzing an attack on an electronic control system mounted on a mobile object, the attack analysis device comprising:
a log acquisition unit acquiring a security log indicating (i) an anomaly detected in the electronic control system and (ii) a location within the electronic control system where the anomaly is detected;
an indicator acquisition unit acquiring an indicator indicating an internal state or an external state of the mobile object when the anomaly occurs;
an attack anomaly relation information storage unit storing attack anomaly relation information indicating a relation among (i) predicted attack information indicating an attack predicted to be received by the electronic control system, (ii) predicted anomaly information indicating an anomaly predicted to occur when the electronic control system receives the predicted attack, and (iii) predicted anomaly location information indicating a location within the electronic control system where the predicted anomaly occurs;
an attack estimation unit estimating the attack received by the electronic control system based on (i) the security log, (ii) the attack anomaly relation information, and (iii) the indicator; and
an output unit outputting attack information indicating the estimated attack.

2. The attack analysis device according to claim 1, further comprising
a situation estimation unit estimating, based on the indicator, a situation of the mobile object corresponding to the indicator,
wherein the attack estimation unit estimates the attack received by the electronic control system based on the situation of the mobile object, in addition to the security log and the attack anomaly relation information.

3. The attack analysis device according to claim 2, wherein,
when estimating the attack received by the electronic control system, the attack estimation unit does not use a part of the attack anomaly relation information, which includes a location within the electronic control system estimated to be not related to the attack under the situation of the mobile object as the predicted anomaly location information or the predicted attack information.

4. The attack analysis device according to claim 2, wherein,
when estimating the attack received by the electronic control system, the attack estimation unit does not use a part of the attack anomaly relation information, which includes an anomaly estimated to be not related to the attack under the situation of the mobile object as the predicted anomaly information.

5. The attack analysis device according to claim 2, wherein,
when estimating the attack received by the electronic control system, the attack estimation unit uses a part of the attack anomaly relation information, which includes a location within the electronic control system estimated to be related to the attack under the situation of the mobile object as the predicted anomaly location information or the predicted attack information.

6. The attack analysis device according to claim 2, wherein,
when estimating the attack received by the electronic control system, the attack estimation unit uses a part of the attack anomaly relation information, which includes an anomaly estimated to be related to the attack under the situation of the mobile object as the predicted anomaly information.

7. The attack analysis device according to claim 2, wherein,
when estimating the attack received by the electronic control system, the attack estimation unit uses a part of the attack anomaly relation information, which includes a location within the electronic control system estimated to be not related to the attack under the situation of the mobile object as the predicted anomaly information or the predicted anomaly location information after applying weighting to the part of the attack anomaly relation information.

8. The attack analysis device according to claim 2, wherein,
when estimating the attack received by the electronic control system, the attack estimation unit uses a part of the attack anomaly relation information, which includes an anomaly estimated to be not related to the attack under the situation of the mobile object as the predicted anomaly information after applying weighting to the part of the attack anomaly relation information.

9. The attack analysis device according to claim 8, wherein
the weighting is performed by multiplying a coefficient set within a range of 0≤coefficient<1.

10. The attack analysis device according to claim 2, wherein
the situation estimation unit estimates whether a cause of the anomaly indicated by the security log is a cyberattack,
in response to the cause of the anomaly being different from the cyberattack, the situation estimation unit determines the security log is a false positive log, and
the attack estimation unit does not estimate the attack using the security log determined as the false positive log.

11. The attack analysis device according to claim 1, wherein
the indicator includes the security log acquired by the log acquisition unit.

12. The attack analysis device according to claim 2, wherein
the situation estimation unit estimates, as the situation of the mobile object, a situation of a vehicle based on the indicator,
the situation of the vehicle includes an operation state of the vehicle or a driving condition of the vehicle,
the situation estimation unit estimates power supply states of one or more electronic control devices included in the electronic control system from the situation of the vehicle, and
when estimating the attack received by the electronic control system, based on the estimated power supply states, the attack estimation unit does not use a part of the attack anomaly relation information, which includes a location within the electronic control system estimated to be not related to the attack as the predicted anomaly location information or the predicted attack information.

13. The attack analysis device according to claim 12, wherein
the indicator includes at least one of (i) a vehicle speed, (ii) an operation mode, (iii) number of occupants, (iv) a battery voltage, (v) a battery charge state, or (vi) a shift position.

14. The attack analysis device according to claim 2, wherein
the situation estimation unit estimates an entry point candidate, which is a candidate of an entry point from where the attack entered, based on the indicator, and
when estimating the attack received by the electronic control system, the attack estimation unit uses a part of the attack anomaly relation information, which includes the entry point candidate as the predicted attack information.

15. The attack analysis device according to claim 14, wherein
the indicator is a speed of the mobile object.

16. The attack analysis device according to claim 14, wherein
the indicator includes at least one of (i) a location of the mobile object, (ii) an ambient temperature of the mobile object, or (iii) time related information.

17. The attack analysis device according to claim 2, wherein
the situation estimation unit estimates whether a cause of the anomaly indicated by the security log is a cyberattack based on a frequency at which the security log is generated as the indicator,
when the cause of the anomaly is not the cyberattack, the situation estimation unit determines that the security log is a false positive log, and
when estimating the attack received by the electronic control system, the attack estimation unit applies weighting to a part of the attack anomaly relation information, which corresponds to the anomaly indicated by the security log at the location of the electronic control system corresponding to the security log determined as the false positive log, and then uses the weighted attack anomaly relation information to estimate the attack.

18. The attack analysis device according to claim 2, wherein
the situation estimation unit estimates whether a cause of the anomaly indicated by the security log is a cyberattack based on a frequency at which the security log is generated as the indicator,
when the cause of the anomaly is not the cyberattack, the situation estimation unit determines that the security log is a false positive log, and
the attack estimation unit does not estimate the attack using the security log determined as the false positive log.

19. The attack analysis device according to claim 17, wherein
the situation estimation unit estimates whether a cause of the anomaly indicated by the security log is a misoperation made by a user to the mobile object based on a frequency at which the security log is generated as the indicator, and
when the cause of the anomaly is the misoperation made by the user, the situation estimation unit determines that the security log is the false positive log.

20. The attack analysis device according to claim 19, wherein,
when the frequency at which the security log is generated is lower than a reference frequency, the situation estimation unit estimates that the cause of the anomaly indicated by the security log is the misoperation made by the user of the mobile object.

21. An attack analysis device analyzing an attack on an electronic control system mounted on a mobile object, the attack analysis device comprising:
a log acquisition unit acquiring a security log indicating (i) an anomaly detected in the electronic control system and (ii) a location within the electronic control system where the anomaly is detected;
a situation acquisition unit acquiring a situation of the mobile object estimated based on an indicator indicating an internal state or an external state of the mobile object when the anomaly occurs;
an attack anomaly relation information storage unit storing attack anomaly relation information indicating a relation among (i) predicted attack information indicating an attack predicted to be received by the electronic control system, (ii) predicted anomaly information indicating an anomaly predicted to occur when the electronic control system receives the predicted attack, and (iii) predicted anomaly location information indicating a location within the electronic control system where the predicted anomaly occurs;
an attack estimation unit estimating the attack received by the electronic control system based on (i) the security log, (ii) the attack anomaly relation information, and (iii) the situation of the mobile object; and
an output unit outputting attack information indicating the estimated attack.

22. The attack analysis device according to claim 1, wherein
the attack analysis device is located outside the mobile object.

23. The attack analysis device according to claim 1, wherein
the attack analysis device is mounted on the mobile object.

24. An attack analysis method executed by an attack analysis device, which analyzes an attack on an electronic control system mounted on a mobile object, the attack analysis device including an attack anomaly relation information storage unit storing attack anomaly relation information indicating a relation among (i) predicted attack information indicating an attack predicted to be received by the electronic control system, (ii) predicted anomaly information indicating an anomaly predicted to occur when the electronic control system receives the predicted attack, and (iii) predicted anomaly location information indicating a location within the electronic control system where the predicted anomaly occurs,
the attack analysis method comprising:
acquiring a security log indicating (i) an anomaly detected in the electronic control system and (ii) a location within the electronic control system where the anomaly is detected;
acquiring an indicator indicating an internal state or an external state of the mobile object when the anomaly occurs;
estimating the attack received by the electronic control system based on (i) the security log, (ii) the attack anomaly relation information, and (iii) the indicator; and
outputting the attack information indicating the estimated attack.

25. A non-transitory tangible storage medium storing an attack analysis program to be executed by at least one processor of an attack analysis device, the attack analysis device analyzing an attack on an electronic control system mounted on a mobile object, the attack analysis device including an attack anomaly relation information storage unit storing attack anomaly relation information indicating a relation among (i) predicted attack information indicating an attack predicted to be received by the electronic control system, (ii) predicted anomaly information indicating an anomaly predicted to occur when the electronic control system receives the predicted attack, and (iii) predicted anomaly location information indicating a location within the electronic control system where the predicted anomaly occurs,
the attack analysis program comprising instructions, when executed by the at least one processor of the attack analysis device, causing the attack analysis device to:
acquire a security log indicating (i) an anomaly detected in the electronic control system and (ii) a location within the electronic control system where the anomaly is detected;
acquire an indicator indicating an internal state or an external state of the mobile object when the anomaly occurs;
estimate the attack received by the electronic control system based on (i) the security log, (ii) the attack anomaly relation information, and (iii) the indicator; and
output the attack information indicating the estimated attack.

26. The attack analysis device according to claim 1, wherein
the indicator, which indicates the internal state or the external state of the mobile object, is not included in the security log.
